(19) United States
(12) Patent Application Publication
(10) Pub. No.: US 2024/0049706 A1
(43) Pub. Date: Feb. 15, 2024

(54) COMPOSITIONS AND METHODS FOR CONTROLLING INSECTS

(71) Applicant: AgroSpheres, Inc., Charlottesville, VA (US)

(72) Inventors: Ameer Hamza SHAKEEL, Charlottesville, VA (US); Sepehr ZOMORODI, Charlottesville, VA (US); Sergio CARBALLO, Charlottesville, VA (US); Payam POURTAHERI, Charlottesville, VA (US); Joseph FRANK, Charlottesville, VA (US)

(21) Appl. No.: 18/257,982

(22) PCT Filed: Dec. 22, 2021
(86) PCT No.: PCT/US2021/065010

§ 371 Date: Jun. 16, 2023

Related U.S. Application Data
(60) Provisional application No. 63/129,465, filed on Dec. 22, 2020.

(51) Int. Cl. A01N 31/16; A01N 63/20; A01N 31/08; A01N 53/00; A01P 7/04

(52) U.S. Cl. CPC A01N 31/16; A01N 63/20; A01N 31/08; A01N 53/00; A01P 7/04

(57) ABSTRACT

The present disclosure provides compositions and methods for controlling insect pests with bioactive agents. Also, the present disclosure provides insecticidal compositions and methods of using the formulations containing minicells and bioactive agents for targeted delivery and controlled release to enhance insect control in an environment-friendly, stable and scalable manner.

### CROSS-REFERENCE TO RELATED APPLICATIONS

This application claims the benefit of priority to U.S. provisional application No. 63/129,465 filed on Dec. 22, 2020, which is hereby incorporated by reference in its entirety.

### FIELD

This present disclosure relates generally to insecticidal compositions and methods of using same to control various insect pests. More particularly, the disclosure relates to compositions and formulations comprising minicell systems for delivery of bioactive agents with insecticidal activity for effective insect.

### BACKGROUND

Insecticides are chemicals used to control insects by killing them or preventing them from engaging in undesirable or destructive behaviors. Commercially available chemical insecticides contain bioactive ingredients that are toxic to target insect pests, as well as to humans and animals if used in relatively confined environments and directly delivered to them. Various side effects such as immediate or delayed neurotoxic reactions occur in humans, and may be exacerbated when the chemical insecticides come in contact with persons of increased sensitivity, or persons of small body mass such as children or babies.

Over the past half centuries, crop protection has relied heavily on synthetic chemical pesticides, but their availability is now declining as a result of new legislation and the evolution of resistance in pest populations.

Therefore, alternative pest management tactics are needed. Biopesticides are pest management agents, which can afford an environmentally friendly and commercially attrbioactive alternative to synthetic chemical pesticides. Biopesticides, also known as biological pesticides, are pesticides derived from natural materials such as animals, plants, bacteria, and certain minerals. Typically, biopesticides have unique modes of action and are inherently less toxic than conventional pesticides. Thus, they are considered as reduced risk pesticides.

However, there are significant technical barriers to making biopesticides more effective. Also, biopesticides are regulated by standards designed for chemical pesticides, which set a high bar for biopesticide industry to enter pesticide market.

Furthermore, biopesticides have a disadvantage of shorter persistence in the environment and susceptibility to unfavorable environmental condition than synthetic chemical pesticides.

Accordingly, there is a need for highly effective biopesticides that would be less or non-toxic to the environments, humans and animals with longer persistence. It is required to develop a new delivery and release system of biopesticides for sustaining their bioactivity in a stable, controlled and scalable manner.

### SUMMARY OF THE DISCLOSURE

The present disclosure provides an insecticidal composition for controlling one or more insects comprising: (i) a minicell and (ii) a bioactive agent having insecticidal activity. In embodiments, the bioactive agent is selected from a botanical ingredient, an essential oil, a saponin, and combinations thereof. In embodiments, the one or more insects are controlled with application of said composition to a locus. In embodiments, said botanical ingredient is a plant extract having an insecticidal activity. In embodiments, said botanical ingredient is selected from the group consisting of pyrethrum, pyrethrin, rotenone, sabadilla, cevadine, veratridine, ryania, nicotine, and neen. In embodiments, said essential oil is a plant extract having an insecticidal activity. In embodiments, said essential oil is selected from the group consisting of thyme oil, rosemary oil, cinnamon oil, tea tree oil, peppermint oil, clove oil, orange oil, oregano oil, and neem oil, citronella oil, lemon grass oil, eucalyptus oil, lavender oil, and cedar oil. In embodiments, said essential oil comprises thymol, geraniol, eugenol, myrcene, α-terpinene, p-cymene, d-limonene, menthol, α-pinene, β-pinene, pulegone, anisole, eucalyptol, geraniol, geranyl acetate, linalyl acetate, methyl anthranilate, cinnamaldehyde, methyl benzoate, azadirachtin, citronellal, nerolidol, pulegone, anethole, ethyl benzoate, emamectin benzoate, or benzyl benzoate. In embodiments, said insecticidal composition further comprises a soap made with potassium salts of fatty acids. In embodiments, said insecticidal composition further comprises a surfactant. In embodiments, the composition is applied in a liquid form or a soluble, dry powder form.

In embodiments, the minicell enhances stability and insecticidal activity of said bioactive agent. In embodiments, the minicell is an achromosomal bacterial cell. In embodiments, the minicell is capable of encapsulating the bioactive agent. In embodiments, the bioactive agent is present within the minicell. In embodiments, the minicell and the bioactive agent are present in a weight-to-weight ratio of about 5:1 to about 1:5 in the composition. In embodiments, the minicell and the bioactive agent are present in a weight-to-weight ratio of about 1:1. In embodiments, the locus is an insect, a plant, an animal, or a human. In embodiments, the bioactive agent in the presence of the minicell has at least 1% higher insecticidal activity than the bioactive agent alone at day 1 after treatment of said composition.

The present disclosure provides a method of controlling one or more insects, the method comprising: applying an insecticidal composition to a locus, wherein said insecticidal composition comprising: (i) a minicell and (ii) a bioactive agent having insecticidal activity, wherein the bioactive agent is selected from a botanical ingredient, an essential oil, a saponin, and combinations thereof, wherein the one or more insects are controlled with application of said composition to said locus, and wherein the minicell enhances stability and insecticidal activity of said bioactive agent. In embodiments of the method, the bioactive agent is selected from a botanical ingredient, an essential oil, a saponin, and combinations thereof. In embodiments of the method, the one or more insects are controlled with application of said composition to a locus. In embodiments of the method, said botanical ingredient is a plant extract having an insecticidal activity. In embodiments of the method, said botanical ingredient is selected from the group consisting of pyrethrum, pyrethrin, rotenone, sabadilla, cevadine, veratridine, ryania, nicotine, and neen. In embodiments of the method, said essential oil is a plant extract having an insecticidal activity. In embodiments of the method, said essential oil is selected from the group consisting of thyme oil, rosemary oil, cinnamon oil, tea tree oil, peppermint oil, clove oil, orange oil, oregano oil, and neem oil, citronella oil, lemon grass oil, eucalyptus oil, lavender oil, and cedar oil. In embodiments of the method, said essential oil comprises thymol, geraniol, eugenol, myrcene, α-terpinene, p-cymene, d-limonene, menthol, α-pinene, β-pinene, pulegone, anisole, eucalyptol, geraniol, geranyl acetate, linalyl acetate, methyl anthranilate, cinnamaldehyde, methyl benzoate, azadirachtin, citronellal, nerolidol, pulegone, anethole, ethyl benzoate, emamectin benzoate, or benzyl benzoate. In embodiments of the method, said insecticidal composition further comprises a soap made with potassium salts of fatty acids. In embodiments of the method, said insecticidal composition further comprises a surfactant. In embodiments of the method, the composition is applied in a liquid form or a soluble, dry powder form.

In embodiments of the method, the minicell enhances stability and insecticidal activity of said bioactive agent. In embodiments of the method, the minicell is an achromosomal bacterial cell. In embodiments of the method, the minicell is capable of encapsulating the bioactive agent. In embodiments, the bioactive agent is present within the minicell. In embodiments of the method, the minicell and the bioactive agent are present in a weight-to-weight ratio of about 5:1 to about 1:5 in the composition. In embodiments of the method, the minicell and the bioactive agent are present in a weight-to-weight ratio of about 1:1. In embodiments of the method, the locus is an insect, a plant, an animal, or a human. In embodiments of the method, the bioactive agent in the presence of the minicell has at least 1% higher insecticidal activity than the bioactive agent alone at day 1 after treatment of said composition.

### BRIEF DESCRIPTION OF THE FIGURES

FIG. 1A-1C illustrates scanning electron microscope images of an unpurified sample of AgriCell producing E. coli. (FIG. 1A; scale bar 1 μm), a purified fraction of AgriCell showing the absence of rod-shaped parent cells (FIG. 1B; scale bar 2 μm) and magnification image showing the morphology and relatively uniform particle size of purified AgriCells (FIG. 1C; scale bar 200 nm).

FIG. 2 illustrates size distribution of an un-purified AgriCell production batch and a purified AgriCell batch. Two humps represent different populations composed by larger replicating parent cells (mean diameter about 1.0 μm) and smaller anucleate AgriCells (mean diameter about 0.5 μm). The size distribution of the purified AgriCell production shows that only small anucleate AgriCells are present (purity >99%).

FIG. 3 illustrates evaluation of loading efficacy for essential oils into AgriCell (AC). FIG. 3 shows that model essential oils (EOs) (e.g. eugenol, thymol and pyrethrum, respectively) are encapsulated into AC. Bars show the correlation between original concentration of EO (200 mg/mL) and the final concentration encapsulated into AC. Line shows the percentage encapsulated EO for each formulation.

FIG. 4A illustrates AgriCell encapsulating eugenol (right tube), which shows improved chemical stability to changes in pH, when compared to Eugenol-encapsulating liposomal formulation (left tube). AgriCell-encapsulated eugenol showed improved stability when pH was adjusted to simulate gastric conditions (pH 1.2). FIG. 4B-4C illustrates the improved physical stability of AgriCell-encapsulated eugenol (right tube) against a Eugenol-encapsulated liposomal formulation (left tube) on day 1 (FIG. 4B) and day 30 (FIG. 4C) after storage under controlled conditions (temperature 25° C., relative humidity 30% and pH 7.2). All samples were diluted 1:10 with deionized water.

FIG. 5 illustrates evaluation of the protective effect of AgriCell on thermal degradation of essential oils at 40° C. Initial concentration of essential oil formulations was about 200 mg/mL, whereas the AgriCell concentration was about 100 mg/mL.

FIG. 6 illustrates evaluation of the protective effect of AgriCell on auto-oxidative degradation of essential oils under UV and Visible (Vis) light exposure. Initial concentration of essential oil formulations was about 200 mg/mL, whereas the AgriCell concentration was 100 mg/mL.

FIG. 7A-7C illustrates cumulative percentage release of model essential oils (EOs), eugenol (FIG. 7A), pyrethrum (FIG. 7B), and thymol (FIG. 7C) from an un-coated free form (i.e. not encapsulated into AgriCell/minicell), AgriCell/minicell platform (i.e. encapsulated into AgriCell/minicell) and AgriCell/minicell surface coated by chitosan biopolymer (MC-CHT). Release media was composed by PBS, ethanol and Tween 80 emulsifier (140:59:1 v/v/v). Dialysis cassette membrane MWCO 8-10 kDa. FIG. 7A shows percentage release of (i) Eug (Eugenol 100 mg/mL); (ii) MC-Eug (Eugenol 100 mg/mL loaded with AgriCell/Minicell platform 100 mg/mL); and (iii) MC-Eug-CHT (Eugenol 100 mg/mL loaded with AgriCell/Minicell-CHT platform (AC 100 mg/mL and CHT 20 mg/mL, weight ratio 1:1). FIG. 7B shows percentage release of (i) Pyrethrum (100 mg/mL); (ii) MC-Pyt (Pyrethrum 100 mg/mL loaded with AgriCell/Minicell platform 100 mg/mL); and (iii) MC-Pyt-CHT (Pyrethrum 100 mg/mL loaded with AgriCell/Minicell-CHT platform (AC 100 mg/mL and CHT 20 mg/mL, weight ratio 1:1). FIG. 7C shows percentage release of (i) Thymol (100 mg/mL); (ii) MC-Thym (Thymol 100 mg/mL loaded with AgriCell/Minicell platform 100 mg/mL); and (iii) MC-Thym-CHT (Thymol 100 mg/mL loaded with AgriCell/Minicell-CHT platform (AC 100 mg/mL and CHT 20 mg/mL, weight ratio 1:1).

FIG. 8 illustrates percent (%) mortality on Velvetbean Caterpillar (VBC) in leaf disc assays. Soy leaf discs treated with different Pyrethrum (Py) concentrations of formulations (0.8%, 0.4%, 0.2%, 0.1%, 0.05%, 0.025%, 0.0125%) and infested with the second instar VBC. The mortality of VBC was measured at 3 days after infestation (DAI). The tested formulations were pyrethrum extract (Sigma-Aldrich Lot #BCCB9487; “Sigma Py”) vs PyGanic® Crop Protection EC 5.0 (commercial formulation manufactured by MGK; “Pyganic”). 5 reps rated for % mortality at 3 DAI.

FIG. 9A illustrates percent (%) leaf damage (i.e. leaf area consumed) in whole soy plants sprayed/treated with three different Py concentrations (0.125%, 0.025%, and 0.05%) of formulations and infested with VBC at 1, 3, 5 days after treatment (DAT) of each formulation. The tested formulations were unencapsulated Pyrethrins (“Free Py”; a.k.a. “Sigma Py” described in FIG. 8, which was not encapsulated by AgriCell) and AgriCell encapsulated Pyrethrins (“AC-Py”; “Sigma Py” encapsulated by AgriCell). 4 reps rated for % leaf damages. The VBC-infested soy plants without any formulation sprayed/treated were used as a control (that is Untreated; “Untrt”). FIG. 9B presents leaf damage with VBC infestation at 1 DAT with (i) 0.0125% free Py and 0.0125% Agricell (AC)-Py treated (left photo) and (ii) 0.05% free Py and 0.05% Agricell (AC)-Py treated (right photo).

FIG. 10A illustrates percent (%) leaf damage in whole soy plants sprayed with three different Py concentrations (0.05%, 0.10%, and 0.20%) of formulations and infested with VBC at 1 day after treatment (DAT) of each formulation. Then, damage ratings were recorded at 4 and 6 days after VBC infestation (DAI). The tested formulations were (i) AgriCell encapsulated Pyrethrins (“AC-Py”), (ii) unencapsulated Pyrethrins (“Free Py”), (iii) PyGanic® Crop Protection EC 5.0 (“Pyganic”). 4 reps rated for % leaf damages. The VBC-infested soy plants without any formulation sprayed/treated were used as a control (that is Untreated; “Untrt”).

FIG. 10B presents leaf damage with VBC infestation at 1 DAT with (i) 0.05% AC-Py, (ii) 0.05% Free-Py, (iii) 0.05% Pyganic, and (iv) Py-Untreated (Untrt). The photos were the damaged 1^{st} trifoliate, which was rated at 4 days after VBC infestation (DAI).

FIG. 11A illustrates percent (%) leaf damage in whole soy plants sprayed with three different Py concentrations (0.05%, 0.10%, and 0.20%) of formulations and infested with VBC at 4 day after treatment (DAT) of each formulation. Then, damage ratings were recorded at 4 and 6 days after VBC infestation (DAI). The tested formulations were (i) AgriCell encapsulated Pyrethrins (“AC-Py”), (ii) unencapsulated Pyrethrins (“Free Py”), (iii) PyGanic® Crop Protection EC 5.0 (“Pyganic”). 4 reps rated for % leaf damages. The VBC-infested soy plants without any formulation sprayed/treated were used as a control (that is Untreated; “Untrt”). FIG. 11B presents leaf damage with VBC infestation at 4 DAT with (i) 0.05% AC-Py, (ii) 0.05% Free-Py, (iii) 0.05% Pyganic, and (iv) Py-Untreated (Untrt). The photos were the damaged 1^{st} trifoliate, which was rated at 4 days after VBC infestation (DAI).

FIG. 12A illustrates percent (%) leaf damage in whole soy plants sprayed with three different Py concentrations (0.05%, 0.10%, and 0.20%) of formulations and infested with VBC at 7 day after treatment (DAT) of each formulation. Then, damage ratings were recorded at 4 and 6 days after VBC infestation (DAI). The tested formulations were (i) AgriCell encapsulated Pyrethrins (“AC-Py”), (ii) unencapsulated Pyrethrins (“Free Py”), (iii) PyGanic® Crop Protection EC 5.0 (“Pyganic”). 4 reps rated for % leaf damages. The VBC-infested soy plants without any formulation sprayed/treated were used as a control (that is Untreated; “Untrt”). FIG. 12B presents leaf damage with VBC infestation at 7 DAT with (i) 0.05% AC-Py, (ii) 0.05% Free-Py, (iii) 0.05% Pyganic, and (iv) Py-Untreated (Untrt). The photos were the damaged 1^{st} trifoliate, which was rated at 4 days after VBC infestation (DAI).

FIG. 13 illustrates percent (%) defoliation at 3 and 6 days after treatment of formulations to soy plants in the field. The tested formulations were AgriCell-Pyrethrum, PyGanic®, and No Py treatment (untreated).

### DETAILED DESCRIPTION

To control undesirable insect pests with biopesticides with longer persistence, new insecticidal compositions and formulations are required to ensure a safe, non-toxic, scalable, and cost-effective delivery of bioactive ingredients/agents with pesticidal activity.

The present disclosure provides use of minicells as a novel delivery platform comprising bioactive agents such as biopesticides for the purpose of control of undesirable insect pests and diseases caused by the insect pests. Also, disclosed are methods of controlling or suppressing undesirable insect pests using an insecticidal composition or formulation taught herein.

### Definitions

While the following terms are believed to be well understood by one of ordinary skill in the art, the following definitions are set forth to facilitate explanation of the presently disclosed subject matter.

The term “a” or “an” refers to one or more of that entity, i.e. can refer to a plural referents. As such, the terms “a” or “an”, “one or more” and “at least one” are used interchangeably herein. In addition, reference to “an element” by the indefinite article “a” or “an” does not exclude the possibility that more than one of the elements is present, unless the context clearly requires that there is one and only one of the elements.

The term “a bioactive agent,” (synonymous with “a biologically active agent”) indicates that a composition or compound itself has a biological effect, or that it modifies, causes, promotes, enhances, blocks, reduces, limits the production or activity of, or reacts with or binds to an endogenous molecule that has a biological effect. A “biological effect” may be but is not limited to one that impacts a biological process in/onto a locus; one that impacts a biological process in and/or onto a pest, pathogen or parasite. In some embodiments, a bioactive agent may be used in agricultural applications. A biological agent acts to cause or stimulate a desired effect upon a plant, an insect, a worm, bacteria, fungi, or virus. Non-limiting examples of desired effects include, for example, (i) suppressing, inhibiting, limiting, or controlling growth of or killing one or more insect species, (ii) preventing, treating or curing a disease or condition in a human, an animal, or a plant suffering from one or more insect species; (iii) suppressing, inhibiting, limiting, or controlling growth of or killing an insect pest that negatively affects a human, an animal, or a plant; (iv) augmenting the phenotype or genotype of a plant by controlling one or more insects; (v) stimulating a positive response in one or more plant species, such as desirable plants, to germinate, grow vegetatively, bloom, fertilize, produce fruits and/or seeds, and harvest by controlling one or more insects; (vi) controlling an insect pest to cause a disease or disorder.

The terms “control” or “controlling” are meant to include any insecticidal (killing) or insectistatic (inhibiting, maiming or generally interfering) activities of an insecticidal composition against a given pest. Thus, these terms not only include knocking down and killing, but also include such activities as those of chemisterilants which produce sterility in insects by preventing the production of ova or sperm, by causing death of sperm or ova, or by producing severe injury to the genetic material of sperm or ova, so that the larvae that are produced do not develop into mature progeny. The terms also include repellant activity that protect animals, plants or products from insect attack by making food or living conditions unattrbioactive or offensive to pests. These repellant activities may be the result of repellents that are poisonous, mildly toxic, or non-poisonous to pests.

The term “insecticidally effective amount” is an amount of the compound of the disclosure, or a composition containing the compound, that has an adverse effect (e.g., knockdown and/or death) on at least 1% of the pests treated, at least 5%, at least 10%, at least 15%, at least 20%, at least 25%, at least 30%, at least 35%, at least 40%, at least 45%, at least 50%, at least 60%, at least 70% or greater. An “effective pest-inhibiting amount” is an amount of the compound of the disclosure, or a composition containing the compound, where at least 5%, at least 10%, at least 15%, at least 20%, at least 25% or greater mortality against pests is achieved, at least 30%, at least 35%, at least 40%, at least 45%, at least 50%, at least 60%, at least 70% or greater mortality. Similarly, an “effective pest-growth modulating amount” is one where at least 5%, at least 10%, at least 15%, at least 20%, at least 25% or greater pest-growth modulation is achieved, 50% or greater, 70% at least 30%, at least 35%, at least 40%, at least 45%, at least 50%, at least 60%, at least 70% of greater. The term “amount sufficient to prevent infestation” is also used herein and is intended to mean an amount that is sufficient to deter all but an insignificant sized pest population so that a disease or infected state is prevented.

The term “pest” is defined herein as encompassing vectors of plant, humans or livestock disease, unwanted species of bacteria, fungi, viruses, insects, nematodes mites, ticks or any organism causing harm.

As used herein the terms “cellular organism” “microorganism” or “microbe” should be taken broadly. These terms are used interchangeably and include, but are not limited to, the two prokaryotic domains, Bacteria and Archaea, as well as certain eukaryotic fungi and protists.

The term “prokaryotes” is art recognized and refers to cells that contain no nucleus or other cell organelles. The prokaryotes are generally classified in one of two domains, the Bacteria and the Archaea. The definitive difference between organisms of the Archaea and Bacteria domains is based on fundamental differences in the nucleotide base sequence in the 16S ribosomal RNA.

The term “encapsulated” means that at least one bioactive agent of the present disclosure is in the interior of the minicell of the present disclosure. In another embodiment, the at least one bioactive agent found on the interior of the minicell of the present disclosure with another compound including, but are not limited to another bioactive agent, an agrochemical, an adjuvant, a carrier, a botanical ingredient, an essential oil and the like.

The term “Archaea” refers to a categorization of organisms of the division Mendosicutes, typically found in unusual environments and distinguished from the rest of the prokaryotes by several criteria, including the number of ribosomal proteins and the lack of muramic acid in cell walls. On the basis of ssrRNA analysis, the Archaea consist of two phylogenetically-distinct groups: Crenarchaeota and Euryarchaeota. On the basis of their physiology, the Archaea can be organized into three types: methanogens (prokaryotes that produce methane); extreme halophiles (prokaryotes that live at very high concentrations of salt (NaCl); and extreme (hyper) thermophilus (prokaryotes that live at very high temperatures). Besides the unifying archaeal features that distinguish them from Bacteria (i.e., no murein in cell wall, ester-linked membrane lipids, etc.), these prokaryotes exhibit unique structural or biochemical attributes which adapt them to their particular habitats. The Crenarchaeota consists mainly of hyperthermophilic sulfur-dependent prokaryotes and the Euryarchaeota contains the methanogens and extreme halophiles.

“Bacteria” or “eubacteria” refers to a domain of prokaryotic organisms. Bacteria include at least 11 distinct groups as follows: (1) Gram-positive (gram+) bacteria, of which there are two major subdivisions: (1) high G+C group (Actinomycetes, Mycobacteria, Micrococcus, others) (2) low G+C group (Bacillus, Clostridia, Lactobacillus, Staphylococci, Streptococci, Mycoplasmas); (2) Proteobacteria, e.g., Purple photosynthetic+non-photosynthetic Gram-negative bacteria (includes most “common” Gram-negative bacteria); (3) Cyanobacteria, e.g., oxygenic phototrophs; (4) Spirochetes and related species; (5) Planctomyces; (6) Bacteroides, Flavobacteria; (7) Chlamydia; (8) Green sulfur bacteria; (9) Green non-sulfur bacteria (also anaerobic phototrophs); (10) Radioresistant micrococci and relatives; (11) Thermotoga and Thermosipho thermophiles.

A “eukaryote” is any organism whose cells contain a nucleus and other organelles enclosed within membranes. Eukaryotes belong to the taxon Eukarya or Eukaryota. The defining feature that sets eukaryotic cells apart from prokaryotic cells (the aforementioned Bacteria and Archaea) is that they have membrane-bound organelles, especially the nucleus, which contains the genetic material, and is enclosed by the nuclear envelope.

The terms “genetically modified host cell,” “recombinant host cell,” and “recombinant strain” are used interchangeably herein and refer to host cells that have been genetically modified by the cloning and transformation methods of the present disclosure or known in the art. Thus, the terms include a host cell (e.g., bacteria, yeast cell, fungal cell, CHO, human cell, etc.) that has been genetically altered, modified, or engineered, such that it exhibits an altered, modified, or different genotype and/or phenotype (e.g., when the genetic modification affects coding nucleic acid sequences of the microorganism), as compared to the naturally-occurring organism from which it was derived. It is understood that in some embodiments, the terms refer not only to the particular recombinant host cell in question, but also to the progeny or potential progeny of such a host cell.

The term “wild-type microorganism” or “wild-type host cell” describes a cell that occurs in nature, i.e. a cell that has not been genetically modified. In the disclosure, “wild type strain” or “wild strain” or “wild type cell line” refers to a cell strain/line that can produce minicells. In some embodiments, wild type bacterial strains and/or cell lines such as E. coli strain p 678-54 and B. subtilis strain CU403 can make miniature cells deficient in DNA. Methods for producing such minicells are known in the art. See, for example, Adler et al., 1967, Proc. Natl. Acad. Sci. USA 57:321-326; Inselburg J, 1970 J. Bacteriol. 102(3):642-647; Frazer 1975, Curr. Topics Microbiol. Immunol. 69:1-84, Reeve et al 1973, J. Bacteriol. 114(2):860-873; and Mendelson et al 1974 J. Bacteriol. 117(3):1312-1319.

The term “genetically engineered” may refer to any manipulation of a host cell's genome (e.g. by insertion, deletion, mutation, or replacement of nucleic acids).

The term “control host cell” refers to an appropriate comparator host cell for determining the effect of a genetic modification or experimental treatment. In some embodiments, the control host cell is a wild type cell. In other embodiments, a control host cell is genetically identical to the genetically modified host cell, save for the genetic modification(s) differentiating the treatment host cell.

As used herein, the term “genetically linked” refers to two or more traits that are co-inherited at a high rate during breeding such that they are difficult to separate through crossing.

A “recombination” or “recombination event” as used herein refers to a chromosomal crossing over or independent assortment.

As used herein, the term “phenotype” refers to the observable characteristics of an individual cell, cell culture, organism, or group of organisms which results from the interaction between that individual's genetic makeup (i.e., genotype) and the environment.

As used herein, the term “chimeric” or “recombinant” when describing a nucleic acid sequence or a protein sequence refers to a nucleic acid, or a protein sequence, that links at least two heterologous polynucleotides, or two heterologous polypeptides, into a single macromolecule, or that rearranges one or more elements of at least one natural nucleic acid or protein sequence. For example, the term “recombinant” can refer to an artificial combination of two otherwise separated segments of sequence, e.g., by chemical synthesis or by the manipulation of isolated segments of nucleic acids by genetic engineering techniques.

As used herein, a “synthetic nucleotide sequence” or “synthetic polynucleotide sequence” is a nucleotide sequence that is not known to occur in nature or that is not naturally occurring. Generally, such a synthetic nucleotide sequence will comprise at least one nucleotide difference when compared to any other naturally occurring nucleotide sequence.

As used herein, a “synthetic amino acid sequence” or “synthetic peptide” or “synthetic protein” is an amino acid sequence that is not known to occur in nature or that is not naturally occurring. Generally, such a synthetic protein sequence will comprise at least one amino acid difference when compared to any other naturally occurring protein sequence.

As used herein, the term “nucleic acid” refers to a polymeric form of nucleotides of any length, either ribonucleotides or deoxyribonucleotides, or analogs thereof. This term refers to the primary structure of the molecule, and thus includes double- and single-stranded DNA, as well as double- and single-stranded RNA. It also includes modified nucleic acids such as methylated and/or capped nucleic acids, nucleic acids containing modified bases, backbone modifications, and the like. The terms “nucleic acid,” “nucleotide,” and “polynucleotide” are used interchangeably.

As used herein, the term “protease-deficient strain” refers to a strain that is deficient in one or more endogenous proteases. For example, protease deficiency can be created by deleting, removing, knock-out, silencing, suppressing, or otherwise downregulating at lease on endogenous protease. Said proteases can include catastrophic proteases. For example, BL21 (DE3) E. coli strain is deficient in proteases Lon and OmpT. E. coli strain has cytoplasmic proteases and membrane proteases that can significantly decrease protein production and localization to the membrane. In some embodiments, a protease-deficient strain can maximize production and localization of a protein of interest to the membrane of the cell. “Protease-deficient” can be interchangeably used as “protease-free” in the present disclosure.

As used herein, the term “gene” refers to any segment of DNA associated with a biological function. Thus, genes include, but are not limited to, coding sequences and/or the regulatory sequences required for their expression. Genes can also include non-expressed DNA segments that, for example, form recognition sequences for other proteins. Genes can be obtained from a variety of sources, including cloning from a source of interest or synthesizing from known or predicted sequence information, and may include sequences designed to have desired parameters.

As used herein, the term “homologous” or “homologue” or “ortholog” is known in the art and refers to related sequences that share a common ancestor or family member and are determined based on the degree of sequence identity. The terms “homology,” “homologous,” “substantially similar” and “corresponding substantially” are used interchangeably herein. They refer to nucleic acid fragments wherein changes in one or more nucleotide bases do not affect the ability of the nucleic acid fragment to mediate gene expression or produce a certain phenotype. These terms also refer to modifications of the nucleic acid fragments of the instant disclosure such as deletion or insertion of one or more nucleotides that do not substantially alter the functional properties of the resulting nucleic acid fragment relative to the initial, unmodified fragment. It is therefore understood, as those skilled in the art will appreciate, that the disclosure encompasses more than the specific exemplary sequences. These terms describe the relationship between a gene found in one species, subspecies, variety, cultivar or strain and the corresponding or equivalent gene in another species, subspecies, variety, cultivar or strain. For purposes of this disclosure homologous sequences are compared. “Homologous sequences” or “homologues” or “orthologs” are thought, believed, or known to be functionally related. A functional relationship may be indicated in any one of a number of ways, including, but not limited to: (a) degree of sequence identity and/or (b) the same or similar biological function. Preferably, both (a) and (b) are indicated. Homology can be determined using software programs readily available in the art, such as those discussed in Current Protocols in Molecular Biology (F. M. Ausubel et al., eds., 1987) Supplement 30, section 7.718, Table 7.71. Some alignment programs are MacVector (Oxford Molecular Ltd, Oxford, U.K.), ALIGN Plus (Scientific and Educational Software, Pennsylvania) and AlignX (Vector NTI, Invitrogen, Carlsbad, CA). Another alignment program is Sequencher (Gene Codes, Ann Arbor, Michigan), using default parameters.

As used herein, the term “endogenous” or “endogenous gene,” refers to the naturally occurring gene, in the location in which it is naturally found within the host cell genome. In the context of the present disclosure, operably linking a heterologous promoter to an endogenous gene means genetically inserting a heterologous promoter sequence in front of an existing gene, in the location where that gene is naturally present. An endogenous gene as described herein can include alleles of naturally occurring genes that have been mutated according to any of the methods of the present disclosure.

As used herein, the term “exogenous” is used interchangeably with the term “heterologous,” and refers to a substance coming from some source other than its native source. For example, the terms “exogenous protein,” or “exogenous gene” refer to a protein or gene from a non-native source or location, and that have been artificially supplied to a biological system.

As used herein, the term “nucleotide change” refers to, e.g., nucleotide substitution, deletion, and/or insertion, as is well understood in the art. For example, mutations contain alterations that produce silent substitutions, additions, or deletions, but do not alter the properties or activities of the encoded protein or how the proteins are made.

As used herein, the term “protein modification” refers to, e.g., amino acid substitution, amino acid modification, deletion, and/or insertion, as is well understood in the art.

As used herein, the term “at least a portion” or “fragment” of a nucleic acid or polypeptide means a portion having the minimal size characteristics of such sequences, or any larger fragment of the full length molecule, up to and including the full length molecule. A fragment of a polynucleotide of the disclosure may encode an enzymatically bioactive portion of a genetic regulatory element. An enzymatically bioactive portion of a genetic regulatory element can be prepared by isolating a portion of one of the polynucleotides of the disclosure that comprises the genetic regulatory element and assessing activity as described herein. Similarly, a portion of a polypeptide may be 4 amino acids, 5 amino acids, 6 amino acids, 7 amino acids, and so on, going up to the full length polypeptide. The length of the portion to be used will depend on the particular application. A portion of a nucleic acid useful as a hybridization probe may be as short as 12 nucleotides; in some embodiments, it is 20 nucleotides. A portion of a polypeptide useful as an epitope may be as short as 4 amino acids. A portion of a polypeptide that performs the function of the full-length polypeptide would generally be longer than 4 amino acids.

Variant polynucleotides also encompass sequences derived from a mutagenic and recombinogenic procedure such as DNA shuffling. Strategies for such DNA shuffling are known in the art. See, for example, Stemmer (1994) PNAS 91:10747-10751; Stemmer (1994) Nature 370:389-391; Crameri et al. (1997) Nature Biotech. 15:436-438; Moore et al. (1997) J. Mol. Biol. 272:336-347; Zhang et al. (1997) PNAS 94:4504-4509; Crameri et al. (1998) Nature 391:288-291; and U.S. Pat. Nos. 5,605,793 and 5,837,458.

For PCR amplifications of the polynucleotides disclosed herein, oligonucleotide primers can be designed for use in PCR reactions to amplify corresponding DNA sequences from cDNA or genomic DNA extracted from any organism of interest. Methods for designing PCR primers and PCR cloning are generally known in the art and are disclosed in Sambrook et al. (2001) Molecular Cloning: A Laboratory Manual (3^{rd} ed., Cold Spring Harbor Laboratory Press, Plainview, New York). See also Innis et al., eds. (1990) PCR Protocols: A Guide to Methods and Applications (Academic Press, New York); Innis and Gelfand, eds. (1995) PCR Strategies (Academic Press, New York); and Innis and Gelfand, eds. (1999) PCR Methods Manual (Academic Press, New York). Known methods of PCR include, but are not limited to, methods using paired primers, nested primers, single specific primers, degenerate primers, gene-specific primers, vector-specific primers, partially-mismatched primers, and the like.

The term “primer” as used herein refers to an oligonucleotide which is capable of annealing to the amplification target allowing a DNA polymerase to attach, thereby serving as a point of initiation of DNA synthesis when placed under conditions in which synthesis of primer extension product is induced, i.e., in the presence of nucleotides and an agent for polymerization such as DNA polymerase and at a suitable temperature and pH. The (amplification) primer is preferably single stranded for maximum efficiency in amplification. Preferably, the primer is an oligodeoxyribonucleotide. The primer must be sufficiently long to prime the synthesis of extension products in the presence of the agent for polymerization. The exact lengths of the primers will depend on many factors, including temperature and composition (A/T vs. G/C content) of primer. A pair of bi-directional primers consists of one forward and one reverse primer as commonly used in the art of DNA amplification such as in PCR amplification.

As used herein, “promoter” refers to a DNA sequence capable of controlling the expression of a coding sequence or functional RNA. In some embodiments, the promoter sequence consists of proximal and more distal upstream elements, the latter elements often referred to as enhancers. Accordingly, an “enhancer” is a DNA sequence that can stimulate promoter activity, and may be an innate element of the promoter or a heterologous element inserted to enhance the level or tissue specificity of a promoter. Promoters may be derived in their entirety from a native gene, or be composed of different elements derived from different promoters found in nature, or even comprise synthetic DNA segments. It is understood by those skilled in the art that different promoters may direct the expression of a gene in different tissues or cell types, or at different stages of development, or in response to different environmental conditions. It is further recognized that since in most cases the exact boundaries of regulatory sequences have not been completely defined, DNA fragments of some variation may have identical promoter activity.

As used herein, the phrases “recombinant construct”, “expression construct”, “chimeric construct”, “construct”, and “recombinant DNA construct” are used interchangeably herein. Also, “construct”, “vector”, and “plasmid” are used interchangeably herein. A recombinant construct comprises an artificial combination of nucleic acid fragments, e.g., regulatory and coding sequences that are not found together in nature. For example, a chimeric construct may comprise regulatory sequences and coding sequences that are derived from different sources, or regulatory sequences and coding sequences derived from the same source, but arranged in a manner different than that found in nature. Such construct may be used by itself or may be used in conjunction with a vector. If a vector is used then the choice of vector is dependent upon the method that will be used to transform host cells. For example, a plasmid vector can be used. The skilled artisan is well aware of the genetic elements that must be present on the vector in order to successfully transform, select and propagate host cells comprising any of the isolated nucleic acid fragments of the disclosure. The skilled artisan will also recognize that different independent transformation events will result in different levels and patterns of expression (Jones et al., (1985) EMBO J. 4:2411-2418; De Almeida et al., (1989) Mol. Gen. Genetics 218:78-86), and thus that multiple events must be screened in order to obtain lines displaying the desired expression level and pattern. Such screening may be accomplished by Southern analysis of DNA, Northern analysis of mRNA expression, immunoblotting analysis of protein expression, or phenotypic analysis, among others. Vectors can be plasmids, viruses, bacteriophages, pro-viruses, phagemids, transposons, artificial chromosomes, and the like, that replicate autonomously or can integrate into a chromosome of a host cell. A vector can also be a naked RNA polynucleotide, a naked DNA polynucleotide, a polynucleotide composed of both DNA and RNA within the same strand, a poly-lysine-conjugated DNA or RNA, a peptide-conjugated DNA or RNA, a liposome-conjugated DNA, or the like, that is not autonomously replicating. As used herein, the term “expression” refers to the production of a functional end-product e.g., an mRNA or a protein (precursor or mature).

“Operably linked” means in this context the sequential arrangement of the promoter polynucleotide according to the disclosure with a further oligo- or polynucleotide, resulting in transcription of said further polynucleotide.

As used herein, the term “display” refers to the exposure of the polypeptide of interest on the outer surface of the minicell. By way of non-limiting example, the displayed polypeptide may be a protein or a protein domain which is either expressed on the minicell membrane or is associated with the minicell membrane such that the extracellular domain or domain of interest is exposed on the outer surface of the minicell (expressed and displayed on the surface of the minicell or expressed in the parental cell to be displayed on the surface of the segregated/budded minicell). In all instances, the “displayed” protein or protein domain is available for interaction with extracellular components. A membrane-associated protein may have more than one extracellular domain, and a minicell of the disclosure may display more than one membrane-associated protein.

As used herein, the terms “polypeptide”, “protein” and “protein domain” refer to a macromolecule made up of a single chain of amino acids joined by peptide bonds. Polypeptides of the disclosure may comprise naturally occurring amino acids, synthetic amino acids, genetically encoded amino acids, non-genetically encoded amino acids, and combinations thereof. Polypeptides may include both L-form and D-form amino acids.

As used herein, the term “enzymatically bioactive polypeptide” refers to a polypeptide which encodes an enzymatically functional protein. The term “enzymatically bioactive polypeptide” includes but not limited to fusion proteins which perform a biological function. Exemplary enzymatically bioactive polypeptides, include but not limited to enzymes/enzyme moiety (e.g. wild type, variants, or engineered variants) that specifically bind to certain receptors or biological/chemical substrates to effect a biological function such as biological signal transduction or chemical inactivation.

As used herein, the term “ribonuclease-deficient strain” refers to a strain that is deficient in one or more endogenous ribonuclease. For example, ribonuclease deficiency can be created by deleting, removing, knock-out, silencing, suppressing, or otherwise downregulating at lease on endogenous ribonuclease. Said ribonuclease can include ribonuclease III. For example, HT115 E. coli strain is deficient in RNase III. In some embodiments, a ribonuclease-deficient strain is unable to and/or has a reduced capability of recognizing dsRNA and cleaving it at specific targeted locations. “Ribonuclease-deficient” can be interchangeably used as “ribonuclease-free” in the present disclosure.

As used herein, the term “anucleated cell” refers to a cell that lacks a nucleus and also lacks chromosomal DNA and which can also be termed as an “anucleate cell”. Because eubacterial and archaebacterial cells, unlike eukaryotic cells, naturally do not have a nucleus (a distinct organelle that contains chromosomes), these non-eukaryotic cells are of course more accurately described as being “without chromosomes” or “achromosomal.” Nonetheless, those skilled in the art often use the term “anucleated” when referring to bacterial minicells in addition to other eukaryotic minicells. Accordingly, in the present disclosure, the term “minicells” encompasses derivatives of eubacterial cells that lack a chromosome; derivatives of archaebacterial cells that lack their chromosome(s), and anucleate derivatives of eukaryotic cells that lack a nucleus and consequently a chromosome. Thus, in the present disclosure, “anucleated cell” or “anucleate cell” can be interchangeably used with the term “achromosomal cell.”

As used herein, the term “binding site,” means a molecular structure or compound, such as a protein, a polypeptide, a polysaccharide, a glycoprotein, a lipoprotein, a fatty acid, a lipid or a nucleic acid or a particular region in such molecular structure or compound or a particular conformation of such molecular structure or compound, or a combination or complex of such molecular structures or compounds. In certain embodiments, at least one binding site is on an intact living plant. An “intact living plant,” as used herein, means a plant as it grows, whether it grows in soil, in water or in artificial substrate, and whether it grows in the field, in a greenhouse, in a yard, in a garden, in a pot or in hydroponic culture systems. An intact living plant preferably comprises all plant parts (roots, stem, branches, leaves, needles, thorns, flowers, seeds etc.) that are normally present on such plant in nature, although some plant parts, such as, e.g., flowers, may be absent during certain periods in the plant's life cycle.

A “binding domain,” as used herein, means the whole or part of a proteinaceous (protein, protein-like or protein containing) molecule that is capable of binding using specific intermolecular interactions to a target molecule. A binding domain can be a naturally occurring molecule, it can be derived from a naturally occurring molecule, or it can be entirely artificially designed. A binding domain can be based on domains present in proteins, including but not limited to microbial proteins, protease inhibitors, toxins, fibronectin, lipocalins, single-chain antiparallel coiled coil proteins or repeat motif proteins. Non-limiting examples of such binding domains are carbohydrate binding modules (CBM) such as cellulose binding domain to be targeted to a locus. In some embodiments, a cell adhesion moiety comprises a binding domain.

As used herein, “carrier,” “acceptable carrier,” or “biologically acceptable carrier” refers to a diluent, adjuvant, excipient, or vehicle with which a composition can be administered to its target, which does not detrimentally effect the composition.

As used herein, “plants” and “plant derivatives” can refer to any portion of a growing plant, including the roots, stems, stalks, leaves, branches, seeds, flowers, fruits, and the like. For example, cinnamon essential oil can be derived from the leaves or bark of a cinnamon plant.

As used herein, the term “essential oils” refers to aromatic, volatile liquids extracted from plant material. Essential oils are often concentrated hydrophobic liquids containing volatile aroma compounds. Essential oil chemical constituents can fall within general classes, such as terpenes (e.g., p-Cymene, limonene, sabinene, a-pinene, y-terpinene, b-caryophyllene), terpenoids (e.g., geraniol, citronellal, thymol, carvacrol, carvone, borneol) and phenylpropanoids (e.g., cinnamaldehyde, eugenol, vanillin, safrole). Essential oils can be natural (i.e., derived from plants), or synthetic.

As used herein, the term “essential oil” encompasses within the scope of the present disclosure also botanical oils and lipids. Non-limiting examples of essential oils are sesame oil, pyrethrum (extract), glycerol-derived lipids or glycerol fatty acid derivatives, cinnamon oil, cedar oil, clove oil, geranium oil, lemongrass oil, angelica oil, mint oil, turmeric oil, wintergreen oil, rosemary oil, anise oil, cardamom oil, caraway oil, chamomile oil, coriander oil, guaiacwood oil, cumin oil, dill oil, mint oil, parsley oil, basil oil, camphor oil, cananga oil, citronella oil, eucalyptus oil, fennel oil, ginger oil, copaiba balsam oil, perilla oil, cedarwood oil, jasmine oil, palmarosa sofia oil, western mint oil, star anis oil, tuberose oil, neroli oil, tolu balsam oil, patchouli oil, palmarosa oil, Chamaecyparis obtusa oil, Hiba oil, sandalwood oil, petitgrain oil, bay oil, vetivert oil, bergamot oil, Peru balsam oil, bois de rose oil, grapefruit oil, lemon oil, mandarin oil, orange oil, oregano oil, lavender oil, Lindera oil, pine needle oil, pepper oil, rose oil, iris oil, sweet orange oil, tangerine oil, tea tree oil, tea seed oil, thyme oil, thymol oil, garlic oil, peppermint oil, onion oil, linaloe oil, Japanese mint oil, spearmint oil, ajowan oil, giant knotweed extract, and others as disclosed herein throughout.

As used herein, the term “stabilize” or “stabilizing” when used with respect to a bioactive agent, a bioactive ingredients, a composition, a compound, or a formulation refers to prevention of chemical or biological degradation of the bioactive agent in thermal or pH change. In some embodiments, “stabilize” or “stabilizing” includes prevention of pH-driven chemical degradation of a bioactive agent and prevention of temperature-driven degradation of a bioactive agent. In further embodiments, “stabilize” or “stabilizing” includes prevention against oxidative stress/oxidation, hydrolysis, and any other form of chemical degradation.

The term “bioavailability” includes, generally, the degree to which a bioactive agent, a bioactive ingredient, a drug or other substance becomes available to a target subject after delivery, application or administration. In some embodiments, the term “bioavailability” refers to effective dose of a bioactive agent that reaches intended target, locus or subject.

The term “depletion flocculation” refers to that depletion forces destabilize colloids and bring the dispersed particles together resulting in flocculation. The particles are no longer dispersed in the liquid but concentrated in floc formations. In some embodiments, a bioactive agent taught herein is preserved from depletion flocculation in acidic condition by minicells taught herein.

The preset disclosure provides a novel minicell platform using AgriCell technology, which is a highly modular and tunable biological microcapsule that can encapsulate, stabilize, and effectively deliver a sustained release of a bioactive ingredients with insecticidal activity to control insects. The key to the AgriCell technology is that it harnesses the capabilities of synthetic biology to produce a bioencapsulation technology that is environmentally compatible, modular in its functionality, and scalable for agricultural applications. Bioactive, non-pathogenic microbial cells are engineered to produce a bioparticle through asymmetric cell division. These bioparticles are small (about less than 1 μm in diameter), spherical versions of their parent microbial cells and they maintain the properties of the parent cell with one major difference: they lack chromosomal DNA. Therefore, the biological particles retain the benefits of the parent microbe, but do not risk contaminating the environment with modified DNA or outcompeting native species since they do not propagate.

Also, the present disclosure a novel minicell platform using AgriCell technology, which represents a potential platform which not only acts as potent candidate delivery systems but also provide a tool for efficient insect control systems.

In some embodiments, the minicells taught herein are naturally occurring anucleate cells.

In other embodiments, the present disclose teaches novel minicells that are engineered to encapsulate high-payload capacities of bioactive ingredients for controlling insects. Also, the robustness of minicell production is improved.

The present disclosure teaches that microencapsulation of biologically active agents/ingredients into AgriCell has two functions: (1) to enhance thermo stability, photo stability, shelf-life, and biological activity of bioinsecticides including the essential oils; and (2) to ensure targeted delivery of biopesticides to a locus. The present disclosure teaches to overcome imitations of bioactive agents, especially essential oils, as biopesticides such as (i) Essential Oils (EOs) affected by environmental conditions (light, temperature, or moisture); (ii) high reactivity and volatility; (iii) interaction with other matrices; (iv) low bioavailability and stability, or (v) strong odor and taste.

The present disclosure further provides that the AgriCell as minicells taught herein, serves as a carrier that protects bioactive agents/ingredients from environmental stresses until it delivers its high-payload capacity slowly to a subject through the natural breakdown of its biodegradable membrane. This bio-encapsulation technology overcomes many of the problems of bioactive agent delivery and can serve as the much-needed replacement to traditional techniques using plastic microcapsules.

In some embodiments, the AgriCell technology can be engineered in various ways to improve stability of bioactive agents (such as essential oils) encapsulated into the AgriCell and provide tailored controlled release profiles of the bioactive agents.

In other embodiments, the AgriCell technology can also be genetically engineered in various ways to enhance/improve bioavailability or sustainability of biopesticides or maintain insecticidal activity of biopesticides in an extended or controlled manner. The advantages of AgriCell platform include the simplicity of the production method, and safety.

The present disclosure teaches successful encapsulation of different bioactive ingredients of interest into minicells as the AgriCell platform for applications of insect pest control, shows outstanding biological activity, improved stability and controlled release.

In some embodiments, the bioactive ingredients successfully encapsulated by the AgriCell platform indicate its biological effect and common drawbacks of unencapsulated bioactive ingredients overcome by AgriCell encapsulation.

### Minicells

Minicells are the result of aberrant, asymmetric cell division, and contain membranes, peptidoglycan, ribosomes, RNA, protein, and often plasmids but no chromosome. (Frazer AC and Curtiss III, Production, Properties and Utility of Bacterial Minicells, Curr. Top. Microbial. Immunol. 69:1-84 (1975)). Because minicells lack chromosomal DNA, minicells cannot divide or grow, but they can continue other cellular processes, such as ATP synthesis, replication and transcription of plasmid DNA, and translation of mRNA. Although chromosomes do not segregate into minicells, extrachromosomal and/or episomal genetic expression elements may segregate, or may be introduced into minicells after segregation from parent cells.

In some embodiments, the minicells described herein are naturally occurring.

In other embodiments, the minicells described herein are non-naturally occurring.

In some embodiments, the disclosure provides a composition comprising a plurality of minicells. In some embodiments, the disclosure provides a composition comprising a plurality of minicells comprising at least one biologically active compound within said cell. In some embodiments, the disclosure provides a composition comprising a plurality of minicells, each minicell of said plurality comprises an enzymatically bioactive polypeptide displayed on the surface of the minicell, said enzymatically bioactive polypeptide has enzymatic activity. The enzymatic activity is derived from enzymatically bioactive polypeptides disclosed in the present disclosure.

In some embodiments, the disclosure provides a composition comprising a plurality of intact, bacterially-derived minicells. In some embodiments, the disclosure provides a composition comprising a plurality of intact, bacterially-derived minicells comprising at least one biologically active compound within said cell. In some embodiments, the disclosure provides a composition comprising a plurality of intact, bacterially-derived minicells, each minicell of said plurality comprises an enzymatically bioactive polypeptide displayed on the surface of the bacterial minicell, said enzymatically bioactive polypeptide has enzymatic activity. In some embodiments, the composition comprises minicells which further comprise a second polypeptide displayed on the surface of the bacterial minicell, to increase adhesion to a subject and/or subjects including, but are not limited to substrates of enzymes, receptors, metal, plastic, soil, bacteria, fungi, pathogens, germs, insects, plants, animals, human, and the like. In some embodiments, the composition comprises a mixture of minicells, certain minicells within the mixed minicell population display the enzymatically bioactive polypeptide or display the second polypeptide including subject adhesion increasing polypeptide or display both.

The term “minicell” in this disclosure refers to the result of aberrant, asymmetric cell division, and contain membranes, peptidoglycan, ribosomes, RNA, protein, and often plasmids but no chromosome. Because minicells lack chromosomal DNA, minicells cannot divide or grow, but they can continue other cellular processes, such as ATP synthesis, replication and transcription of plasmid DNA, and translation of mRNA. Although chromosomes do not segregate into minicells, extrachromosomal and/or episomal genetic expression elements may segregate or may be introduced into minicells after segregation from parent cells. In some embodiments, the minicells described herein are naturally occurring. In other embodiments, the minicells described herein are non-naturally occurring. In some embodiments, minicells can be loaded with the biologically active agents described herein.

Minicells are derivatives of cells that lack chromosomal DNA and which are sometimes referred to as anucleate cells. Because eubacterial and archeabacterial cells, unlike eukaryotic cells, do not have a nucleus (a distinct organelle that contains chromosomes), these non-eukaryotic minicells are more accurately described as being “without chromosomes” or “achromosomal,” as opposed to “anucleate.” Nonetheless, those skilled in the art often use the term “anucleate” when referring to bacterial minicells in addition to other minicells. Accordingly, in the present disclosure, the term “minicells” encompasses derivatives of eubacterial cells that lack a chromosome; derivatives of archeabacterial cells that lack their chromosome(s), and anucleate derivatives of eukaryotic cells.

A description of minicells and methods of making and using such minicells can be found, for example, in International Patent application Nos. WO2018/201160, WO2018/201161, WO2019/060903, and WO2021/133846, all of which are incorporated herein by reference.

Eubacterial Minicells

One type of minicell is a eubacterial minicell. For reviews of eubacterial cell cycle and division processes, see Rothfield et al., Annu. Rev. Genet., 33:423-48, 1999; Jacobs et al., Proc. Natl. Acad. Sci. USA, 96:5891-5893, May, 1999; Koch, Appl. and Envir. Microb., Vol. 66, No. 9, pp. 3657-3663; Bouche and Pichoff, Mol Microbiol, 1998. 29: 19-26; Khachatourians et al., J Bacteriol, 1973. 116: 226-229; Cooper, Res Microbiol, 1990. 141: 17-29; and Danachie and Robinson, “Cell Division: Parameter Values and the Process,” in: Escherichia Coli and Salmonella Typhimurium: Cellular and Molecular Biology, Neidhardt, Frederick C., Editor in Chief, American Society for Microbiology, Washington, D.C., 1987, Volume 2, pages 1578-1592, and references cited therein; and Lutkenhaus et al., “Cell Division,” Chapter 101 in: Escherichia coli and Salmonella typhimurium: Cellular and Molecular Biology, 2^{nd} Ed., Neidhardt, Frederick C., Editor in Chief, American Society for Microbiology, Washington, D.C., 1996, Volume 2, pages 1615-1626, and references cited therein. When DNA replication and/or chromosomal partitioning is altered, membrane-bounded vesicles “pinch off” from parent cells before transfer of chromosomal DNA is completed. As a result of this type of dysfunctional division, minicells are produced which contain an intact outer membrane, inner membrane, cell wall, and all of the cytoplasm components but do not contain chromosomal DNA.

In some embodiments, the bacterially-derived minicells are produced from a strain, including, but are not limited to a strain of Escherichia coli, Bacillus spp., Salmonella spp., Listeria spp., Mycobacterium spp., Shigella spp., or Yersinia spp. In some embodiments, the bacterially-derived minicells are produced from a strain that naturally produces minicells. Such natural minicell producing strains produce minicells, for example, at a 2:1 ratio (2 bacterial cells for every one minicell). In certain embodiments, exemplary bacterial strains that naturally produce minicells include, but are not limited to E. coli strain number P678-54, Coli Genetic Stock Center (CGSC) number: 4928 and B. subtilis strain CU403.

As one example, mutations in B. subtilis smc genes result in the production of minicells (Britton et al., 1998, Genes and Dev. 12:1254-1259; Moriya et al., 1998, Mol Microbiol 29:179-87). Disruption of smc genes in various cells is predicted to result in minicell production therefrom.

As another example, mutations in the divIVA gene of Bacillus subtilis results in minicell production. When expressed in E. coli, B. subtilis or yeast Schizosaccharomyces pombe, a DivIVA-GFP protein is targeted to cell division sites therein, even though clear homologs of DivIVA do not seem to exist in E. coli, B. subtilis or S. pombe (David et al., 2000, EMBO J. 19:2719-2727. Over- or under-expression of B. subtilis DivIVA or a homolog thereof may be used to reduce minicell production in a variety of cells.

In some embodiments, the minicell-producing bacteria is a Gram-negative bacteria. The Gram-negative bacteria includes, but is not limited to, Escherichia coli, Salmonella spp. including Salmonella typhimurium, Shigella spp. including Shigella flexneri, Pseudomonas aeruginosa, Agrobacterium, Campylobacter jejuni, Lactobacillus spp., Neisseria gonorrhoeae, and Legionella pneumophila. In some embodiments, the minicell-producing gram-negative bacteria can produce minicells naturally caused by endogenous or exogenous mutation(s) associated with cell division and/or chromosomal partitioning. In some embodiments, the minicell-producing bacteria comprises endogenous or exogenous gene(s) that is involved in cell division and/or chromosomal partitioning, where the gene is genetically modified such as by homologous recombination, compared to a corresponding wild-type gene. In some embodiments, the minicell-producing gram-negative bacteria is deficient in protease and/or its activity naturally and/or by genetic engineering techniques disclosed herein. In some embodiments, the protease-deficient minicell-producing gram-negative bacteria comprises a recombinant expression vector comprising a gene or genes that is involved in a protein of interest disclosed in the present disclosure.

In some embodiments, the minicell-producing bacteria can be a Gram-positive bacteria. The Gram-positive bacteria includes, but is not limited to, Bacillus subtilis, Bacillus cereus, Corynebacterium Glutamicum, Lactobacillus acidophilus, Staphylococcus spp., or Streptococcus spp. In some embodiments, the minicell-producing gram-positive bacteria can produce minicells naturally caused by endogenous or exogenous mutation(s) associated with cell division and/or chromosomal partitioning. In some embodiments, the minicell-producing gram-positive bacteria comprises endogenous or exogenous gene(s) that is involved in cell division and/or chromosomal partitioning, where the gene is genetically modified such as by homologous recombination, compared to a corresponding wild-type gene. In some embodiments, the minicell-producing gram-positive bacteria is deficient in protease and/or its activity naturally and/or by genetic engineering techniques disclosed herein. In some embodiments, the protease-deficient minicell-producing gram-positive bacteria comprises a recombinant expression vector comprising a gene or genes that is involved in a protein of interest disclosed in the present disclosure.

The minicell-producing bacteria can be a Extremophilic bacteria. The Extremophilic bacteria includes, but is not limited to, Thermophiles including Thermus aquaticus, Psychrophiles, Piezophiles, Halophilic bacteria, Acidophile, Alkaliphile, Anaerobe, Lithoautotroph, Oligotroph, Metallotolerant, Oligotroph, Xerophil or Polyextremophile. In some embodiments, the minicell-producing Extremophilic bacteria can produce minicells naturally caused by endogenous or exogenous mutation(s) associated with cell division and/or chromosomal partitioning. In some embodiments, the minicell-producing Extremophilic bacteria comprises endogenous or exogenous gene(s) that is involved in cell division and/or chromosomal partitioning, where the gene is genetically modified such as by homologous recombination, compared to a corresponding wild-type gene. In some embodiments, the minicell-producing Extremophilic bacteria is deficient in protease and/or its activity naturally and/or by genetic engineering techniques disclosed herein. In some embodiments, the protease-deficient minicell-producing Extremophilic bacteria comprises a recombinant expression vector comprising a gene or genes that is involved in a protein of interest disclosed in the present disclosure.

Eukaryotic Minicells

Achromosomal eukaryotic minicells (i.e., anucleate cells) are within the scope of the disclosure. Yeast cells are used to generate fungal minicells. See, e.g., Lee et al., Ibd1p, a possible spindle pole body associated protein, regulates nuclear division and bud separation in Saccharomyces cerevisiae, Biochim Biophys Acta 3:239-253, 1999; Kopecka et al., A method of isolating anucleate yeast protoplasts unable to synthesize the glucan fibrillar component of the wall J Gen Microbiol 81:111-120, 1974; and Yoo et al., Fission yeast Hrp1, a chromodomain ATPase, is required for proper chromosome segregation and its overexpression interferes with chromatin condensation, Nucl Acids Res 28:2004-2011, 2000. Cell division in yeast is reviewed by Gould and Simanis, The control of septum formation in fission yeast, Genes & Dev 11:2939-51, 1997).

In some embodiments, the eukaryotic minicells can be produced from yeast cells, such as Saccharomyces cerevisiae, Pichia pastoris and/or Schizosaccharomyces pombe.

As one example, mutations in the yeast genes encoding TRF topoisomerases result in the production of minicells, and a human homolog of yeast TRF genes has been stated to exist (Castano et al., 1996, Nucleic Acids Res 24:2404-10). Mutations in a yeast chromodomain ATPase, Hrp1, result in abnormal chromosomal segregation; (Yoo et al., 2000 Nuc. Acids Res. 28:2004-2011). Disruption of TRF and/or Hrp1 function is predicted to cause minicell production in various cells. Genes involved in septum formation in fission yeast (see, e.g., Gould et al., 1997 Genes and Dev. 11:2939-2951) can be used in like fashion.

Platelets are a non-limiting example of eukaryotic minicells. Platelets are anucleate cells with little or no capacity for de novo protein synthesis. The tight regulation of protein synthesis in platelets (Smith et al., 1999, Vasc Med 4:165-72) may allow for the over-production of exogenous proteins and, at the same time, under-production of endogenous proteins. Thrombin-activated expression elements such as those that are associated with Bcl-3 (Weyrich et al., Signal-dependent translation of a regulatory protein, Bcl-3, in activated human platelets, Cell Biology 95:5556-5561, 1998) may be used to modulate the expression of exogenous genes in platelets.

As another non-limiting example, eukaryotic minicells are generated from tumor cell lines (Gyongyossy-Issa and Khachatourians, Tumour minicells: single, large vesicles released from cultured mastocytoma cells (1985) Tissue Cell 17:801-809; Melton, Cell fusion-induced mouse neuroblastomas HPRT revertants with variant enzyme and elevated HPRT protein levels (1981) Somatic Cell Genet. 7: 331-344).

Yeast cells are used to generate fungal minicells. See, e.g., Lee et al., Ibd1p, a possible spindle pole body associated protein, regulates nuclear division and bud separation in Saccharomyces cerevisiae, Biochim Biophys Acta 3:239-253, 1999; Kopecka et al., A method of isolating anucleate yeast protoplasts unable to synthesize the glucan fibrillar component of the wall J Gen Microbiol 81:111-120, 1974; and Yoo et al., Fission yeast Hrp1, a chromodomain ATPase, is required for proper chromosome segregation and its overexpression interferes with chromatin condensation, Nucl Acids Res 28:2004-2011, 2000. Cell division in yeast is reviewed by Gould and Simanis, The control of septum formation in fission yeast, Genes & Dev 11:2939-51, 1997). In some embodiments, the present disclosure teaches production of yeast minicells.

Archaebacterial Minicells

The term “archaebacterium” is defined as is used in the art and includes extreme thermophiles and other Archaea (Woese, C. R., L. Magrum. G. Fox. 1978. Archaebacteria. Journal of Molecular Evolution. 11:245-252). Three types of Archaebacteria are halophiles, thermophiles and methanogens. By physiological definition, the Archaea (informally, archaes) are single-cell extreme thermophiles (including thermoacidophiles), sulfate reducers, methanogens, and extreme halophiles. The thermophilic members of the Archaea include the most thermophilic organisms cultivated in the laboratory. The aerobic thermophiles are also acidophilic; they oxidize sulfur in their environment to sulfuric acid. The extreme halophiles are aerobic or microaerophilic and include the most salt tolerant organisms known. The sulfate-reducing Archaea reduce sulfate to sulfide in extreme environment. Methanogens are strict anaerobes, yet they gave rise to at least two separate aerobic groups: the halophiles and a thermoacidophilic lineage. Non-limiting examples of halophiles include Halobacterium cutirubrum and Halogerax mediterranei. Non-limiting examples of methanogens include Methanococcus voltae; Methanococcus vanniela; Methanobacterium thermoautotrophicum; Methanococcus voltae; Methanothermus fervidus; and Methanosarcina barkeri. Non-limiting examples of thermophiles include Azotobacter vinelandii; Thermoplasma acidophilum; Pyrococcus horikoshii; Pyrococcus furiosus; and Crenarchaeota (extremely thermophilic archaebacteria) species such as Sulfolobus solfataricus and Sulfolobus acidocaldarius.

Archaebacterial minicells are within the scope of the disclosure. Archaebacteria have homologs of eubacterial minicell genes and proteins, such as the MinD polypeptide from Pyrococcus furiosus (Hayashi et al., EMBO J. 20:1819-28, 2001). It is thus possible to create Archaebacterial minicells by methods such as, by way of non-limiting example, overexpressing the product of a min gene isolated from a prokaryote or an archaebacterium; or by disrupting expression of a min gene in an archaebacterium of interest by, e.g., the introduction of mutations thereof or antisense molecules thereto. See, e.g., Laurence et al., Genetics 152:1315-1323, 1999.

By physiological definition, the Archaea (informally, archaes) are single-cell extreme thermophiles (including thermoacidophiles), sulfate reducers, methanogens, and extreme halophiles. The thermophilic members of the Archaea include the most thermophilic organisms cultivated in the laboratory. The aerobic thermophiles are also acidophilic; they oxidize sulfur in their environment to sulfuric acid. The extreme halophiles are aerobic or microaerophilic and include the most salt tolerant organisms known. The sulfate-reducing Archaea reduce sulfate to sulfide in extreme environment. Methanogens are strict anaerobes, yet they gave rise to at least two separate aerobic groups: the halophiles and a thermoacidophilic lineage. In some embodiments, the present disclosure teaches production of archaeal minicells.

Minicells Derived from Endophytes

An endophyte is an endosymbiont, often a bacterium or fungus, that lives within a plant for at least part of its life cycle. The endophyte can transport itself from the environment to internal organs of plants. Non-limiting examples of endophytes include Acidovorax facilis, Bradyrhizobium, Rhizobium, Rhodococcus rhodochrous, Colletotrichum, Curvularia, Epichloe, Fusarium, Mycosphaerella, Neotyphodium, Piriformospora, and Serendipita. In some embodiments, the present disclosure teaches production of endophyte-derived minicells. In other embodiments, endophyte-derived minicells can enter into internal plant cell, tissues, or organs, and function as an invasive minicell.

Fungal endophytes have the ability to colonize inter- or intra-cellularly. The colonization process involves several steps, including host recognition, spore germination, penetration of the epidermis and tissue multiplication. Once the endophytes are successfully colonized in the host tissue, the endophytic niche becomes established. In the endophytic niche, endophytes will obtain a reliable source of nutrition from the plant fragment, exudates and leachates and protect the host against other microorganisms. In some embodiments, minicells produced from fungal endophytes can transmit the bioactive compounds within and/or on their surface to a target using their invasive capability.

Minicells Derived from Plant Pathogen Bacteria

The present disclosure provides plant pathogen bacteria, which can be utilized for minicell production, including but are not limited to (1) Pseudomonas syringae pathovars; (2) Ralstonia solanacearum; (3) Agrobacterium tumefaciens; (4) Xanthomonas oryzae pv. oryzae; (5)Xanthomonas campestris pathovars; (6)Xanthomonas axonopodis pathovars; (7) Erwinia amylovora; (8) Xylella fastidiosa; (9) Dickeya (dadantii and solani); (10) Pectobacterium carotovorum (and Pectobacterium atrosepticum), (11) Clavibacter michiganensis (michiganensis and sepedonicus), (12) Pseudomonas savastanoi, and (13) Candidatus Liberibacter asiaticus. Such plant pathogen bacteria natively have the capacity to penetrate and invade into internal host tissues in their natural state. In some embodiments, minicells derived from plant pathogen bacteria described above can naturally deliver biologically active compounds disclosed herein into internal cells, tissues, and/or organs of a target host in their natural ability of invasion, penetration, and/or transmission into internal parts of a target.

From example, some pathogen bacteria are found to secrete cell wall-degrading endoglucanase and endopolygalacturonase, potentially explaining penetration into the root endosphere. Other pathogen bacteria can penetrate through the stomata into the substomatal chamber, and colonization of the intercellular spaces of the leaf mesophyll. The minicells produced from these pathogen bacteria possess and utilize natural ability of invading, penetrating and/or transmitting for scalable and targeted delivery of bioactive compounds disclosed herein.

### Bacterial Minicell Production

Minicells are produced by parent cells having a mutation in, and/or overexpressing, or under expressing a gene involved in cell division and/or chromosomal partitioning, or from parent cells that have been exposed to certain conditions, that result in aberrant fission of bacterial cells and/or partitioning in abnormal chromosomal segregation during cellular fission (division). The term “parent cells” or “parental cells” refers to the cells from which minicells are produced. Minicells, most of which lack chromosomal DNA (Mulder et al., Mol Gen Genet, 221: 87-93, 1990), are generally, but need not be, smaller than their parent cells. Typically, minicells produced from E. coli cells are generally spherical in shape and are about 0.1 to about 0.3 μm in diameter, whereas whole E. coli cells are about from about 1 to about 3 μm in diameter and from about 2 to about 10 μm in length. Micrographs of E. coli cells and minicells that have been stained with DAPI (4:6-diamidino-z-phenylindole), a compound that binds to DNA, show that the minicells do not stain while the parent E. coli are brightly stained. Such micrographs demonstrate the lack of chromosomal DNA in minicells. (Mulder et al., Mol. Gen. Genet. 221:87-93, 1990).

Minicells are achromosomal, membrane-encapsulated biological nanoparticles (≤1 μm) that are formed by bacteria following a disruption in the normal division apparatus of bacterial cells. In essence, minicells are small, metabolically bioactive replicas of normal bacterial cells with the exception that they contain no chromosomal DNA and as such, are non-dividing and non-viable. Although minicells do not contain chromosomal DNA, the ability of plasmids, RNA, native and/or recombinantly expressed proteins, and other metabolites have all been shown to segregate into minicells. Some methods of construction of minicell-producing bacterial strains are discussed in detail in U.S. patent application Ser. No. 10/154,951 (US Publication No. US/2003/0194798 A1), which is hereby incorporated by reference in its entirety.

Disruptions in the coordination between chromosome replication and cell division lead to minicell formation from the polar region of most rod-shaped prokaryotes. Disruption of the coordination between chromosome replication and cell division can be facilitated through the overexpression of some of the genes involved in septum formation and binary fission. Alternatively, minicells can be produced in strains that harbor mutations in genes that modulate septum formation and binary fission. Impaired chromosome segregation mechanisms can also lead to minicell formation as has been shown in many different prokaryotes.

A description of methods of making, producing, and purifying bacterial minicells can be found, for example, in International Patent application No. WO2018/201160, WO2018/201161, WO2019/060903, and WO2021/133846, which are incorporated herein by reference.

Also, a description of strains for producing minicells an be found, for example, in International Patent application No. WO2019/060903, and WO2021/133846, which are incorporated herein by reference.

In some embodiments, the present disclosure teaches a composition comprising: a minicell and a bioactive agent. In some embodiments, the minicell is derived from a bacterial cell. In some embodiments, the minicell is less than or equal to 1 μm in diameter. The minicell is about 10 nm-about 1000 nm in size, about 20 nm-about 990 nm in size, about 30 nm-about 980 nm in size, about 50 nm-about 950 nm in size, about 100 nm-about 900 nm in size, about 150 nm-about 850 nm in size, about 200 nm-about 800 nm in size, or about 30 nm-about 700 nm in size.

### Biologically Active Compounds

The present disclosure provides biologically active compounds for controlling one or more insect species, as well as a minicell-based platform and/or an agricultural formulation for the encapsulation and delivery of biologically active compounds to a target, locus, or subject. In some embodiments, the minicell-based platform and/or an agricultural formulation comprises an intact minicell, which comprises at least one biologically active compounds. By way of non-limiting example, the biologically active compound is bioinsecticides including, but are not limited to, essential oils, botanical ingredients, saponins, and combinations thereof. There is currently great interest in the agricultural industry to begin replacing some of these synthetic compounds with their biologically derived counterparts. In some embodiments, the biologically active compound is a bioinsecticide.

In some embodiments, the present disclose teaches a composition comprising: a minicell and a bioactive agent with insecticidal activity. The bioactive agent is encapsulated by the minicell. The bioactive agent is a biologically active agent. In some embodiments, the biologically active agent is a botanical ingredient, an essential oil, or saponin. In some embodiments, the botanical ingredient is selected from the group consisting of pyrethrum, pyrethrin, rotenone, sabadilla, cevadine, veratridine, ryania, nicotine, and neen. In some embodiments, the essential oil is selected from the group consisting of thyme oil, rosemary oil, cinnamon oil, tea tree oil, peppermint oil, clove oil, orange oil, oregano oil, and neem oil, citronella oil, lemon grass oil, eucalyptus oil, lavender oil, and cedar oil. In some embodiments, said essential oil comprises thymol, geraniol, eugenol, myrcene, α-terpinene, p-cymene, d-limonene, menthol, α-pinene, β-pinene, pulegone, anisole, eucalyptol, geraniol, geranyl acetate, linalyl acetate, methyl anthranilate, cinnamaldehyde, methyl benzoate, azadirachtin, citronellal, nerolidol, pulegone, anethole, ethyl benzoate, emamectin benzoate, or benzyl benzoate. In some embodiments, saponins comprises hydrophilic sugar moiety linked to a hydrophobic aglycone. The different classes of saponins are triterpene, steroidal saponins, steroidal alkaloid).

Botanical Ingredient

Many plants and minerals have insecticidal properties; that is, they are toxic to insects. Botanical ingredients are naturally occurring chemicals (insect toxins) extracted or derived from plants or minerals. They are natural insecticides or bioinsecticides. Ingredients derived from plants are a bioactive agent with insecticidal activity. Products containing ingredients derived from plants are considered insecticides. The ingredients are described below.

In some embodiments, the insecticidal ingredient is Pyrethrum and Pyrethrins. Pyrethrum is the powdered, dried flower head of the pyrethrum is daisy, Chrysanthemum cinerariaefolium. The term “pyrethrum” is the name for the crude flower dust itself, and the term “pyrethrins” refers to the six related insecticidal compounds that occur naturally in the crude material, the pyrethrum flowers. They are extracted from crude pyrethrum dust as a resin that is used in the manufacture of various insecticidal products.

In some embodiments, the insecticidal ingredient is Rotenone. Rotenone is insecticidal compound that occurs in the roots of Lonchocarpus species in South America, Derris species in Asia, and several other related tropical legumes. Commercial rotenone was at one time produced from Malaysian Derris. Currently the main commercial source of rotenone is Peruvian Lonchocarpus, which often is referred to as cube root. Rotenone is extracted from cube roots in acetone or ether. Extraction produces a 2-40% rotenone resin which contains several related but less insecticidal compounds known as rotenoids. Cube roots may be dried, powdered and mixed directly with an inert carrier to form an insecticidal dust.

In some embodiments, the insecticidal ingredient is Sabadilla. Sabadilla is derived from the ripe seeds of Schoenocaulon officinale. Sabadilla is also known as cevadilla or caustic barley. When sabadilla seeds are aged, heated, or treated with alkali, several insecticidal alkaloids are formed or activated. Alkaloids are physiologically bioactive compounds that occur naturally in many plants. Caffeine, nicotine, cocaine, quinine, and strychnine are some of the more familiar alkaloids. The alkaloids in sabadilla are known collectively as veratrine or as the veratrine alkaloids. They constitute 3-6% of aged, ripe sabadilla seeds. Of these alkaloids, cevadine and veratridine are the most bioactive insecticidally.

In some embodiments, the insecticidal ingredient is Ryania, which comes from the woody stems of Ryania speciosa. The most bioactive compound in ryania is the alkaloid ryanodine, which constitutes approximately 0.2% of the dry weight of stem wood.

In some embodiments, the insecticidal ingredient is Nicotine, which is a simple alkaloid derived from tobacco, Nictiana tabacumn, and other Nicotiana species. insecticidal formulations generally contain nicotine in the form of 40% nicotine sulfate.

In some embodiments, the insecticidal ingredient is Neem, which is derived from the neem tree. The principle bioactive compound in neem is azadirachtin, a bitter, complex chemical that is both a feeding deterrent and a growth regulator. Meliantriol, salannin, and many other minor components of neem are also bioactive in various ways. Neem products include teas and dusts made from leaves and bark, extracts from whole fruits, seeds, or seed kernels, and an oil expressed from the seed kernel.

In some embodiments, the insecticidal ingredient are Limonene and Linalool. Crude citrus oils and the refined compounds, d-limonene (hereafter referred to simply as limonene) and linalool, are extracted from orange and other citrus fruit peels. Limonene, a terpene, constitutes about 90% of crude citrus oil, and is purified from the oil by steam distillation. Linalool, a terpene alcohol, is found in small quantities in citrus peel and in over 200 other herbs, flowers, fruits, and woods.

In some embodiments, the insecticidal ingredient are Essential Oils. Terpenes and terpene alcohols are among the major components of many plant volatiles or essential oils. Other components of essential oils are ketones, aldehydes, esters, and various alcohols. Essential oils are the volatile compounds responsible for most of the tastes and scents of plants. Many of the essential oils have some physiological activity including insecticidal activity.

Essential Oils

Essential oils (EOs) and plant extracts represent a major group of phytobiotics, consisting of a complex mixture of different volatile and non-volatile compounds. Due to their strong aromatic features and bioactivity, EOs have been widely used since ancient times in aromatherapy, as flavor and fragrances in cosmetics and foods, and more recently as pharmaceuticals, natural preservatives, additives, and biopesticides. The bioactivity of EOs depends on their complex mixture of volatile molecules produced by the secondary metabolism of aromatic and medical plants. Terpenoids are known as a major class of EOs components. Among natural compounds, the terpenoids are the largest family of plant secondary metabolites, with over 40,000 different chemical structures described to date. Factors that influence the bioactivity of EOs, regardless of the field of application, are related to plant species, growing conditions, harvest time, and plant chemotype, among others. Due to the volatile and reactive nature of EOs, their effectiveness in the field can be influenced by different conditions during production processes, storage of EOs, and environmental conditions.

The use of plant essential oils as insecticides is described in U.S. Pat. Nos. 4,518,593, 6,231,865, 7,534,447, 9,743,676, and in U.S. Pub. No. 2013/0142893 (the full disclosures of which are incorporated herein by reference in their entireties).

“Essential oil” is a concentrated hydrophobic liquid containing volatile aroma compounds from plants. Essential oils may contain a single component, or one or more major components together with one or more minor constituents. Essential oils within the context of the present disclosure include essential oils comprising mixtures of different constituents as well as essential oils which are enriched for one or more constituents or contain substantially a single essential oil constituent. Essential oils include essential oils, and constituents thereof, which are isolated from natural sources (e.g., plants) and/or prepared synthetically.

Essential oils such as peppermint oil (PO), thyme oil (TO), clove oil (CO), and cinnamon oil (CnO) have been used for their antibacterial, antiviral, anti-inflammatory, antifungal, and antioxidant properties. Terpenoids such as menthol and thymol and phenylpropenes such as eugenol and cinnamaldehyde are components of EOs that mainly influence antibacterial activities. For example, thymol is able to disturb micromembranes by integration of its polar head-groups in lipid bilayers and increase of the intracellular ATP concentration. Eugenol was also found to affect the transport of ions through cellular membranes. Cinnamaldehyde inhibits enzymes associated in cytokine interactions and acts as an ATPase inhibitor.

In some embodiments, terpenes are chemical compounds that are widespread in nature, mainly in plants as constituents of essential oils (EOs). Their building block is the hydrocarbon isoprene (C₅H₈)n.

In some embodiments, examples of terpenes include, but are not limited to citral, pinene, nerol, b-ionone, geraniol, carvacrol, eugenol, carvone, terpeniol, anethole, camphor, menthol, limonene, nerolidol, framesol, phytol, carotene (vitamin A1), squalene, thymol, tocotrienol, perillyl alcohol, borneol, myrcene, simene, carene, terpenene, and linalool.

A known simulated natural pesticide is Requiem®, which contains a mixture of three terpenes, i.e. α-terpinene, p-cymene and limonene, as pesticidally bioactive ingredients. It is disclosed in US 2010/0316738 corresponding to WO 2010/144919 and the references cited therein, which are incorporated herein by reference. WO 20120/144919 also discloses the use of the terpene mixture disclosed in this document in combination with one or more additional pesticidally bioactive ingredients against plant pests, such as a carrier, a solvent or another pesticide such as another insecticide or biopesticide. Examples for additional pesticides which are disclosed in the document are fungicides, insecticides, miticides or acaricides, bactericides and the like as well as combinations thereof.

The use of extracts comprising these three terpenes obtained from Chenopodium ambrosioides for controlling insect or mite infestation on plants is known, including the use of such extracts that include natural terpenes isolated form Chenopodium. See e.g. US 2003/0091657 and US 2009/0030087, WO 2001/067868 and WO 2004/006679 and William Quarles (1192) Botanical Pesticides from Chenopodium, The IPM Practitioner Volume XIV, Number 2, 11 pages; and Lorenzo Sagero-Nieves (March/April 1995) Volatile Constituents from the Leaves of Chenopodium ambrosioides L., J. Essent. Oil Res. 7:221-223.

There are, however, a number of drawbacks to the use of terpenes as EOs, such as (i) terpenes are liquids which can make them difficult to handle and unsuitable for certain purposes; (ii) terpenes are not very miscible with water, and it generally requires the use of detergents, surfactants or other emulsifiers to prepare aqueous emulsions, and (iii) terpenes are prone to oxidation in aqueous emulsion systems, which make long term storage a problem.

That is, the main limitations of EOs comprising terpenes and/or terpenoids are their inherent volatility and propensity to oxidize. These drawbacks limit the long-term insecticidal efficacy of EOs.

The present disclosure teaches novel delivery technologies, such as encapsulation using minicells, to protect the volatile compounds and bioactivity of EOs from (1) degradation and oxidation process occurring during feed processing and storage; (2) different conditions in the field and enable the controlled release; and (3) mixing with other crop inputs.

The present disclosure teaches that bioactive agents with insecticidal activity includes, but are not limited to, Thyme oil, Thymol, Rosemary oil, Geraniol, Cinnamon oil, Cinnamaldehyde, Methyl Benzoate, Tea Tree oil, Peppermint oil, Clove oil, Orange Oil, Oregano Oil, Neem Oil, Azadirachtin, Pyrethrum, Citronella oil, Citronellal, Eugenol, Rotenone, Nerolidol, Lemon grass oil, α-terpinene, p-cymene, d-limonene, eucalyptus oil, menthol, pulegone, Anethole, ethyl benzoate, emamectin benzoate, benzyl benzoate, lavender oil, cedar oil, Soaps comprising salts produced from the salts of fatty acids (such as potassium oleate), Saponins comprising hydrophilic sugar moiety linked to a hydrophobic aglycone (different classes of saponins: triterpene, steroidal saponins, steroidal alkaloid).

One of the insecticidal compositions from the bioactive agent of the present disclosure is Pyrethrin, which is a class of bioinsecticidal organic compounds derived from the plant Chrysanthemum cinerariifolium. In embodiments, said biological bioactive agents/ingredients/compound is an essential oil, which is a pyrethrum or pyrethrin.

Pyrethrum is the crude extract form obtained from flowers of the plant Chrysanthemum cinerariifolium. Pyrethrin refers to a more refined extract of pyrethrum. While pyrethrum extract is composed of 6 esters, both organic compounds mediate insecticidal activities. Pyrethrum-containing mixtures are used as a common insecticide to control specific pest species. Pyrethrum extract is also used to treat head, body, and pubic lice infections. The bioactive compound is absorbed by the lice and destroys them by acting on their nervous systems but is thought to exert minimal effect on humans.

Pyrethrum is a natural plant oil that occurs in the Pyrethrum daisy, Tanacetum cinerariaefolium, oil-containing glands on the surface of the seed case in the tightly packed flower head. Pyrethrum flowers are also known as a member of the chrysanthemum family (Chrysanthemum cinerariaefolium). It is found mainly in tiny n as Dalmatian Insect powder and Persian Insect powder. Several trade names associated with these compounds are Buhach, Chrysanthemum Cinerariaefolium, Ofirmotox, Insect Powder, Dalmation Insect Flowers, Firmotox, Parexan and NA 9184. The flowers of the plant are harvested shortly after blooming and are either dried and powdered or the oils within the flowers are extracted with solvents. The resulting mixture of pyrethrin containing dusts and extracts usually have a bioactive ingredient content of about 30%. These bioactive insecticidal components of pyrethrum are collectively known as pyrethrins. Two pyrethrins are most prominent, pyrethrin-I and pyrethrin-II. The pyrethrins include other bioactive ingredients such as Cinerin I and II, Jasmolin I and II, pyrethrosin, pyretol, pyrethrotoxic acid, chrysanthemine, chrysanthemumic acid. See, Merck Index, Eleventh ed., (1989).

Pyrethrin compounds have been used primarily to control human lice, mosquitoes, cockroaches, beetles and flies. Some “pyrethrin dusts,” used to control insects in horticultural crops, are only 0.3% to 0.5% pyrethrins, and are used at rates of up to 50 lb/Acre. Other pyrethrin compounds may be used in grain storage and in poultry pens and on dogs and cats to control lice and fleas. However, the natural pyrethrins are contact poisons which quickly penetrate the nervous system of the insect. A few minutes after application, the insect cannot move or fly away. The natural pyrethrins can be swiftly detoxified by enzymes in the insect. Semisynthetic derivatives of the chrysanthemumic acids have been developed as insecticides. These are called pyrethroids and tend to be more effective than natural pyrethrins while they are less toxic to mammals. One common synthetic group of pyrethroid compounds are the allethrins, also known as allyl cinerins (allethrin I and II).

Pyrethrum was used commercially as an insecticide, primarily in the form of “oleoresin of pyrethrum”. Oleoresin of pyrethrum is an archaic pharmaceutical term for an ether extract of the cinerariaefolium variety of Chrysanthemum. It contains volatile oils and components having insecticidal properties, called pyrethrins, jasmolins, and cinerins. These materials are known to be toxic to insects, essentially non-toxic to mammals, to lack persistence in the environment, and to be characterized by negligible biological magnification in the food chain.

As used herein, the term “pyrethrins” is intended to mean pyrethrin and its bioactive components. One of the problems with using pyrethrins as insecticides is their high cost per unit dose. An example of such a composition comprising a mixture of saponified organic acids, i.e., salts of coconut oil, and pyrethrins was sold commercially under the trademark Red Arrow. However, these mixtures did not solve the expense problem because of their high pyrethrin content, about 40% by weight, and because the coconut oil soaps contributed little to their insecticidal efficacy. In fact, most commercially available fatty acid soap compositions contain an excess of alkali which is thought to promotes hydrolysis and inactivation of pyrethrins. Pyrethrin-based insecticides also degrade rapidly in storage and in use.

More recently, the commercially effective use of pyrethrins was shown when pyrethrins were combined with certain fatty acid salts and a low molecular weight alcohol, such as isopropanol. See for example, U.S. Pat. Nos. 4,904,645, and 4,983,591.

Insect killing soap has also been sold commercially as an insecticide for many years. An example is the Safer® Brand Insect Killing Soap Formulation. This insecticide soap formulation contains about 49.52% potassium salts of fatty acids by weight, and was used to formulate treatments containing about 1.0% to about 2.0% potassium salts of fatty acids by weight. Insecticidal soap has also been shown to have synergistic effects when combined with an insecticide, i.e. pyrethrin, and the soap and compositions of soap and pyrethrins are described in U.S. Pat. Nos. 4,861,762, 4,983,591 and 5,047,424. These three patents, as well as U.S. Pat. Nos. 6,548,085, and 5,998,484 which describe the combination of essential oils and a synergist, are all incorporated by reference herein as if fully set forth in their entireties.

In some embodiments, the present disclose teaches a composition comprising: a minicell and a bioactive agent. The bioactive agent is encapsulated by the minicell. The bioactive agent is a biologically active agent. In some embodiments, the biologically active agent is an essential oil, a botanical ingredient, a saponin, and combinations thereof.

In some embodiments, the insecticidal compounds or the bioactive agent with insecticidal activity of the present disclosure comprise Thyme oil, Thymol, Rosemary oil, Geraniol, Cinnamon oil, Cinnamaldehyde, Methyl Benzoate, Tea Tree oil, Peppermint oil, Clove oil, Orange Oil, Oregano Oil, Neem Oil, Neem, Azadirachtin, Pyrethrum (or Pyrethrin), Citronella oil, Citronellal, Eugenol, Rotenone, Nerolidol, Lemon grass oil, rotenone, sabadilla, cevadine, veratridine, ryania, nicotine, α-terpinene, p-cymene, d-limonene, eucalyptus oil, menthol, pulegone, Anethole, ethyl benzoate, emamectin benzoate, benzyl benzoate, lavender oil, cedar oil, Soaps which care salts produced from the salts of fatty acids (such as potassium oleate), Saponins which comprise hydrophilic sugar moiety linked to a hydrophobic aglycone (different classes of saponins: triterpene, steroidal saponins, steroidal alkaloid)

Essential oils as provided herein also contain essential oils derived from plants (i.e., “natural” essential oils) and additionally or alternatively their synthetic analogues. Some embodiments comprise a combination of essential oils. Other embodiments comprise a combination of natural and synthetic essential oils. In some embodiments, synthetic essential oils can be a synthetic blend, which generally mimics an essential oil assay of a natural essential oil by including at least 5, at least 10, at least 15, or at least 20 of the most critical essential oils within a natural essential oil.

In embodiments, the essential oil itself has insecticidal activity. Exemplary essential oils and extracts, and constituents thereof, useful in the presently disclosed compositions include, but are not limited to: α-pinene, β-pinene, α-campholenic aldehyde, α-citronellol, α-iso-amyl-cinnamic (e.g., amyl cinnamic aldehyde), α-pinene oxide, α-cinnamic terpinene, α-terpineol (e.g., 1-methyl-4-isopropyl-1-cyclohexen-8-ol), λ-terpinene, achillea, aldehyde C16, α-phellandrene, amyl cinnamic aldehyde, allspice oil (pimento berry oil), amyl salicylate, anethole, anise oil, anisic aldehyde, basil oil, bay oil, benzyl acetate, benzyl alcohol, bergamot oil (extracted from plant species, such as, Monardia fistulosa, Monarda didyma, Citrus bergamia, Monarda punctata), bitter orange peel oil, black pepper oil, borneol, calamus oil, camphor oil, cananga oil, cardamom oil, carnation oil (e.g., Dianthus caryophyllus), carvacrol, carveol, cassia oil, castor oil, cedar oil (e.g., hinoki oil), cedar leaf oil, chamomile oil, cineole, cinnamaldehyde, cinnamic alcohol, cinnamon, cis-pinane, citral (e.g., 3,7-dimethyl-2,6-octadienal), citronella oil, citronellal, citronellol dextro (e.g., 3-7-dimethyl-6-octen-1-ol), citronellol, citronellyl acetate, citronellyl nitrile, Citrus unshiu peel extract, clary sage oil, clove and clove bud oil (extracted from plant species, such as, Eugenia caryophyllus and Syzgium aromaticum), coriander oil, corn oil, cotton seed oil, d-dihydrocarvone, decyl aldehyde, diethyl phthalate, dihydroanethole, dihydrocarveol, dihydrolinalool, dihydromyrcene, dihydromyrcenol, dihydromyrcenyl acetate, dihydroterpineol, dimethyl salicylate, dimethyloctanal, dimethyloctanol, dimethyloctanyl acetate, diphenyl oxide, dipropylene glycol, d-limonene, d-pulegone, estragole, ethyl vanillin (e.g., 3-ethoxy-4-hydrobenzaldehyde), eucalyptol (e.g., cineole), eucalyptus oil (such as, Eucalyptus citriodora, Eucalyptus globulus), eugenol (e.g., 2-methoxy-4-allyl phenol), evening primrose oil, fenchol, fennel oil, fish oil, florazon (e.g., 4-ethyl α-α-dimethyl-benzenepropanal), galaxolide, geraniol (e.g., 2-trans-3,7-dimethyl-2,6-octadien-8-ol), geraniol, geranium oil, geranyl acetate, geranyl nitrile, ginger oil, grapefruit oil (derived from the peel pink and white varieties of Citrus paradise) guaiacol, guaiacwood oil, gurjun balsam oil, heliotropin, herbanate (e.g., 3-(1-methyl-ethyl)bicyclo(2,2,1)hept-5-ene-2-carboxylic acid ethyl ester), hiba oil, hydroxycitronellal, 1-carvone, 1-methyl acetate, ionone, isobutyl quinoleine (e.g., 6-secondary butyl quinoline), isobornyl acetate, isobornyl methylether, isoeugenol, isolongifolene, jasmine oil, jojoba oil, juniper berry oil, lavender oil, lavandin oil, lemon grass oil, lemon oil, lime oil, limonene, linallol oxide, linallol, linalool, linalyl acetate, linseed oil, Litsea cubeba oil, 1-methyl acetate, longifolene, mandarin oil, menthol crystals, menthol laevo (e.g., 5-methyl-2-isopropyl cyclohexanol), menthol, menthone laevo (e.g., 4-isopropyl-1-methyl cyclohexan-3-one), methyl anthranilate, methyl cedryl ketone, methyl chavicol, methyl hexyl ether, methyl ionone, mineral oil, mint oil, musk oil (such as, musk ambrette, musk ketone, musk xylol), mustard (also known as allylisothio-cyanate), myrcene, nerol, neryl acetate, nonyl aldehyde, nutmeg oil (extracted from the seed of the tree species Myristica fragrans), orange oil extract (extracted from fruit such as, Citrus aurantium dulcis and Citrus sinensis), orris oil (derived from Iris florentina) para-cymene, para-hydroxy phenyl butanone crystals (e.g., 4-(4-hydroxyphenyl)-2-butanone), palmarosa oil (derived from Cymbopogon martini), patchouli oil (derived from Pogostemon cablin), p-cymene, pennyroyal oil, pepper oil, peppermint oil (derived from Mentha piperita), perillaldehyde, petitgrain oil (extracted from the leaves and green twigs of Citrus aurantium amara), phenyl ethyl alcohol, phenyl ethyl propionate, phenyl ethyl-2-methylbutyrate, pinane hydroperoxide, pinanol, pine ester, pine oil, pinene, piperonal, piperonyl acetate, piperonyl alcohol, plinol, plinyl acetate, pseudo ionone, rhodinol, rhodinyl acetate, rose oil, rosemary oil (derived from Rosmarinus officinalis) sage oil (derived from Salvia officinalis), sandalwood oil (derived from Santalum album), sandenol, sassafras oil, sesame oil, soybean oil, spearmint oil, spice oils (such as, but not limited to, caraway seed oil, celery oil, dill seed oil, marjoram oil), spike lavender oil (derived from Lavandula latifolia), spirantol, starflower oil (also known as, borage oil), tangerine oil (derived from Citrus reticulata), tea seed oil, tea tree oil, terpenoid, terpineol, terpinolene, terpinyl acetate, tert-butylcyclohexyl acetate, tetrahydrolinalool, tetrahydrolinalyl acetate, tetrahydromyrcenol, thulasi oil, thyme oil, thymol, trans-2-hexenol, trans-anethole and metabolites thereof, turmeric oil, turpentine, vanillin (e.g., 4-hydroxy-3-methoxy benzaldehyde), vetiver oil, white cedar oil (derived from Thuja occidentalis), wintergreen oil (methyl salicylate) and the like.

In some embodiments, the composition comprises thyme oil, and the thyme oil comprises a major constituent selected from the group consisting of thymol, camphor, ρ-cymene, γ-terpinene and caravacrol. In some other embodiments, the thyme oil comprises one or more minor constituent selected from the group consisting of myrcene, α-pinene, camphene, borneol, β-caryophyllene, 1,3-octadiene, 1,7-acadiene, 2,4-dymethyl-2,4-heptadiene, sabinene, para-menthene-1, para-menthene-3, α-phellandrene, α-terpinene, limonene, (Z)-b-ocimene, (E)-b-ocimene, α-terpinolene, metha-3,8-diene, p-cimenen, trans-dihydrocarvone, thymol methyl ether, carvacrol acetate, β-caryophyllene, calamenene, gamma-cadinene, β-pinene and linalool.

In still other embodiments of any of the disclosed compositions, the essential oil comprises a constituent selected from α-pinene, β-pinene, pulegone, anisole, eucalyptol, eugenol, geraniol, geranyl acetate, linalyl acetate, methyl anthranilate, myrcene, thymol and cymene.

In certain embodiments, the compositions further comprise additional ingredients selected to increase the insecticidal activity of the compositions. For example, synergists other than the essential oils are included in some embodiments. Accordingly, in some embodiments the compositions comprise a synergist selected from the group consisting of piperonyl butoxide, isopropyl myistate, phenethyl propionate, sodium lauryl sulfate (“SLS”), sodium dodecyl sulfate and lecithin.

In some embodiments, the essential oils can include oils from the classes of terpenes, terpenoids, phenylpropenes and combinations thereof.

### Insect Pests

The present disclosure relates to the control of one or more insect pests with a composition or formulation comprising a minicell and one or more bioactive agents with insecticidal activity.

In one embodiment, the insect pest is a plant pest and the method comprises applying the composition or formulation of the present disclosure to the plant or its surroundings.

Embodiments of the disclosure can be used to treat crops in order to limit or prevent insect infestation. The present disclosure is especially suitable for agronomically important plants, which refers to a plant that is harvested or cultivated on a commercial scale.

Examples of such agronomic plants (or crops) are cereals, such as wheat, barley, rye, oats, rice, maize or sorghum; beet, such as sugar or fodder beet; fruit, for example pome fruit, stone fruit and soft fruit, such as apples, pears, plums, prunes, peaches, almonds, cherries or berries, for example strawberries, raspberries or blackberries; legumes, such as beans, lentils, peas or soya beans; oil crops such as oil seed rape, mustard, poppies, olives, sunflowers, coconuts, castor, cacao or peanuts; the marrow family, such as pumpkins, cucumbers or melons; fibre plants such as cotton, flax, hemp or jute; citrus fruits such as oranges, lemons, grapefruits or tangerines; vegetables such as spinach, lettuce, asparagus, cabbage species, carrots, onions, chillies, tomatoes, potatoes, or capsicums; the laurel family such as avocado, Cinnamonium or camphor; and tobacco, nuts (such as walnut), coffee, egg plants, sugar cane, tea, pepper, grapevines, hops, the banana family, latex plants and ornamentals. Also important are forage crops such as grasses and legumes.

In an embodiment plants include fibre plants, grain crops, legume crops, pulse crops, vegetables and fruit, more particularly, cotton, maize, sorghum, sunflower, lucerne, various legumes especially soybean, pigeon pea, mung bean and chickpea, tomatoes, okra and like plants.

In an embodiment plants include ornamental plants. By way of example these ornamental plants may be orchids, roses, tulips, trees, shrubs, herbs, lawns and grasses, bulbs, vines, perennials, succulents, house plants.

In an embodiment, the insect pest is a pest of an animal and the method comprises applying the composition or formulation of the present disclosure to the animal. In an embodiment the animal may be dogs, cats, cattle, sheep, horses, goats, pigs, chicken, guinea pig, donkey, duck, bird, water buffalo, camel, reindeer, goose, llama, alpaca, elephant, deer, rabbit, mink, chinchilla, hamster, fox, emu, ostrich.

The term “locus” as used herein refers to a place to which a composition according to the disclosure is applied. It includes application to an individual plant, a group of plants such as a plant and/or its surrounds, an animal or a human individually or in a group and the region in which plants may be planted or in which animals may congregate, as well application directly to an insect or insects and/or the vicinity in which they are located.

For purposes of simplicity, the term “insect” or its equivalents or derivatives such as “insecticidal” shall be used in this application; however, it should be understood that the term “insect” refers, not only to insects but to their immature forms and larvae.

Those skilled in the art will recognize that not all compounds are equally effective against all insects. In embodiments the compositions display activity against insect pests, which may include economically important agronomic, forest, greenhouse, nursery, ornamentals, food and fiber, public and animal health, domestic and commercial structure, household, and stored product pests.

In an embodiment the insects are selected from cotton bollworm, native budworm, green mirids, aphids, green vegetable bugs, apple dimpling bugs, thrips (plaque thrips, tobacco thrips, onion thrips, western flower thrips), white flies and two spotted mites.

In an embodiment the insect pests of animals include fleas, lice, mosquitoes, flies, tsetse flies, ants, ticks, mites, silverfish and chiggers.

In embodiments, the insect pests of the present disclosure is Velvetbean Caterpillar (VBC) or Diamondback Moth (DBM).

The compositions are effective to knockdown and/or kill a wide range of target pests. One of ordinary skill in the art can select the correct combination of solid insecticide and essential oil components based on the desired target pest.

The compositions and methods of the present disclosure are effective in the control of different species of invertebrate pests. It will be understood that the pests exemplified and evaluated in the examples herein is representative of such a wider variety. By way of illustration, but not limitation, the insecticidal compositions of the present disclosure are also useful for control of pests such as fleas (Siphonaptera), mosquitos (Diptera: Culicidae), yellow jackets and wasps (Hymenoptera: Vespidae), bees, (Hymenoptera: Apoidea), ants (Hymenoptera: Formicidae), cockroaches (Blattodea: Blaberoidea), termites (Blattodea: Isoptera), insect agricultural/plant pests such as leafhoppers (Heteroptera: Cicadellidae), stink bugs (Heteroptera: Pentatomidae), beetles (Coleoptera), moths (Lepidoptera), lygus bugs (Heteroptera: Miridae: Lygus), leaf miner flies (Diptera: Agromyzidae), whiteflies (Homoptera: Aleyrodidae), thrips (Thysanoptera), and aphids (Homoptera: Aphididae), in addition to arachnids, such as spiders (Araneae), ticks and mites (Acari), slugs and snails (Molluska: Gastropoda), nematodes, water-molds (Heterokontophyta: Oomycota, e.g. species in the Phytophthora and Pythium genera), bacteria (e.g. Erwinia genus), as well as fungi, in the Ascomycota, Chytridiomycota, and Zygomycota phyla (e.g. Clavicipitaceae, Davidiellaceae, Diatrypaceae, Mycosphaerellaceae, Mucoraceae, and Sclerotiniaceae Families), but not excluding other phyla, classes, orders, or families, such as true smut fungi (Ustilaginomycetes), pathogenic fungi (Pucciniales), molds (Dermatophytes), and the Ceratobasidiaceae family in the Basidiomycota phylum.

Further targeted pests controlled by the compositions and methods of the present disclosure are, for example, members of Diplopoda (millipedes), e.g. the spotted snake millipede (Blaniulus guttulatus); Chilopoda (centipedes), e.g. soil centipedes (Geophilomorpha: Geophilidae), house centipedes (Scutigeromorpha), and tropical centipedes (Scolopendromorpha); Symphyla (symphylans/pseudocentipedes), e.g. the garden centipede (Scutigerella immaculate); Collembola (springtails and allies); and Isopoda (isopods), e.g. woodlice (Oniscidea), and pillbugs (Oniscidea: Armadillidiidae). Within the Class Insecta, examples of target pests include those in the Orders, Zygentoma (silverfish), e.g. Oriental silverfish (Ctenolepisma villosa), firebrat (Thermobia domestica), and common silverfish (Lepisma saccharina); Microcoryphia (bristletails); Dermaptera (earwigs), e.g. shore earwig (Labidura riparia) and European earwig (Forficula auricularia); Orthoptera (grasshoppers, crickets, katydids), e.g. house cricket (Acheta domesticus), camel cricket (Rhaphidophoridae), Oriental migratory locust (Locusta migratoria), and mole cricket (Gryllotalpidae); Blattodea (cockroaches and termites), e.g. American cockroach (Periplaneta americana), German cockroach (Blattella germanica), Oriental cockroach (Blatta orientalis), rottenwood termites (Archotermopsidae), drywood termites (Kalotermitidae), harvester termites (Hodotermitidae), subterranean termites (Rhinotermitidae), and higher termites (Termitidae); Thysanoptera (thrips), e.g. western flower thrip (Frankliniella occidentalis), onion thrip (Thrips tabaci), and melon thrip (Thrips palmi); Psocodea (barklice, booklice, and parasitic lice), e.g. larger pale booklouse (Trogium pulsatorium), chewing lice (Mallophaga), and sucking lice (Anoplura) such as the crab louse (Phthiris pubis), human louse (Pediculus humanus) and pale lice (Linognathidae). Also included are members of Hemiptera, e.g. stink bugs (Pentatomidae), rice bug (Cletus punctiger), common bed bug (Cimex lectuarius), tropical bed bug (Cimex hemipterus), cotton stainer (Dysdercus intermedius), kissing bugs (Triatominae), whiteflies (Aleyrodidae) such as the silverleaf whitefly (Bemisia tabaci), aphids (Aphididae) such as black bean aphid (Aphis fabae), cabbage aphid (Brevicoryne brassicae) and green peach aphid (Myzus persicae), leafhoppers (Cicadellidae) such as the potato leafhopper (Empoasca fabae), grape leafhopper (Erythroneura comes) and brown rice planthopper (Nilaparvata lugens), soft scale insects (Coccidae) such as the brown scale (Lecanium corni) and black scale (Saissetia oleae), armored scale insects (Diaspididae) such as the California red scale (Aonidiella aurantii), and mealybugs (Pseudococcidae); Coleoptera (beetles), including but not limited to scarab beetles (Scarabaeidae), metallic wood-boring beetles (Buprestidae), click beetles (Elateridae), carpet beetles (Dermestidae), horned powder-post beetles (Bostrichidae), death-watch beetles (Ptinidae), sap-feeding beetles (Nitidulidae), darkling beetles (Tenebrionidae), long-horned beetles (Cerambycidae), leaf beetles (Chrysomelidae) such as the bean weevil (Acanthoscelides obtectus) and Colorado potato beetle (Leptinotarsa decemlineata), and snout and bark beetles (Curculionidae) such as the black vine weevil (Otiorhynchus sulcatus) and Alfalfa weevil (Hypera postica); Hymenoptera (ants, bees, and wasps), e.g. conifer sawflies (Diprionidae), common sawflies (Tenthredinidae), paper wasps (Vespidae: Polistinae), and ants (Formicidae) such as odorous ants (Dolichoderinae), fire ants (Solenopsis), the pharaoh ant (Monomorium pharaonis), Argentine ant (Linepithema humile) and carpenter ants (Camponotus); Lepidoptera (butterflies and moths), e.g. tussock moths (Lymantriidae) such as the gypsy moth (Lymantria dispar), torticid moths (Torticidae) such as the oak leafroller moth (Tortrix viridana), crambid snout moths (Crambidae) such as the Mediterranean flour moth (Ephestia kuehniella), leaf blotch miner moths (Gracillariidae) such as the citrus leafminer (Phyllocnistis citrella), owlet moths (Noctuidae) such as the cabbage armyworm (Mamestra brassicae), clothes moths (Tineidae), and tent caterpillars and lappet moths (Lasiocampidae); and Diptera (flies), e.g. mosquitoes (Culicidae), black flies (Simuliidae), biting midges (Ceratopogonidae), vinegar flies (Drosophilidae), house flies (Muscidae), root-maggot flies (Anthomyiidae) such as the beet leafminer (Pegomya hyoscyami), bee lice (Braulidae), louse flies (Hippoboscidae), tsetse flies (Glossinidae), blow flies (Calliphoridae) such as cluster flies (Pollenia) and hairy maggot blow flies (Chrysomya), bot flies (Oestridae), fruit flies (Tephritidae) such as the Mediterranean fruit fly (Ceratitis capitata), large crane flies (Tipulidae) such as the European crane fly (Tipula paludosa), horse flies (Tabanidea), and sand flies (Psychodidea).

Other exemplary target pests include, but are not limited to, cockroaches (Blattodea: Blaberoidea), American cockroach (Periplaneta americana), German cockroach (Blattella germanica), Oriental cockroach (Blatta orientalis)), flies (Diptera) (e.g., housefly (Musca domestica), blow flies (Calliphoridae spp.), flesh flies (Sarcophagidae spp.), stable fly (Stomoxys calcitrans), fruit flies (Drosophila spp.) humpback flies (Phoridae spp.), drain flies (Psychodidae spp.), fungus gnats (Sciaridae spp. and Fungivoridae spp.), cluster fly (Pollenia rudis), black flies (Silmulium spp.), biting midges (Ceratopogonidae), deer flies (Chrysops spp. and Silvius spp.), snipe flies (Symphoromyia spp.), ants (Hymenoptera: Formicidae) (e.g., odorous house ant (Tapinoma sessile) carpenter ant (Camponotus spp.)), silverfish (Zygentoma), camel crickets (Rhaphidophoridae), spiders (Araneae), ticks and mites (Acari), bed bugs (Cimex lectuarius and Cimex hemipterus), fleas (Siphonaptera), earwigs (Dermaptera), termites (Blattodea: Isoptera), lice (Phthiraptera), spiders (Arachidae), mites and ticks (Acari) wasps and bees (Hymenoptera: Vespidae and Apoidea). In some embodiments, the target pest is selected from the group consisting of bed bugs (Cimex spp), fleas (Siphonoptera), lice (Phthiraptera), silverfish (Zygentoma), crickets (Orthoptera), cockroaches (Blattodea: Blaberoidea), ants, wasps, and bees (Hymenoptera: Fomiciadae, Vespidae, and Apoidea), and flies (Diptera).

In some embodiments, the bioactive agent in the presence of the minicell has at least 1%, at least 2%, at least 3%, at least 4%, at least 5%, at least 6%, at least 7%, at least 8%, at least 9%, at least 10%, at least 15%, at least 20%, at least 30%, at least 40%, at least 50%, at least 60%, at least 70%, at least 80%, at least 90% higher insecticidal activity than the bioactive agent alone at day 1 after treatment of said composition.

In some embodiments, the insecticidal effect is an effect wherein treatment with a composition causes at least about 1%, at least about 2%, at least about 3%, at least about 4%, at least about 5%, at least about 6%, at least about 7%, at least about 8%, at least about 9%, at least about 10%, at least about 15%, at least about 20% of the exposed insects to die. In some embodiments, the insecticidal effect is an effect wherein treatment with a composition causes at least about 25% of the insects to die. In some embodiments the insecticidal effect is an effect wherein treatment with a composition causes at least about 50% of the exposed insects to die. In some embodiments the insecticidal effect is an effect wherein treatment with a composition causes at least about 75% of the exposed insects to die. In some embodiments the insecticidal effect is an effect wherein treatment with a composition causes at least about 90% of the exposed insects to die.

### Pesticidal Compositions

The present disclosure teaches a composition or formulation comprising a minicell and at least one insecticidal ingredient (i.e. a bioactive agent with insecticidal activity or a component of the bioactive agent). In some embodiments, the insecticidal ingredients can be applied in the form of compositions and can be applied to the crop area or plant to be treated, simultaneously or in succession, with other compounds. These compounds can be fertilizers, weed killers, Cryoprotectants, surfactants, detergents, pesticidal soaps, dormant oils, polymers, and/or time-release or biodegradable carrier formulations that permit long-term dosing of a target area following a single application of the formulation. They can also be selective insecticidal soaps, chemical insecticides, herbicides, virucides, microbicides, amoebicides, pesticides, fungicides, bacteriocides, nematocides, molluscicides or mixtures of several of these preparations, if desired, together with further agriculturally acceptable carriers, surfactants or application-promoting adjuvants customarily employed in the art of formulation. Suitable carriers and adjuvants can be solid or liquid and correspond to the substances ordinarily employed in formulation technology, e.g. natural or regenerated mineral substances, solvents, dispersants, wetting agents, tackifiers, binders or fertilizers. Likewise the formulations may be prepared into edible “baits” or fashioned into pest “traps” to permit feeding or ingestion by a target pest of the pesticidal formulation.

The present disclosure teaches that the composition or formulation of the present disclosure is combined with insecticidal soap, which can improve insecticidal efficacy. The combination may have a synergistic effect in that the soap solubilizes the waxy outer layer of the insect and weakens the cell membranes, thereby allowing the composition taught herein to penetrate the exoskeleton and reach the insect's nervous system more quickly.

In some embodiments, an insecticidal composition comprising a minicell and one or more insecticidal ingredients can be combined with insecticidal soap. In some embodiments, the insecticidal soap has about 0.1% to about 20%, about 0.2% to about 15%, about 0.3% to about 10% about 0.4% to about 5%, or about 0.5% to about 3% by weight of potassium salts of fatty acids, such as oleic acid, which enhances the effectiveness of the composition sufficiently to render the otherwise relatively ineffective individual components functionally enhanced and quicker-acting, thereby improving both the mortality and the kill time.

The compositions of the present disclosure can be formulated or mixed with, if desired, conventional inert insecticide diluents or extenders of the type usable in conventional pest control agents, e.g., conventional dispersible carrier vehicles in the form of solutions, emulsions, suspensions, emulsifiable concentrates, spray powders, pastes, soluble powders, dusting agents, granules or foams.

As used herein, the term “emulsion” refers to a fine dispersion of droplets of one liquid in which the liquid is not substantially soluble or miscible. An essential oil may be emulsified or substantially emulsified within an aqueous carrier.

As used herein, the term “emulsifier” refers to a substance that stabilizes an emulsion. The emulsifier can utilize physical properties, chemical properties, or utilize both physical and chemical properties to interact with one or more substances of an emulsion.

Typical emulsifiers that may be suitable for use in the compositions of the disclosure, include, but are not limited to, light molecular weight oils without insecticidal activity (e.g., canola, cottonseed, groundnut, corn, germ, olive, castor and sesame oils), and non-ionic, anionic and cationic surfactants. Blends of any of the above emulsifiers may also be used in the compositions of the present disclosure.

Typical non-ionic surfactants include ethoxylated alkanols, in particular ethoxylated fatty alcohols and ethoxylated oxoalcohols, such as ethoxylated lauryl alcohol, ethoxylated isotridecanol, ethoxylated cetyl alcohol, ethoxylated stearyl alcohol, and esters thereof, such as acetates; ethoxylated alkylphenols, such as ethoxylated nonylphenyl, ethoxylated dodecylphenyl, ethoxylated isotridecylphenol and the esters thereof, e.g. the acetates alkylglucosides and alkyl polyglucosides, ethoxylated alkylglucosides; ethoxylated fatty amines, ethoxylated fatty acids, partial esters, such as mono-, di- and triesters of fatty acids with glycerine or sorbitan, such as glycerine monostearate, glycerine monooleate, sorbitanmonolaurate, sorbitanmonopalmitate, sorbitanmonostearate, sorbitan monooleate, sorbitantristearate, sorbitan trioleate; ethoxylated esters of fatty acids with glycerine or sorbitan, such as polyoxyethylene glycerine monostearate, polyoxyethylene sorbitanmonolaurate, sorbitanmonopalmitate, polyoxyethylene sorbitanmonostearate, polyoxyethylene sorbitan monooleate, polyoxyethylene sorbitantristearate, polyoxyethylene sorbitan trioleate; ethoxylates of vegetable oils or animal fats, such as corn oil ethoxylate, castor oil ethoxylate, tallow oil ethoxylate; ethoxylates of fatty amines, fatty amides or of fatty acid diethanolamides.

Typical anionic surfactants include salts, in particular, sodium, potassium calcium or ammonium salts of alkylsulfonates, such as lauryl sulfonate, isotridecylsulfonate, alkylsulfates, in particular fatty alcohol sulfates, such as lauryl sulfate, isotridecylsulfate, cetylsulfate, stearylsulfate-aryl- and alkylarylsulfonates, such as napthylsulfonate, dibutylnaphtylsulfonate, alkyldiphenylether sulfonates such as dodecyldiphenylether sulfonate, alkylbenzene sulfonates such as cumylsulfonate, nonylbenzenesulfonate and dodecylbenzene sulfonate; sulfonates of fatty acids and fatty acid esters; sulfates of fatty acids and fatty acid esters; sulfates of ethoxylated alkanols, such as sulfates of ethoxylated lauryl alcohol; sulfates of alkoxylated alkylphenols; alkylphosphates and dialkylphosphates; dialkylesters of sulfosuccinic acid, such as dioctylsulfosuccinate, acylsarcosinates, fatty acids, such as stearates, acylglutamates, ligninsulfonates, low molecular weight condensates of naphthalinesulfonic acid or phenolsulfonic acid with formaldehyde and optionally urea.

Typical cationic surfactants include quaternary ammonium compounds, in particular alkyltrimethylammonium salts and dialkyldimethylammonium salts, e.g. the halides, sulfates and alkylsulfates.

In some embodiments, the insect control compositions can be combined with one or more synthetic insecticides or pesticides. In one embodiment, the insecticide or pesticide is selected from one or more of endosulfan, dicofol, chlorpyrifos, dimethoate, disulfoton, omethoate, parathion, phorate, profenofos, sulprofos, thiometon, aldicarb, carbaryl, beta-cyfluthrin, deltamethrin, esfenvalerate, fenvalerate, fluvalinate, lamda-cyhalothrin, chlorfluazuron, piperonyl butoxide, and petroleum spray oils. In another embodiment, the pesticide is a biological pesticide selected from a nuclear polyhedrosis virus and/or a plant extract known to be anti-feedant of pests. In yet another embodiment, the insecticide or pesticide is used at a reduced label rate. For example, the insecticide or pesticide may be used at half or one-third of the label rate.

The compositions of the present disclosure can be used to control insects by either treating a host directly, or treating an area in which the host will be located. For example, the host can be treated directly by using a spray formulation, which can be applied to a plant individually or when grouped, such as an agricultural crop.

The formulation of the present disclosure may further comprise other formulation auxiliaries known in the art of agrochemical formulations in customary amounts. Such auxiliaries include, but are not limited to, antifreeze agents (such as but not limited to glycerine, ethylene glycol, propylene glycol, monopropylene glycol, hexylene glycol, 1-methoxy-2-propanol, cyclohexanol), buffering agents (such as but not limited to sodium hydroxide, phosphoric acid), preserving agents (such as but not limited to derivatives of 1,2-benzisothiazolin-3-one, benzoic acid, sorbic acid, formaldehyde, a combination of methyl parahydroxybenzoate and propyl parahydroxybenzoate), stabilizing agents (such as but not limited to acids, preferably organic acids, such as dodecylbenzene sulfonic acid, acetic acid, propionic acid or butyl hydroxyl toluene, butyl hydroxyl anisole), thickening agents (such as but not limited to heteropolysaccharide and starches), and antifoaming agents (such as but not limited to those based on silicone, particularly polydimethylsiloxane). Such auxiliaries are commercially available and known in the art.

### Use of AgriCell Platform for Controlling Insects

As used herein, the term “AgriCell” refers to a “minicell” taught herein, both of which are interchangeably used.

Once the AgriCell is loaded with active ingredients, it serves as a carrier that protects them from environmental stresses until it delivers its high-payload capacity slowly to the plant microenvironment through the natural breakdown of its biodegradable membrane. This bio-encapsulation technology overcomes many of the problems of agrochemical delivery and can serve as the much-needed replacement to traditional techniques using plastic microcapsules. The AgriCell technology can also be engineered in various ways to improve its stability and provide tailored controlled release profiles. The major benefit of this platform is the enhanced efficacy/potency of the active in the field setting.

The present disclosure teaches that the AgriCell platform can be used to effectively deliver one or more insecticidal ingredients (i.e. one or more bioactive agents with insecticidal activity) for controlling insects. Insecticidal ingredients that cannot be expressed in the host bacterial system can be loaded into “empty” minicells. Once the ingredients or bioactive agents are encapsulated by the minicell, the minicell can be processed to improve the strength of its membrane for enhanced delivery and uptake. Encapsulated bioinsecticides can be used to show enhanced insecticidal activity, prolonged/extended insecticidal activity, controlled release of bioinsecticides, efficient killing of undesirable insects, less or non-toxicity to a plant, an animal, a human, and environments around the plant, the animal, and the human being.

The present disclosure provides that AgriCell platform can protect botanical ingredients, essential oils, and saponin, and ensure their delivery to a locus for environment-friendly, sustainable, controllable and scalable control of insects. Without proper protection, unencapsulated insecticidal ingredients of the present disclosure may act quickly, degrade rapidly. Consequently, the use of AgriCell platform provides improved performance of the insecticidal ingredients in terms of stability, storage, and bioavailability through an encapsulation and controlled release mechanism.

The present disclosure teaches that the AgriCell platform can be applied to encapsulation of insecticidal ingredients of interest for insect control. The AgriCell platform, showing improved stability and bioavailability, long lasting shelf-life and controlled release properties, can be used for better insect control than conventional ways of insect control using insecticides not protected or encapsulated by the AgriCell platform.

Encapsulation

The present disclosure teaches a composition comprising: a minicell and a bioactive agent with insecticidal activity. In some embodiments, the bioactive agent is encapsulated by the minicell.

In some embodiments, the minicell and the bioactive agent are present in a weight-to-weight ratio of about 5:1 to about 1:5 in the composition. In some embodiments, the minicell and the bioactive agent are present in a weight-to-weight ratio of about 4:1 to about 1:4 in the composition. In some embodiments, the minicell and the bioactive agent are present in a weight-to-weight ratio of about 3:1 to about 1:3 in the composition. In some embodiments, the minicell and the bioactive agent are present in a weight-to-weight ratio of about 2:1 to about 1:2 in the composition. In some embodiments, the minicell and the bioactive agent are present in a weight-to-weight ratio of about 1:1 in the composition.

In some embodiments, at least about 1%, at least about 2%, at least about 3%, at least about 4%, at least about 5%, at least about 6%, at least about 7%, at least about 8%, at least about 9%, at least about 10%, at least about 20%, at least about 30%, at least about 40%, at least about 50%, at least about 60%, at least about 70%, at least about 80%, at least about 90%, of the bioactive agent is encapsulated by the minicell.

In some embodiments, at least about 10% of the bioactive agent is encapsulated by the minicell.

In some embodiments, the minicell stabilizes the bioactive agent in an acidic condition. The acidic condition is less than pH 7, pH 6, pH 5, pH 4, pH 3, or pH 2. In some embodiments, the minicell encapsulating the bioactive agent is preserved from depletion flocculation when a pH is adjusted to an extremely acidic condition. In some embodiments, the acidic condition is as low as pH 1, pH 2, pH 3, pH 4, pH 5, or pH 6. The extremely acidic condition is as low as pH 1.

In other embodiments, the minicell stabilizes the bioactive agent at least 1 day, at least 2 days, at least 3 days, at least 4 days, at least 5 days, at least 6 days, at least 7 days, at least 8 days, at least 9 days, at least 10 days, at least 11 days, at least 12 days, at least 13 days, at least 14 days, at least 15 days, at least 16 days, at least 17 days, at least 18 days, at least 19 days, at least 20, at least 21 days, at least 22 days, at least 23 days, at least 24 days, at least 25 days, at least 26 days, at least 27 days, at least 28 days, at least 29 days, at least 30 days, at least 31 days, at least 32 days, at least 33 days, at least 34 days, at least 35 days, at least 36 days, at least 37 days, at least 38 days, at least 39 days, at least 40 days, at least 45 days, at least 50 days, at least 55 days, or at least 60 days, at room temperature in a neutral pH condition. In other embodiments, the minicell stabilizes the bioactive agent at least 30 days, at room temperature in a neutral pH condition.

In some embodiments, the minicell stabilizes the bioactive agent in a thermal variation. In some embodiments, the bioactive agent encapsulated by the minicell is at least 1.1 fold, at least 1.2 fold, at least 1.3 fold, at least 1.4 fold, at least 1.5 fold, at least 1.6 fold, at least 1.7 fold, at least 1.8 fold, at least 1.9 fold, at least 2 fold, at least 3 fold, at least 4 fold, at least 5 fold more resistant to thermal degradation than a free bioactive agent not encapsulated by the minicell after a heat treatment. In other embodiments, the heat treatment is above room temperature, which is at 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., or higher.

In other embodiments, the bioactive agent encapsulated by the minicell is at least 1.1 fold more resistant to thermal degradation than a free bioactive agent not encapsulated by the minicell after a heat treatment. In further embodiments, the bioactive agent encapsulated by the minicell is at least 1.1 fold more resistant to thermal degradation than a free bioactive agent not encapsulated by the minicell after a heat treatment on day 7 after a heat treatment at 40° C.

In some embodiments, the bioactive agent encapsulated by the minicell has less than about 90%, less than about 85%, less than about 80%, less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%, or less than about 10% thermal degradation after a heat treatment.

In some embodiments, the bioactive agent encapsulated by the minicell has less than about 60% thermal degradation after a heat treatment. In some embodiments, the bioactive agent encapsulated by the minicell has less than about 60% thermal degradation on day 7 after a heat treatment at 40° C.

In some embodiments, the minicell protects the bioactive agent from oxidative degradation by ultraviolet (UV) or visible light. In some embodiments, the bioactive agent encapsulated by the minicell is at least 1.1 fold, at least 1.2 fold, at least 1.3 fold, at least 1.4 fold, at least 1.5 fold, at least 1.6 fold, at least 1.7 fold, at least 1.8 fold, at least 1.9 fold, at least 2 fold, at least 3 fold, at least 4 fold, at least 5 fold more resistant to oxidative degradation than a free bioactive agent not encapsulated by the minicell under UV or visible light exposure.

In other embodiments, the bioactive agent encapsulated by the minicell is at least 1.1 fold more resistant to oxidative degradation than a free bioactive agent not encapsulated by the minicell under UV or visible light exposure. In further embodiments, the bioactive agent encapsulated by the minicell is at least 1.1 fold more resistant to oxidative degradation than a free bioactive agent not encapsulated by the minicell on day 7 under UV or visible light exposure.

In some embodiments, the bioactive bioagent encapsulated by the minicell has less than about 90%, less than about 85%, less than about 80%, less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%, or less than about 10% oxidative degradation under UV or visible light exposure.

In other embodiments, the bioactive agent encapsulated by the minicell has less than about 35% oxidative degradation under UV or visible light exposure. In further embodiments, the bioactive agent encapsulated by the minicell has less than about 35% oxidative degradation on day 7 under UV or visible light exposure.

The present disclosure teaches that the minicell confers to the bioactive agent an improved stability, an enhanced bioavailability and an extended shelf life. The present disclosure teaches a composition comprising the minicell encapsulates the bioactive agent, thereby conferring to an improved stability, an enhanced bioavailability and an extended shelf life.

Release of Bioactive Agents Encapsulated into AgriCell Platform

The present disclosure teaches a composition comprising: a minicell and a bioactive agent. In some embodiments, the bioactive agent is encapsulated by the minicell.

In some embodiments, a release of the bioactive agent encapsulated by the minicell is delayed when compared to a free bioactive agent not encapsulated by the minicell.

In some embodiments, a release percentage (%) of the encapsulated bioactive agent is less than about 90%, less than about 85%, less than about 80%, less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%, or less than about 10% after a release.

In some embodiments, a release percentage (%) of the encapsulated bioactive agent is less than about 50% in a first hour.

In some embodiments, a release percentage (%) of the encapsulated bioactive agent is at least about 45% at 8 hours after the release.

In some embodiments, the encapsulated bioactive agent has an extended release with less than about 90%, less than about 85%, less than about 80%, less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%, or less than about 10% of the bioactive agent retained, when compared to the non-encapsulated free bioactive agent that are fully released, at 8 hours after the release.

In some embodiments, the encapsulated bioactive agent has an extended release with less than about 50% of the bioactive agent retained, when compared to the non-encapsulated free bioactive agent that are fully released, at 8 hours after the release.

The present disclosure teaches that the AgriCell platform can be coated by biopolymer. The biopolymer is a chitosan. In some embodiments, the minicell is coated by biopolymer. In some embodiments, the biopolymer is a chitosan.

In some embodiments, a release of the bioactive agent encapsulated by the biopolymer-coated minicell is further delayed when compared to the encapsulated bioactive agent without the biopolymer coated.

In some embodiments, the bioactive agent encapsulated by the biopolymer-coated minicell has a further extended release with at least about 1%, at least about 5%, at least about 10%, at least about 20%, at least about 30%, at least about 40%, at least about 50%, at least about 60%, at least about 70%, at least about 80%, at least about 90% of the bioactive agent retained, when compared to the encapsulated bioactive agent without the biopolymer coated, after a release.

In some embodiments, the bioactive agent encapsulated by the biopolymer-coated minicell has a further extended release with at least about 10% of the bioactive agent retained, when compared to the encapsulated bioactive agent without the biopolymer coated, at 8 hours after the release.

In some embodiments, the bioactive agent encapsulated by the minicell is capable of being delivered to a target in a controlled release manner.

Amounts of Bioactive Agents Delivered by AgriCell Platform

In some embodiments, bioactive agents are encapsulated within the minicells described herein and delivered to a desired subject. Amounts of bioactive agents of interest are provided herein with percent weight proportions of the various components used in the preparation of the minicell for the encapsulation and deliver of bioactive agents.

The percent weight proportions of the various components used in the preparation of the minicell for the encapsulation and deliver of bioactive agents can be varied as required to achieve optimal results. In some embodiments, the bioactive agents including, but are not limited to a nucleic acid, a polypeptide, a protein, an enzyme, an organic acid, an inorganic acid, a metabolite, an essential oil, a nutrient, and a semiochemical, are present in an amount of about 0.1 to about 99.9% by weight, about 1 to about 99% by weight, about 10 to about 90% by weight, about 20 to about 80% by weight, about 30 to about 70% by weight, about 40 to about 60% by weight, based on the total weight of the minicells within which a bioactive compound of interest is encapsulated. Alternate percent weight proportions are also envisioned.

Among the various aspects of the present disclosure is an minicell in the form of encapsulation of a bioactive agent of interest at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95%, by weight of the bioactive agent within the minicell.

In other embodiments, the bioactive agent within the minicell is present in an amount of at least about 0.01 g/L, at least about 0.02 g/L, at least about 0.03 g/L, at least about 0.04 g/L, at least about 0.05 g/L, at least about 0.06 g/L, at least about 0.07 g/L, at least about 0.08 g/L, at least about 0.09 g/L, at least about 0.1 g/L, at least about 0.2 g/L, at least about 0.3 g/L, at least about 0.4 g/L, at least about 0.5 g/L, at least about 0.6 g/L, at least about 0.7 g/L, at least about 0.8 g/L, at least about 0.9 g/L, at least about 1 g/L, about 2 g/L, at least about 3 g/L, at least about 4 g/L, at least about 5 g/L, at least about 6 g/L, at least about 7 g/L, at least about 8 g/L, at least about 9 g/L, at least about 10 g/L, at least about 11 g/L, at least about 12 g/L, at least about 13 g/L, at least about 14 g/L, at least about 15 g/L, at least about 16 g/L, at least about 17 g/L, at least about 18 g/L, at least about 19 g/L, at least about 20 g/L, at least about 30 g/L, at least about 40 g/L, at least about 50 g/L, at least about 60 g/L, at least about 70 g/L, at least about 80 g/L, at least about 90 g/L, at least about 100 g/L, at least about 110 g/L, at least about 120 g/L, at least about 130 g/L, at least about 140 g/L, at least about 150 g/L, at least about 160 g/L, at least about 170 g/L, at least about 180 g/L, at least about 190 g/L, at least about 200 g/L, at least about 300 g/L, at least about 400 g/L, at least about 500 g/L, at least about 600 g/L, at least about 700 g/L, at least about 800 g/L, at least about 900 g/L, or at least about 1000 g/L.

In another embodiment, the bioactive agent of interest and the minicell are present in compositions of the disclosure in a weight ratio of about 1:200, about 1:195, about 1:190, about 1:185, about 1:180, about 1:175, about 1:170, about 1:165, about 1:160, about 1:155, about 1:150, about 1:145, about 1:140, about 1:135, about 1:130, about 1:125, about 1:120, about 1:115, about 1:110, about 1:105, about 1:100, about 1:95, about 1:90, about 1:85, about 1:80, about 1:75, about 1:70, about 1:65, about 1:60, about 1:55, about 1:50, about 1:45, about 1:40, about 1:35, about 1:30, about 1:25, about 1:20, about 1:15, about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 35:1, about 40:1, about 45:1, about 50:1, about 55:1, about 60:1, about 65:1, about 70:1, about 75:1, about 80:1, about 85:1, about 90:1, about 95:1, about 100:1, about 110:1, about 115:1, about 120:1, about 125:1, about 130:1, about 135:1, about 140:1, about 145:1, about 150:1, about 155:1, about 160:1, about 165:1, about 170:1, about 175:1, about 180:1, about 185:1, about 190:1, about 195:1, or about 200:1. In another embodiment, the bioactive agent of interest and the minicell are present in a weight ratio of from about 1:50 to about 50:1, from about 1:40 to about 40:1, from about 1:30 to about 30:1, from about 1:20 to about 20:1, from about 1:10 to about 10:1, from about 1:5 to about 5:1, from about 1:4 to about 4:1, from about 1:3 to about 3:1, from about 1:2 to about 2:1 or from about 1 to about 1.

In some embodiments, a bioactive agent of interest, for example, is present in at least about 1%, at least about 5% at least about 10%, at least about 20%, at least about 30%, at least about 40%, at least about 50%, at least about 60%, at least about 70%, at least about 80%, at least about 90%, or at least about 95% of total mass of a formulated product. In further embodiments, about 10 to 90% of the total mass of the formulated product is provided for the bioactive agent disclosed herein and the remaining about 10 to 90% of the mass is from the minicell.

In some embodiments, more than one non-expressed bioactive agents can be encapsulated within the minicell. In another embodiment, the formulated product comprises two bioactive agents that are present in compositions of the disclosure in a weight ratio of about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, or about 10:1.

Methods of Producing and Delivering Bioactive Agents to a Subject Using AgriCell Platform

The present disclosure provides a method of preparing an minicell encapsulating a bioactive agent with insecticidal activity, said method comprising the steps of: a) producing and purifying minicells; b) providing a bioactive agent with insecticidal activity; c) loading the minicells with the bioactive agent for encapsulation; and d) recovering the minicells encapsulating the bioactive agent.

In some embodiments, in step a) the minicells are produced from a bacterial cell. In some embodiments, in step a) the purified minicells are provided as a suspension in water or other suitable liquid, or a concentrated paste. In some embodiments, the suspension comprises about 0.01 to 5,000 mg minicells per ml, about 0.1 to 3,000 mg minicells per ml, about 1 to 1,000 mg minicells per ml, or about 1 to 500 mg minicells per ml. In some embodiments, in step a) the purified minicells are provided as a dry powder.

In some embodiments, in step b) the bioactive agent provided as a suspension in an aqueous solvent.

In some embodiments, in step c) the loaded minicells are suspended in a suspension of the bioactive agent. In some embodiments, in step c) the reaction is carried out at atmospheric pressure at a temperature of about 1° C. to about 40° C., about 5° C. to about 40° C., about 10° C. to about 40° C., or about 20° C. to about 40° C. In some embodiments, in step c) the reaction is carried out at atmospheric pressure at a temperature of about 20° C. to about 37° C. In some embodiments, in step c) the loading ratio between the minicells and the bioactive agent is about 1:5 to about 5:1.

In some embodiments, the method described above further comprises the step of drying the minicells encapsulating the bioactive agent. In some embodiments, the drying of the minicells encapsulating the bioactive agent is by evaporating a solvent.

Among the methods of the present disclosure, the bioactive agent is a biologically active agent. In some embodiments, the biologically active agent is selected from a botanical ingredient, an essential oil, a saponin and combinations thereof.

The present disclosure provides a method of producing a compound for controlling insects. In some embodiments, said method comprises applying to a locus said compound that comprises a minicell and a bioactive agent with insecticidal activity taught herein.

The present disclosure provides a method of enhancing health of a plant, said method comprising: administering to a plant in need thereof an insecticidally effective amount of a composition that comprises a minicell and a bioactive agent taught herein.

Among the methods of the present disclosure, the health of the plant applied with the composition is enhanced when compared to the health of the plant not administered with the composition. In some embodiments, the composition can be applied with other agricultural products. In some embodiments, other agricultural products can be fertilizers, weed killers, Cryoprotectants, surfactants, detergents, pesticidal soaps, dormant oils, polymers, and/or time-release or biodegradable carrier formulations. In further embodiments, other agricultural products can be also selective herbicides, chemical insecticides, virucides, microbicides, amoebicides, pesticides, fungicides, bacteriocides, nematocides, molluscicides or mixtures of several of these preparations, if desired, together with further agriculturally acceptable carriers, surfactants or application-promoting adjuvants customarily employed in the art of formulation.

The present disclosure provides a method of delivering a bioactive agent to a subject, the method comprising: applying to the subject with a composition that comprises a minicell and a bioactive agent taught herein. In some embodiments, the subject is a plant, an animal, a human or environments around the plant. In some embodiments, the bioactive agent with insecticidal activity is selected from a botanical ingredient, an essential oil, a saponin and combinations thereof. In some embodiments, the bioactive agent has an insecticidal activity.

The present disclosure teaches an insecticidal composition and a method for controlling one or more insects comprising: a minicell and a bioactive agent having insecticidal activity. In embodiments of the composition and method of the present disclosure, the bioactive agent is selected from a botanical ingredient, an essential oil, a saponin, and combinations thereof. In embodiments of the composition and method of the present disclosure, the one or more insects are controlled with application of said composition to a locus. In embodiments of the composition and method of the present disclosure, the minicell enhances stability and insecticidal activity of the bioactive agent. In embodiments of the composition and method of the present disclosure, the minicell is an achromosomal bacterial cell. In embodiments of the composition and method of the present disclosure, the minicell is capable of encapsulating the bioactive agent. In embodiments, the bioactive agent is present within the minicell. In embodiments of the composition and method of the present disclosure, said botanical ingredient is a plant extract having an insecticidal activity. In embodiments of the composition and method of the present disclosure, said botanical ingredient is selected from the group consisting of pyrethrum, pyrethrin, rotenone, sabadilla, cevadine, veratridine, ryania, nicotine, and neen. In embodiments of the composition and method of the present disclosure, said essential oil is a plant extract having an insecticidal activity. In embodiments of the composition and method of the present disclosure, said essential oil is selected from the group consisting of thyme oil, rosemary oil, cinnamon oil, tea tree oil, peppermint oil, clove oil, orange oil, oregano oil, and neem oil, citronella oil, lemon grass oil, eucalyptus oil, lavender oil, and cedar oil. In embodiments of the composition and method of the present disclosure, said essential oil comprises thymol, geraniol, eugenol, myrcene, α-terpinene, p-cymene, d-limonene, menthol, α-pinene, β-pinene, pulegone, anisole, eucalyptol, geraniol, geranyl acetate, linalyl acetate, methyl anthranilate, cinnamaldehyde, methyl benzoate, azadirachtin, citronellal, nerolidol, pulegone, anethole, ethyl benzoate, emamectin benzoate, or benzyl benzoate.

In embodiments of the composition and method of the present disclosure, said insecticidal composition further comprises a soap made with potassium salts of fatty acids. In embodiments of the composition and method of the present disclosure, said insecticidal composition further comprises a surfactant. In embodiments of the composition and method of the present disclosure, the composition is applied in a liquid form or a soluble, dry powder form. In embodiments of the composition and method of the present disclosure, the minicell and the bioactive agent are present in a weight-to-weight ratio of about 5:1 to about 1:5 in the composition. In embodiments of the composition and method of the present disclosure, the minicell and the bioactive agent are present in a weight-to-weight ratio of about 1:1. In embodiments of the composition and method of the present disclosure, the locus is an insect, a plant, an animal, or a human. In embodiments of the composition and method of the present disclosure, In embodiments of the composition and method of the present disclosure, the bioactive agent in the presence of the minicell has at least 1% higher insecticidal activity than the bioactive agent alone at day 1 after treatment of said composition.

The present disclosure provides that essential oils are considered to be a cost effective and safe alternative to chemicals for insect control. The application of EOs has resulted in an improvement in the durability of EOs which led to enhanced efficacy in the field setting.

Due to the high sensitivity of EOs to temperature, pH, and other factors, they need to be encapsulated to ensure stability and consistency of the bioactive components of phytobiotics and programmed release in the environment. Evaluation of existent literature data on essential oil stability revealed that oxidative changes and deterioration reactions, which may lead to both sensory as well as pharmacologically relevant alterations, have scarcely been systematically addressed.

AgriCell platform has proven to protect essential oils and ensure their delivery to insect (e.g. the diamondback moth) in field conditions. Without proper protection, most topically applied essential oils may not reach the intended pest. Consequently, the use of AgriCell platform provides improved performance in terms of chemical stability under harsh environmental conditions, better protection to autoxidative processes during storage, and improving bioavailability through an encapsulation and controlled release mechanism.

### Examples

The following examples are given for the purpose of illustrating various embodiments of the disclosure and are not meant to limit the present disclosure in any fashion. Changes therein and other uses which are encompassed within the spirit of the disclosure, as defined by the scope of the claims, will occur to those skilled in the art.

### Example 1. Production and Characterization of AgriCell (Minicell) Platform

A minimal media fermentation and a two-step centrifugation process constitute the manufacturing process for AgriCell production and purification. The entire process takes approximately 36 hours to produce and recover 20-50 grams dry mass of AgriCells per liter of fermentation broth. Pure AgriCells were concentrated in PBS using centrifugation and then frozen at −80° C. Samples were then sealed inside the LabConco FreeZone Plus 6 system and lyophilized overnight at a chamber temperature of −90° C. and pressure of 133×10⁻³ mBar.

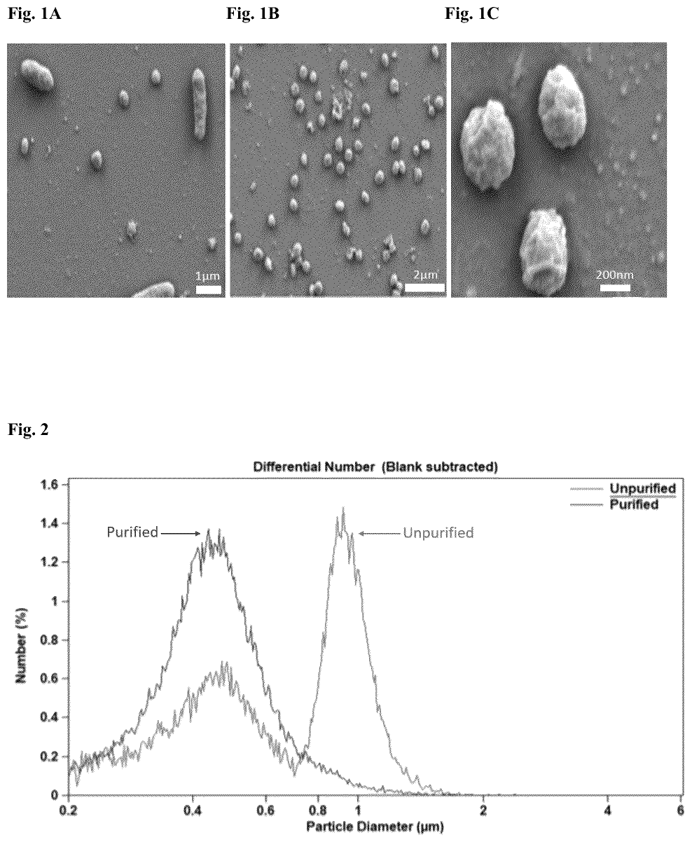

An E. coli strain was taken and designed for a fermentation process to robustly produce AgriCells. A downstream process was developed to rapidly and effectively purify the bacterial minicells from the viable, whole parental cells. FIG. 1A-1C shows scanning electron microscopy (SEM) images of the whole, rod-shaped cells (FIG. 1A) and smaller, spherical AgriCells after a fermentation and purification process (FIG. 1B-1C). All images were taken with the Zeiss Sigma VP HD field emission SEM in secondary electron imaging mode.

The efficacy of a differential centrifugation protocol developed by inventors is further demonstrated in FIG. 2, which shows a size distribution profile of AgriCell producing cell line. The profile was generated using the Multisizer 4E Coulter Counter which detects and characterizes particles using electrical zone sensing. The small, anucleate AgriCells, which purified to a degree of more than 99% purity, are then taken for next step for the encapsulation of active ingredients/agents.

### Example 2. Encapsulation of Essential Oils (EOs) into AgriCell Platform

### (1) Selection of Essential Oils (EOs)

Three active ingredients of model EOs were selected for encapsulation and efficacy studies on AgriCell. Eugenol (99% purity, extracted from clove oil, Sigma Aldrich Lot #STBJ0145), thymol (98.5% purity, extracted from thyme oil, Sigma Aldrich Lot #SLCF3572) and pyrethrum (>50% sum of pyrethrines, extracted from chrysanthemum oil, Sigma Aldrich Lot #BCCB9487) were prepared.

### (2) Loading Process

Phytobiotics (e.g. eugenol, pyrethrum and thymol) were selected as model EOs for encapsulation experiments.

After AgriCells are purified, the concentrated AgriCell paste or dry lyophilized powder is loaded with EOs. If dry, the AgriCells are first homogenized into a finer powder through mechanical homogenization. A stock solution from each EO is prepared in ethanol at 100 mg/mL-200 mg/mL. Lyophilized AgriCells would then be suspended in a solution with the EO solution at a ratio of 1 g of dry AgriCells to 10 mL of EO solution. Once resuspended, the ethanol is allowed to evaporate overnight, leaving behind EO encapsulated AgriCells in the process. After this overnight period, encapsulated AgriCells are removed from the beaker, and the EO-encapsulated AgriCell powder is mechanically homogenized. This encapsulated product is ready for resuspension in its appropriate medium. Loading efficacy was measured and/or calculated as percentage of EO loaded into AgriCell after extraction with ethanol 100% v/v and quantification by UV-Vis spectroscopy. Eugenol and thymol were quantified at 280 nm, whereas pyrethrum was quantified at 230 nm against its respective calibration standard curve.

Encapsulation of Active Ingredients Agents of EOs into AgriCell Platform

The active ingredients/agents of model essential oils (such as eugenol, thymol, pyrethrum) were efficiently encapsulated into AgriCell platform, via passive diffusion-concentration reduction mechanism.

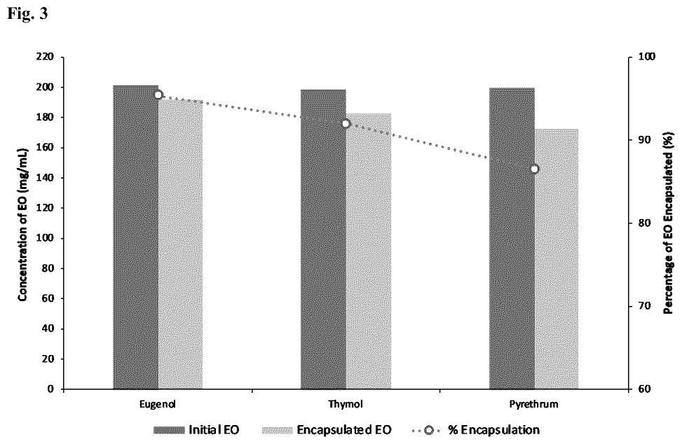

FIG. 3 shows the results for encapsulation efficacy of eugenol, thymol, and pyrethrum, and the final concentrations of EOs encapsulated into the AgriCell. Results indicate all model essential oils showed good yields for encapsulation, with eugenol showing the highest encapsulation efficacy (95.5%), followed by thymol (91.8%) and the lowest yield by pyrethrum (86.5%). All formulations showed optimal stability and were easy to handle.

### Example 3. Stability of Essential Oils (EOs) Encapsulated into AgriCell Platform

### (1) Improved Chemical Stability of EOs to Changes in pH

For illustrative purposes, FIG. 4A-4C shows the physical stability of the model formulation composed by eugenol encapsulated AgriCell, when compared to a standard liposomal formulation encapsulating eugenol, using soybean lecithin and cholesterol. FIG. 4A illustrates AgriCell encapsulating eugenol (right tube), which shows improved chemical stability to changes in pH, when compared to Eugenol-encapsulating liposomal formulation (left tube). AgriCell-encapsulated eugenol showed improved stability when pH was adjusted to simulate gastric conditions (pH 1.2). FIG. 4B-4C illustrates the improved physical stability of AgriCell-encapsulated eugenol (right tube) against a Eugenol-encapsulated liposomal formulation (left tube) on day 1 (FIG. 4B) and day 30 (FIG. 4C) after storage under controlled conditions (temperature 25° C., relative humidity 30% and pH 7.2). All samples were diluted 1:10 with deionized water.

Results present that AgriCell platform succeeded in stabilizing the encapsulated EO (e.g. eugenol) when compared to a standard liposomal formulation, showing better stability to changes in pH (FIG. 4A) and under controlled storage conditions (temperature 25° C., relative humidity 30% and pH 7.2; FIG. 4B-4C).

As shown in FIG. 4A, the EO-encapsulated liposomes suffered depletion flocculation processes when submitted to changes in pH 1.2 simulating gastric conditions, depicting in immediate release of encapsulated EO and poor bioavailability without desired nutritional effects. As shown in FIG. 4B-4C, the same liposomal formulation lacked long term stability and the formulation experienced significant degradation after 30 days storage under controlled conditions.

Thus, results indicate that AgriCell succeeded in providing improved stability, higher bioavailability and extended shelf life for encapsulated EOs.

### (2) Improved Thermal Stability of EOs

AgriCell-encapsulated EOs, which were AC-Eugenol, AC-Pyrethrum, and AC-Thymol, (200 mg/mL of EO loaded with 200 mg/mL of AgriCell) were diluted 1:10 in deionized water (total volume 1000 μL, 14 replicates for each EO) and the solutions were left at 40° C. for a total period of 7 days. One replicate of each EO per treatment was collected daily and tested for EO content. Results were reported as concentration of EO as function of time for each stability condition.

Ambient temperature crucially influences essential oil stability in several respects. Generally, chemical reactions accelerate with increasing heat due to the temperature-dependence of the reaction rate as expressed by the Arrhenius equation. Based thereon, the van′t Hoff law states that a temperature rise of 10° C. approximately doubles chemical reaction rates, a relation that can be consulted to predict stability at different temperatures (Glasl, 1975). Hence, both autoxidation as well as decomposition of hydroperoxides advances with increasing temperature, even more so since heat is likely to contribute to the initial formation of free radicals (Choe and Min, 2006).

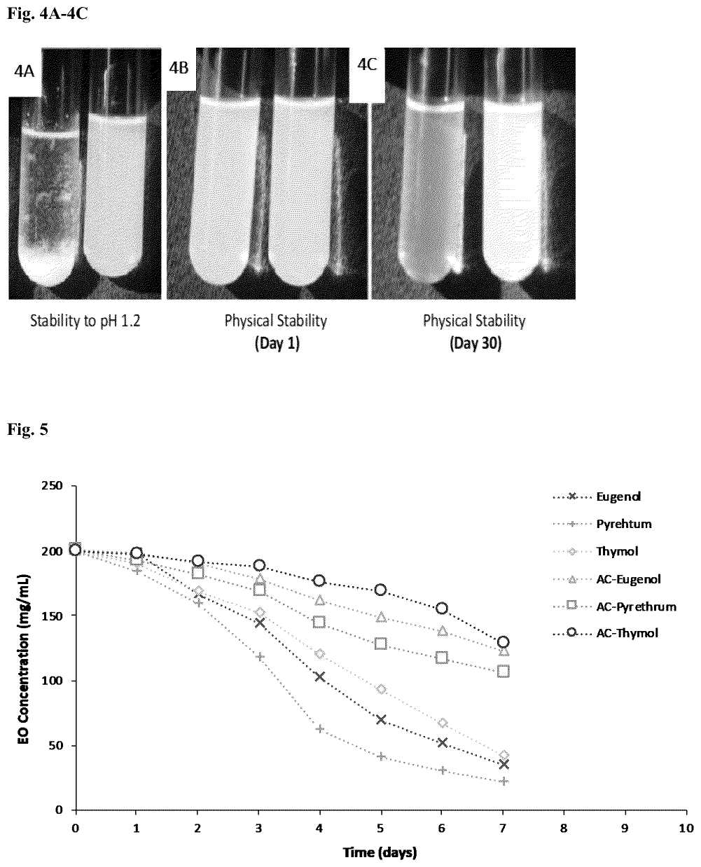

FIG. 5 shows the performance of AgriCell in preventing thermal degradation of model EOs. Results support the improvement in EO's thermal stability when encapsulated into AgriCell. The trends in FIG. 5 shows that free pyrethrum experienced the highest sensitivity to temperature raise, followed by free eugenol and lastly free thymol, reaching percentages of degradation after day 7 of 89.2% (free pyrethrum), 82.7% (free eugenol) and 79.1% (free thymol), respectively. The same trends were seen in the AgriCell encapsulated formulations, but the percentages of degradation were significantly improved in about 45%, with AgriCell-encapsulated pyrethrum, eugenol and thymol yielding to percentages of degradation of 52.5%, 61.0% and 64.4% at day 7 of the stability experiment.

### (3) Improved Oxidative Stability of EOs

Ultraviolet (UV) light and visible (Vis) light are considered to accelerate autoxidation processes by triggering the hydrogen abstraction that results in the formation of alkyl radicals. Compositional changes proceeded considerably faster when illumination is involved. Especially monoterpenes have been shown to degrade rapidly under the influence of light (Turek and Stintzing, 2013). Essential oils experiences accelerated autoxidative reactions when exposed to UV or light radiation, which triggers hydrogen abstraction that results in the formation of alkyl radicals (Turek and Stintzin 2013).

AgriCell-encapsulated EOs, which were AC-Eugenol, AC-Pyrethrum, and AC-Thymol, (200 mg/mL of EO loaded with 200 mg/mL of AgriCell) were diluted 1:10 in deionized water (total volume 1000 μL, 14 replicates for each EO) and the solutions were left under UV radiation for a total period of 7 days. One replicate of each EO per treatment was collected daily and tested for EO content by UV-Vis spectroscopy as described in Example 2. Results were reported as concentration of EO as function of time for each stability condition.

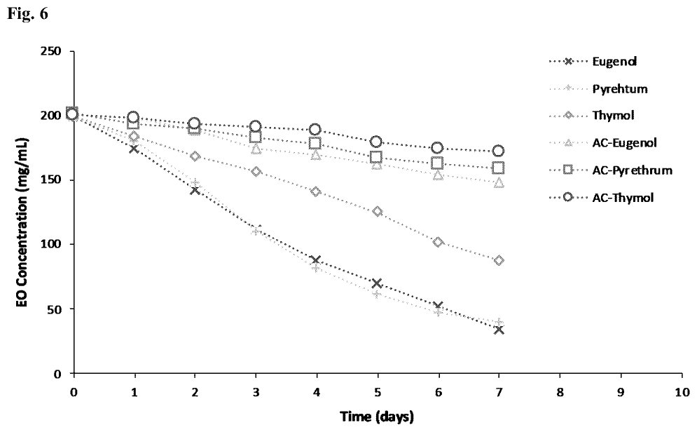

FIG. 6 shows the performance of AgriCell in preventing oxidative degradation of model EOs by influence of UV and Vis light. Results support the improvement in EO's oxidative stability when encapsulated into AgriCell. The trends in FIG. 6 show that free pyrethrum and eugenol experienced the highest oxidative rate, whereas free thymol showed lower tendency to oxidation. After 7 days of stability experiments, the oxidative processes yielded existence of 17.3%, 20.0% and 44.2% for eugenol, pyrethrum and thymol, respectively (i.e., 82.7%, 80.0%, and 55.8% of eugenol, pyrethrum and thymol, respectively were degraded by autoxidation). However, after 7 days of stability experiments, degradation rates for the model essential oils encapsulated into AgriCell were 26.0%, 20.0%, and 14.1% for eugenol, pyrethrum and thymol, respectively (i.e. 74.0%, 80.0% and 85.9% of eugenol, pyrethrum and thymol, respectively remained/not damaged). This is corresponding to an improvement of about 50% for all the encapsulated formulations over free EO formulations, supporting the protective effect of AgriCell encapsulation on autoxidation of essential oils. The results in FIG. 6 shows the effect AgriCell encapsulation on preventing autoxidative degradation of essential oils.

These results support the potential improvement in shelf-life properties for encapsulated AgriCell containing sensitive bioactive ingredients.

### Example 4. Controlled Release of Essential Oils (EOs) Encapsulated into AgriCell Platform

### (1) Chitosan Coating Process to Modify AgriCell Controlled Release Properties

AgriCell-encapsulated EO (AgriCell-EO) formulations can then be further modified for its release properties. Surface coating technique via ionotropic gelation mechanism was used to generate a unique AgriCell-EO formulation, composed by an EO encapsulated by AgriCell that is coated by chitosan biopolymer (AgriCell-EO CHT).

Existing studies have shown that to optimize the characteristics and stability of carriers which can be coated by a biopolymer, by means of electrostatic interactions providing a dense polymeric shell around the carriers that will promote stabilization and prevent leaking of active ingredient to external compartments (Filipovid-Grcic et al. 2007, Mengoni et al. 2017). In this example, AgriCell platform was coated by chitosan through ionic gelation reaction due to electrostatic interactions between the negatively charged AgriCell surface and the positive charges of primary amino groups in chitosan, similar to previously described for chitosan coated liposomes (Madrigal-Carballo et al. 2009, 2010). Chitosan solution, in acetic acid, was mixed with AgriCell platform, dispersed in PBS (1×, pH 7.4) and previously loaded with EOs (eugenol and thymol), under continuous stirring for 1 hour at room temperature, yielding chitosan coated AgriCell-EO that were purified by centrifugation (12,000 rpm) and stored at 4° C. until further experimentation.

### (2) Controlled Release of EOs from AgriCell and AgriCell-CHT

EOs-loaded AgriCell formulations (with and without chitosan surface coating) were prepared in PBS (1×, pH 7.4) and diluted to a known concentration in release media composed by PBS, ethanol and Tween 80 emulsifier (140:59:1 v/v/v). Samples (500 μL) were loaded into dialysis cassettes (MWCO 8-10 kDa) pre stabilized in deionized water, place into a reservoir container filled with exactly 100 mL of release media and kept under gentle stirring at room temperature. At different time intervals, an aliquot (1000 μL) of release media was removed for quantification of released EOs in ethanol (100% v/v) performed by UV-vis spectrometry as described above, a new volume of fresh release media was added to continue release experiments. EOs released from AgriCell platform were observed as percentage cumulative release over the selected timeframe. Original content of EOs loaded into AgriCell and the remained content after release studies were quantified by solvent extraction with ethanol (100% v/v) directly from AgriCell.

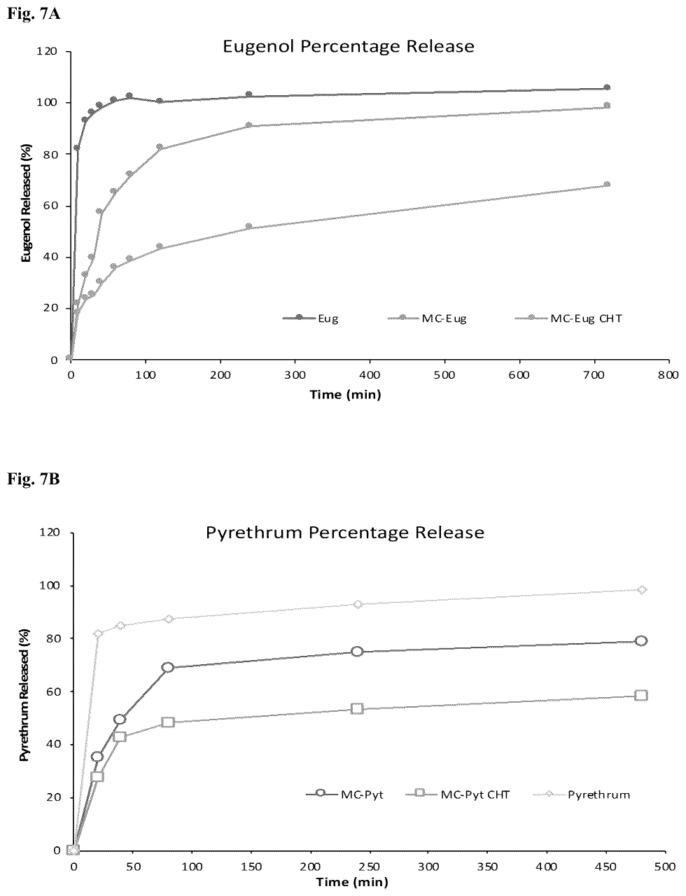

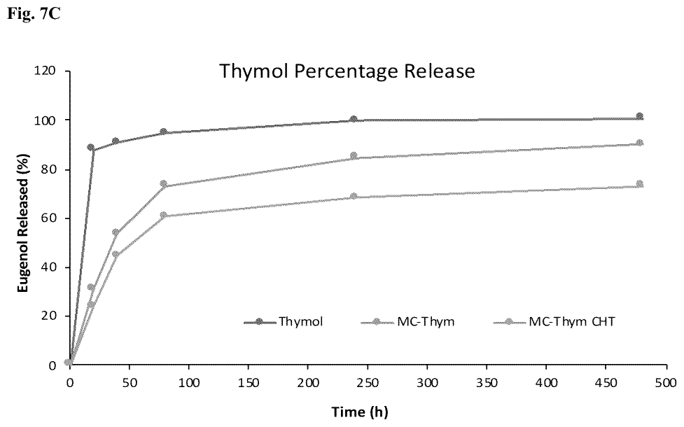

The cumulative release profile of model EOs was calculated by determining the concentration of each EO in the release medium at different times. FIG. 7A-7C shows the release profiles for eugenol (FIG. 7A), pyrethrum (FIG. 7B) and thymol (FIG. 7C) loaded into AgriCell formulations, respectively. Results indicate AgriCell platform can efficiently delay burst release stage of EOs, as suggested by the significant reduction in the percentage of each EO released in the first hour of the release experiments, where all encapsulated EOs showed percentages of release lower than 40%, whereas free EOs have reached close to 90% release in the same timeframe.

After completion of release studies, AgriCell encapsulated EOs reached a percentage release of 98.5%, 79.0% and 90.1% for eugenol, pyrethrum and thymol, respectively, as shown in FIG. 7A-7C. Similar behavior was observed for the treated AgriCell systems surface coated by chitosan biopolymer (CHT), but the CHT coated systems showing a more efficient delaying effect on release of EOs when compared to AgriCell non-coated, yielding to final percentages of release at the end of the experiment of 67.8%, 58.3% and 73.0% foe eugenol, pyrethrum and thymol, respectively. In average, chitosan coating of AgriCell was able to improve controlled release of encapsulated EOS in about 20% for all model EOs tested.

### Example 5. Efficacy of AgriCell-Pyrethrum on Velvetbean Caterpillar (VBC)

Pyrethrins are a class of bioinsecticidal Organic Compounds derived from the plant Chrysanthemum cinerariifolium. Pyrethrins are powerful insecticides, but are limited by their short Environmental half life which is accelerated by UV, heat and environmental stresses.

Prior to conducting field trials (presented in Example 6), leaf disc and greenhouse assays were executed in order to compare the efficacy of the source Pyrethrum from Sigma Aldrich (“Free-Py” a.k.a. “Sigma-Py”), the AgriCell encapsulated Sigma Aldrich Pyrethrum (“AC-Py” a.k.a. “AGR-Py”), and the commercial Pyrethrum product (Pyganic®).

### (1) Leaf Disc Assay: High Throughput Experiment

Leaf disc Test was performed to check insecticidal activity of Sigma Py (Free-Py) in comparison to Pyganic®. Soy leaf discs dipped in the formulation, placed on agar and infested with the second instar velvetbean caterpillar (VBC). 5 reps were rated for % mortality at 1, 2, 3 Day after infestation (DAI).

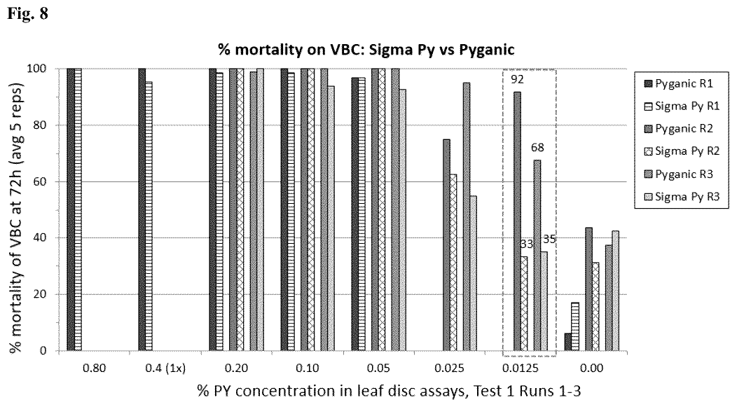

FIG. 8 illustrates percent (%) mortality on Velvetbean Caterpillar (VBC) in leaf disc assays. Soy leaf discs treated with different Pyrethrum (Py) concentrations of formulations (0.8%, 0.4%, 0.2%, 0.1%, 0.05%, 0.025%, 0.0125%) and infested with the second instar VBC. The mortality of VBC was measured at 3 days after infestation (DAI). The tested formulations were pyrethrum extract (Sigma-Aldrich Lot #BCCB9487; “Sigma Py”) vs PyGanic® Crop Protection EC 5.0 (commercial formulation manufactured by MGK; “Pyganic”). 5 reps rated for % mortality at 3 DAI.

Three runs of titrations showed that Sigma Py is about ½ to ⅓ as bioactive as Pyganic® on velvetbean caterpillar (VBC) in Py concentration of 0.025% to 0.0125%. This indicates that Pyganic is at least 2 or 3 times more effective and bioactive than Sigma Py as an insecticide. Lethal (1×) rate of Sigma Py on VBC is around 0.05% in the formulation.

### (2) Whole Plant Assay: Mimic Field Use

Whole plant test was performed to see if AC-Py shows any benefits or bioactivity over free-Py in whole plants. V1 soy plants were sprayed with each formulation and infested with VBC at different times. Velvetbean caterpillars (VBC) were introduced/infested at 3 different timings: VBC infestation at 1 DAT of each formulation, VBC infestation at 3 DAT infestation of each formulation, and VBC infestation at 5 DAT infestation of each formulation, respectively. Plants exposed to supplemental UV in the controlled environment.

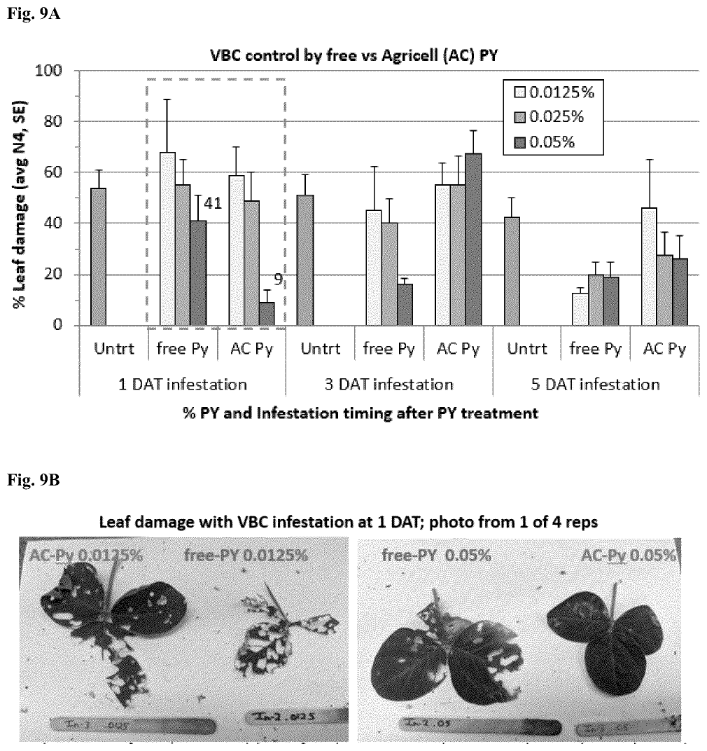

FIG. 9A illustrates percent (%) leaf damage (i.e. leaf area consumed) in whole soy plants sprayed/treated with three different Py concentrations (0.125%, 0.025%, and 0.05%) of formulations and infested with VBC at 1, 3, 5 days after treatment (DAT) of each formulation. The tested formulations were unencapsulated Pyrethrins (“Free Py”; a.k.a. “Sigma Py” described in FIG. 8, which was not encapsulated by AgriCell) and AgriCell encapsulated Pyrethrins (“AC-Py”; “Sigma Py” encapsulated by AgriCell). 4 reps rated for % leaf damages. The VBC-infested soy plants without any formulation sprayed/treated were used as a control (that is Untreated; “Untrt”). FIG. 9B presents leaf damage with VBC infestation at 1 DAT with (i) 0.0125% free Py and 0.0125% Agricell (AC)-Py treated (left photo) and (ii) 0.05% free Py and 0.05% Agricell (AC)-Py treated (right photo).

As shown in FIG. 9A-9B, AC-Py showed lower upfront leaf damage than free-Py because AC-Py showed lower leaf damage than free-Py at 1 DAT infestation. 1 DAT infestation showed less damage in AC-Py than free-Py at the highest rate (0.05%). Overall 3 and 5 DAT showed weak activities with poor dose response.

Another whole plant test was performed with variables modified. Next set of experiments were conducted to investigate upfront activity and duration of efficacy for different formulations among AC-Py, Free-Py, and Pyganic®. V1 soy plants were sprayed with free-Py, AC-Py or Pyganic, plants in CE. The 1st trifoliate was harvested at 1, 4, 7 DAT and placed on agar, infested with VBC.

Velvetbean caterpillars (VBC) were introduced at 3 different timings: VBC infestation at 1 DAT of each formulation, VBC infestation at 4 DAT infestation of each formulation, and VBC infestation at 7 DAT infestation of each formulation. The 4 and 7 DAT conditions were intended to evaluate any advantages from controlled release of AC-Py formulations. Damage ratings were recorded 4 and 6 days after infestation (DAI).

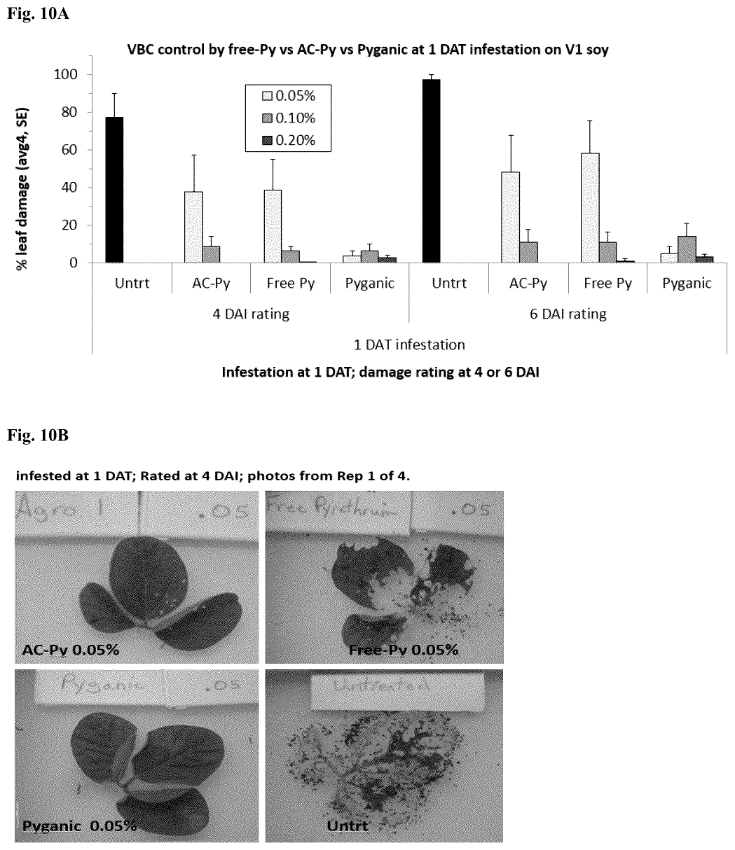

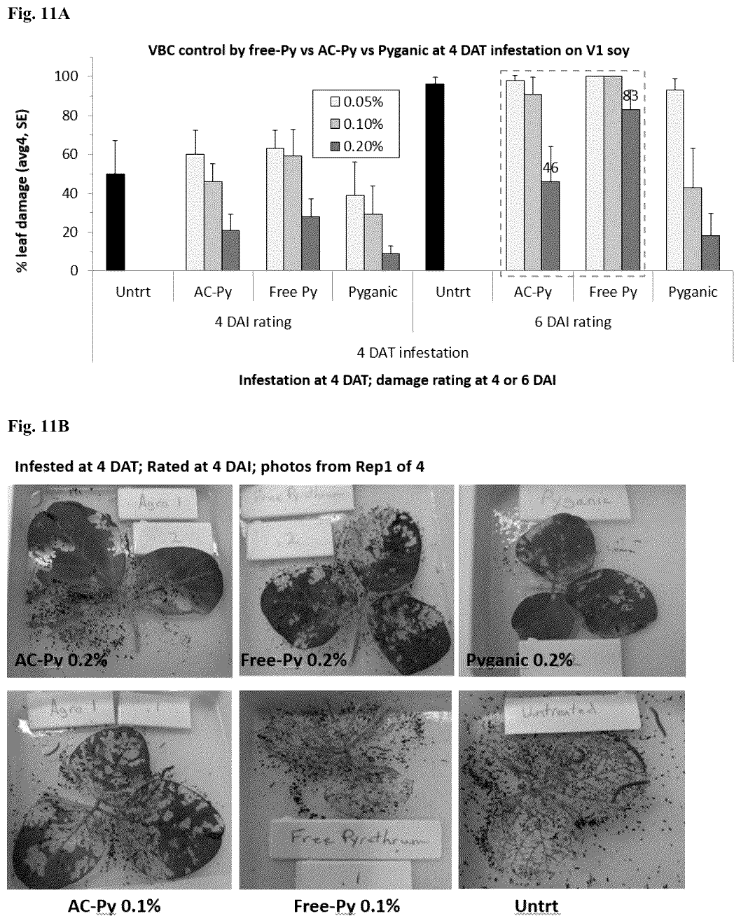

FIG. 10A illustrates percent (%) leaf damage in whole soy plants sprayed with three different Py concentrations (0.05%, 0.10%, and 0.20%) of formulations and infested with VBC at 1 day after treatment (DAT) of each formulation. Then, damage ratings were recorded at 4 and 6 days after VBC infestation (DAI). The tested formulations were (i) AgriCell encapsulated Pyrethrins (“AC-Py”), (ii) unencapsulated Pyrethrins (“Free Py”), (iii) PyGanic® Crop Protection EC 5.0 (“Pyganic”). 4 reps rated for % leaf damages. The VBC-infested soy plants without any formulation sprayed/treated were used as a control (that is Untreated; “Untrt”). FIG. 10B presents leaf damage with VBC infestation at 1 DAT with (i) 0.05% AC-Py, (ii) 0.05% Free-Py, (iii) 0.05% Pyganic, and (iv) Py-Untreated (Untrt). The photos were the damaged 1^{st} trifoliate, which was rated at 4 days after VBC infestation (DAI).

FIG. 10A shows that VBC control by free-Py vs AC-Py vs Pyganic at 1 DAT infestation on V1 soy. VBC pressure with 80-100% damage in Untreated. Good response to dose and damage progression. As Pyganic® performed the best because it is at least 2 or 3 times more bioactive than Sigma Py as demonstrated in FIG. 8. At 1 DAT freshly applied Py showed good overall activity in all formulation. FIG. 10B shows Leaf damage with VBC infestation at 1 DAT and rated at 4 DAI with free Py and Agricell (AC)-Py treated. Freshly applied Py (1 DAT) showed good overall bioactivities as a bioinsecticide even at the lowest rate (0.05%), and some reps showed AC-Py outperforming Free-Py.

FIG. 11A illustrates percent (%) leaf damage in whole soy plants sprayed with three different Py concentrations (0.05%, 0.10%, and 0.20%) of formulations and infested with VBC at 4 day after treatment (DAT) of each formulation. Then, damage ratings were recorded at 4 and 6 days after VBC infestation (DAI). The tested formulations were (i) AgriCell encapsulated Pyrethrins (“AC-Py”), (ii) unencapsulated Pyrethrins (“Free Py”), (iii) PyGanic® Crop Protection EC 5.0 (“Pyganic”). 4 reps rated for % leaf damages. The VBC-infested soy plants without any formulation sprayed/treated were used as a control (that is Untreated; “Untrt”). FIG. 11B presents leaf damage with VBC infestation at 4 DAT with (i) 0.05% AC-Py, (ii) 0.05% Free-Py, (iii) 0.05% Pyganic, and (iv) Py-Untreated (Untrt). The photos were the damaged 1^{st} trifoliate, which was rated at 4 days after VBC infestation (DAI).

FIG. 11A shows VBC control by free-Py vs AC-Py vs Pyganic® at 4 DAT infestation on V1 soy plants. At 4 DAT infestation, further leaf damages were observed due to Py degradation in comparison to 1DAT infestation. However, AC-Py (0.2%) shows at least 2 times better control of leaf damage (by VBC) than Free-Py (0.2%) as shown in FIG. 11A. FIG. 11B shows leaf damage with VBC infestation at 4 DAT and rated at 4 DAT with free Py and Agricell (AC)-Py treated. FIG. 11B shows leaf damage with VBC infestation at 4 DAT and rated at 4 DAT with free Py and Agricell (AC)-Py treated. AC-Py at 0.2% outperformed free-Py. In general, damages were high at low Py concentrations (0.05% and 0.01%) compared to 0.2% of Py concentration. These results from FIG. 11A-11B indicate that AC-Py extended VBC control over Free-Py. Commercial product Pyganic® continue to show the best performance.

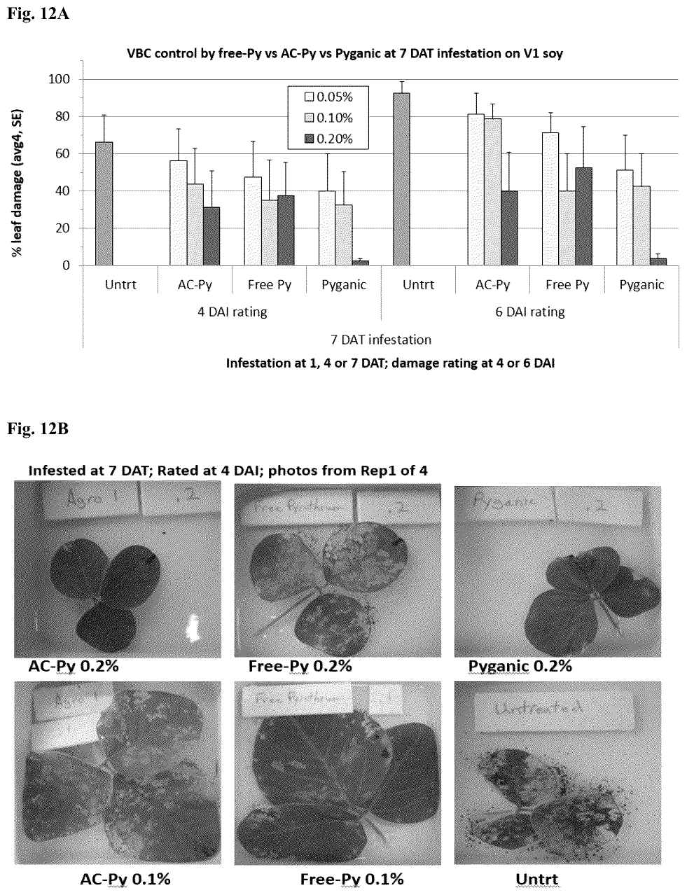

FIG. 12A illustrates percent (%) leaf damage in whole soy plants sprayed with three different Py concentrations (0.05%, 0.10%, and 0.20%) of formulations and infested with VBC at 7 day after treatment (DAT) of each formulation. Then, damage ratings were recorded at 4 and 6 days after VBC infestation (DAI). The tested formulations were (i) AgriCell encapsulated Pyrethrins (“AC-Py”), (ii) unencapsulated Pyrethrins (“Free Py”), (iii) PyGanic® Crop Protection EC 5.0 (“Pyganic”). 4 reps rated for % leaf damages. The VBC-infested soy plants without any formulation sprayed/treated were used as a control (that is Untreated; “Untrt”). FIG. 12B presents leaf damage with VBC infestation at 7 DAT with (i) 0.05% AC-Py, (ii) 0.05% Free-Py, (iii) 0.05% Pyganic, and (iv) Py-Untreated (Untrt). The photos were the damaged 1^{st} trifoliate, which was rated at 4 days after VBC infestation (DAI). FIG. 12A shows VBC control by free-Py vs AC-Py vs Pyganic at 7 DAT infestation on V1 soy plants. At 7 DAT infestation AC-Py and free-Py showed similar leaf damages. Only Pyganic at 0.2% showed minimal damage. FIG. 12B shows leaf damage with VBC infestation at 7 DAT and rated at 4 DAT with free Py and Agricell (AC)-Py treated.

In this example, AC-Py showed comparable upfront activity as Free-Py right after formulation spray (1 DAT). Only the lowest rate (0.05%) showed any significant damages (˜50%). Py activity deteriorated significantly after 4 days of aging on soybean plants. 4 DAT infestation showed ˜100% damage at the lower rates (0.05 & 0.1%) of AC-Py and Free-Py. At the highest dose (0.2%), AC-Py outperformed free-Py showing about half as much damage. AC encapsulation extended Py activity on VBC.

### Example 6. Artificial Infestation Diamondback Moth Field Trial with Pyrethrum Extract Encapsulated by AgriCell

Individual cabbage plants (4 leaf stage) were transplanted to 10-inch diameter pots. Pots were placed under mesh screen cages in a cultivated (weed free) field. On Day 0, plants were sprayed with a hand sprayer delivering 15 gal/acre at ca. 30 psi. Each plant was considered a replication and there were 4 replications per treatment. Once treatments dried, each plant was infested with ten of the first instar diamondback moth (DBM) larvae from Benzon Research. Plants were placed back under cages in a completely random design and cages were secured. On Day 3, 3 days after treatment (3 DAT) cages were removed and each plant was carefully observed and photographed to determine the number of live larvae and percent defoliation. On Day 6 (6 DAT) this was repeated. At this time the majority of surviving larvae had pupated and the trial was terminated.

Efficacy of AgriCell-pyrethrum on Diamondback Moth (DBM) in Texas Cabbage AgriCell-Py was tested against MGK-Py in the field. MGK-Py is known to be UV sensitive, which limits field efficacy. AGR-Py are AgriCell-encapsulated Sigma Pyrethrin formulations and MGK-Py is the commercial Pyrethrin formulation called Pyganic®.

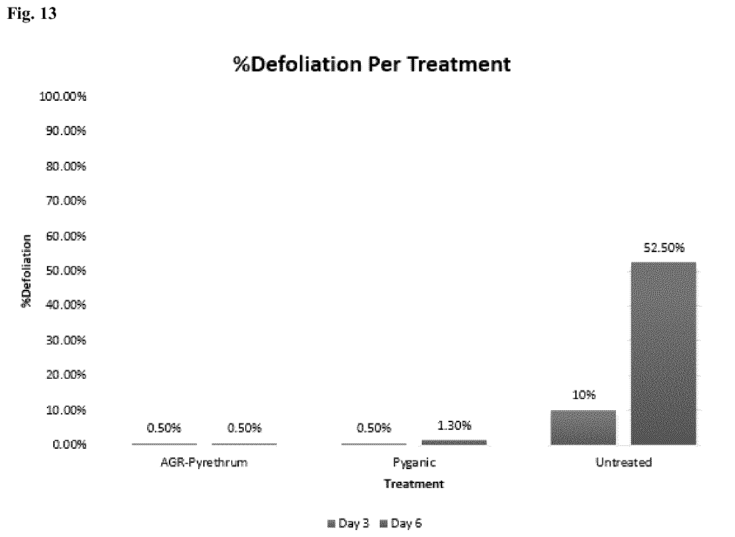

FIG. 13 illustrates percent (%) defoliation at 3 and 6 days after treatment of formulations to soy plants in the field. The tested formulations were AgriCell-Pyrethrum, PyGanic®, and No Py treatment (untreated). Table 1 also presents the results of FIG. 13.

TABLE 1

| | | | | Mean no. | |
|---|---|---|---|---|---|
| | | Mean no. | | live larvae | |
| | | live | Mean % | or | Mean % |
| Treatment | Treatment | larvae/plant | defoliation/plant | pupae/plant | defoliation/plant |
| No. | Name | (3 DAT) | (3 DAT) | (6 DAT) | (6 DAT) |
| 1 | AGR-Py | 0.3d | 0.5c | 0.0a | 0.5c |
| 2 | PyGanic ® | 0.5cd | 0.5c | 0.0a | 1.3c |
| 3 | Untreated | 6.8a | 10.0a | 0.3a | 52.5a |

Means within a column followed by the same letter are not significantly different (P > 0.05; PROC ANOVA; Mean comparison by LSD [SAS 9.4]).

As shown in FIG. 8, MGK-pyrethrin showed at least 2 or 3 times more effective and active than Free-Py (unencapsulated Py). However, AGR-Py (i.e. AgriCell-encapsulated Py) demonstrates as comparable as MGK-Py in effectiveness and activity. Thus, AGR-Py shows the similar effectiveness and insecticidal activity to insects (e.g. DBM) to commercial product, PyGanic®. The results in FIG. 13 and Table 1 indicate the ability of the AgriCell technology, which significantly enhances the efficacy of the Sigma Aldrich Pyrethrum (Free-Py) in the field. This is due to the AgriCell providing enhanced uptake in the gut of the insect as well as protection from UV/Heat Damage.

### NUMBERED EMBODIMENTS OF THE DISCLOSURE

Notwithstanding the appended claims, the disclosure sets forth the following numbered embodiments:

### Insecticidal Composition

1. An insecticidal composition for controlling one or more insects comprising:
   (i) a minicell and (ii) a bioactive agent having insecticidal activity, wherein the bioactive agent is selected from a botanical ingredient, an essential oil, a saponin, and combinations thereof,
   wherein the one or more insects are controlled with application of said composition to a locus, and
   wherein the minicell enhances stability and insecticidal activity of said bioactive agent.
2. The insecticidal composition of any one of the preceding embodiments, wherein the minicell is an achromosomal bacterial cell.
3. The insecticidal composition of any one of the preceding embodiments, wherein the minicell is capable of encapsulating the bioactive agent and wherein the bioactive agent is present within the minicell.
4. The insecticidal composition of any one of the preceding embodiments, wherein said botanical ingredient is a plant extract having an insecticidal activity.
5. The insecticidal composition of any one of the preceding embodiments, wherein said botanical ingredient is selected from the group consisting of pyrethrum, pyrethrin, rotenone, sabadilla, cevadine, veratridine, ryania, nicotine, and neen.
6. The insecticidal composition of any one of the preceding embodiments, wherein said essential oil is a plant extract having an insecticidal activity.
7. The insecticidal composition of any one of the preceding embodiments, wherein said essential oil is selected from the group consisting of thyme oil, rosemary oil, cinnamon oil, tea tree oil, peppermint oil, clove oil, orange oil, oregano oil, and neem oil, citronella oil, lemon grass oil, eucalyptus oil, lavender oil, and cedar oil.
8. The insecticidal composition of any one of the preceding embodiments, wherein said essential oil comprises thymol, geraniol, eugenol, myrcene, α-terpinene, p-cymene, d-limonene, menthol, α-pinene, β-pinene, pulegone, anisole, eucalyptol, geraniol, geranyl acetate, linalyl acetate, methyl anthranilate, cinnamaldehyde, methyl benzoate, azadirachtin, citronellal, nerolidol, pulegone, anethole, ethyl benzoate, emamectin benzoate, or benzyl benzoate.
9. The insecticidal composition of any one of the preceding embodiments, wherein said insecticidal composition further comprises a soap made with potassium salts of fatty acids.
10. The insecticidal composition of any one of the preceding embodiments, wherein said insecticidal composition further comprises a surfactant.
11. The insecticidal composition of any one of the preceding embodiments, wherein the composition is applied in a liquid form or a soluble, dry powder form.
12. The insecticidal composition of any one of the preceding embodiments, wherein the minicell and the bioactive agent are present in a weight-to-weight ratio of about 5:1 to about 1:5 in the composition.
13. The insecticidal composition of any one of the preceding embodiments, wherein the minicell and the bioactive agent are present in a weight-to-weight ratio of about 1:1.
14. The insecticidal composition of any one of the preceding embodiments, wherein the locus is an insect, a plant, an animal, or a human.
15. The insecticidal composition of any one of the preceding embodiments, wherein the bioactive agent in the presence of the minicell has at least 1% higher insecticidal activity than the bioactive agent alone at day 1 after treatment of said composition.
16. The insecticidal composition of any one of the preceding embodiments, wherein at least about 10% of the bioactive agent is encapsulated by the minicell.
17. The insecticidal composition of any one of the preceding embodiments, wherein the minicell stabilizes the bioactive agent in an acidic condition, wherein the acidic condition is less than pH 7.
18. The insecticidal composition of any one of the preceding embodiments, wherein the minicell encapsulating the bioactive agent is preserved from depletion flocculation when a pH is adjusted to an extremely acidic condition.
19. The insecticidal composition of any one of the preceding embodiments, wherein the acidic condition is as low as pH 1.
20. The insecticidal composition of any one of the preceding embodiments, wherein the minicell stabilizes the bioactive agent at least 30 days at room temperature in a neutral pH condition.
21. The insecticidal composition of any one of the preceding embodiments, wherein the minicell stabilizes the bioactive agent in a thermal variation.
22. The insecticidal composition of any one of the preceding embodiments, wherein the bioactive agent encapsulated by the minicell is at least 1.1 fold more resistant to thermal degradation than a free bioactive agent not encapsulated by the minicell on day 7 after a heat treatment at 40° C.
23. The insecticidal composition of any one of the preceding embodiments, wherein the bioactive agent encapsulated by the minicell has less than about 60% thermal degradation on day 7 after a heat treatment at 40° C.
24. The insecticidal composition of any one of the preceding embodiments, wherein the minicell protects the bioactive agent from oxidative degradation by ultraviolet (UV) or visible light.
25. The insecticidal composition of any one of the preceding embodiments, wherein the bioactive agent encapsulated by the minicell is at least 1.1 fold more resistant to oxidative degradation than a free bioactive agent not encapsulated by the minicell on day 7 under UV or visible light exposure.
26. The insecticidal composition of any one of the preceding embodiments, wherein the bioactive agent encapsulated by the minicell has less than about 35% oxidative degradation on day 7 under UV or visible light exposure.
27. The insecticidal composition of any one of the preceding embodiments, wherein the minicell confers to the bioactive agent an improved stability, an enhanced bioavailability and an extended shelf life.
28. The insecticidal composition of any one of the preceding embodiments, wherein a release of the bioactive agent encapsulated by the minicell is delayed when compared to a free bioactive agent not encapsulated by the minicell.
29. The insecticidal composition of any one of the preceding embodiments, wherein a release percentage (%) of the encapsulated bioactive agent is less than about 50% in a first hour.
30. The insecticidal composition of any one of the preceding embodiments, wherein a release percentage (%) of the encapsulated bioactive agent is at least about 45% at 8 hours after the release.
31. The insecticidal composition of any one of the preceding embodiments, wherein the encapsulated bioactive agent has an extended release with less than about 50% of the bioactive agent retained at 8 hours after the release.
32. The insecticidal composition of any one of the preceding embodiments, wherein the minicell is coated by biopolymer.
33. The insecticidal composition of any one of the preceding embodiments, wherein the biopolymer is a chitosan.
34. The insecticidal composition of any one of the preceding embodiments, wherein a release of the bioactive agent encapsulated by the biopolymer-coated minicell is further delayed when compared to the encapsulated bioactive agent without the biopolymer coated.
35. The insecticidal composition of any one of the preceding embodiments, wherein the bioactive agent encapsulated by the biopolymer-coated minicell has a further extended release with at least about 10% of the bioactive agent retained, when compared to the encapsulated bioactive agent without the biopolymer coated, at 8 hours after the release.
36. The insecticidal composition of any one of the preceding embodiments, wherein the bioactive agent encapsulated by the minicell is capable of being delivered to a target in a controlled release manner.

### Method of Controlling Insects

1. A method of controlling one or more insects, the method comprising: applying an insecticidal composition to a locus, wherein said insecticidal composition comprising:
(i) a minicell and (ii) a bioactive agent having insecticidal activity,
wherein the bioactive agent is selected from a botanical ingredient, an essential oil, a saponin, and combinations thereof,
wherein the one or more insects are controlled with application of said composition to said locus, and
wherein the minicell enhances stability and insecticidal activity of said bioactive agent.
2. The method of any one of the preceding embodiments, wherein the minicell is an achromosomal bacterial cell.
3. The method of any one of the preceding embodiments, wherein the minicell is capable of encapsulating the bioactive agent and wherein the bioactive agent is present within the minicell.
4. The method of any one of the preceding embodiments, wherein said botanical ingredient is a plant extract having an insecticidal activity.
5. The method of any one of the preceding embodiments, wherein said botanical ingredient is selected from the group consisting of pyrethrum, pyrethrin, rotenone, sabadilla, cevadine, veratridine, ryania, nicotine, and neen.
6. The method of any one of the preceding embodiments, wherein said essential oil is a plant extract having an insecticidal activity.
7. The method of any one of the preceding embodiments, wherein said essential oil is selected from the group consisting of thyme oil, rosemary oil, cinnamon oil, tea tree oil, peppermint oil, clove oil, orange oil, oregano oil, and neem oil, citronella oil, lemon grass oil, eucalyptus oil, lavender oil, and cedar oil.
8. The method of any one of the preceding embodiments, wherein said essential oil comprises thymol, geraniol, eugenol, myrcene, α-terpinene, p-cymene, d-limonene, menthol, α-pinene, β-pinene, pulegone, anisole, eucalyptol, geraniol, geranyl acetate, linalyl acetate, methyl anthranilate, cinnamaldehyde, methyl benzoate, azadirachtin, citronellal, nerolidol, pulegone, anethole, ethyl benzoate, emamectin benzoate, or benzyl benzoate.
9. The method of any one of the preceding embodiments, wherein said insecticidal composition further comprises a soap made with potassium salts of fatty acids.
10. The method of any one of the preceding embodiments, wherein said insecticidal composition further comprises a surfactant.
11. The method of any one of the preceding embodiments, wherein the composition is applied in a liquid form or a soluble, dry powder form.
12. The method of any one of the preceding embodiments, wherein the minicell and the bioactive agent are present in a weight-to-weight ratio of about 5:1 to about 1:5 in the composition.
13. The method of any one of the preceding embodiments, wherein the minicell and the bioactive agent are present in a weight-to-weight ratio of about 1:1.
14. The method of any one of the preceding embodiments, wherein the locus is an insect, a plant, an animal, or a human.
15. The method of any one of the preceding embodiments, wherein the bioactive agent in the presence of the minicell has at least 1% higher insecticidal activity than the bioactive agent alone at day 1 after treatment of said composition.

### Bacterial Minicell Comprising an Essential Oil

1. A bacterial minicell comprising: an essential oil, wherein the minicell is loaded with the essential oil in a weight-to-weight ratio of about 5:1 to about 1:5, wherein about 50% w/w to about 150% w/w of the essential oil is encapsulated by the minicell, and wherein a release percentage (%) of the encapsulated essential oil is less than about 50% in a first hour.
2. The bacterial minicell as in any one of the preceding embodiments, wherein a release percentage (%) of the encapsulated essential oil is at least about 45% at 8 hours after the release.
3. The bacterial minicell as in any one of the preceding embodiments, wherein the encapsulated essential oil has an extended release with less than about 50% of the essential oil retained at 8 hours after the release.
4. The bacterial minicell as in any one of the preceding embodiments, wherein the minicell is coated by biopolymer.
5. The bacterial minicell as in any one of the preceding embodiments, wherein the biopolymer is a chitosan.
6. The bacterial minicell as in any one of the preceding embodiments, wherein a release of the essential oil encapsulated by the biopolymer-coated minicell is further delayed when compared to the encapsulated essential oil without the biopolymer coated.
7. The bacterial minicell as in any one of the preceding embodiments, wherein the essential oil encapsulated by the biopolymer-coated minicell has a further extended release with at least about 10% of the essential oil retained, when compared to the encapsulated essential oil without the biopolymer coated, at 8 hours after the release.
8. The bacterial minicell as in any one of the preceding embodiments, wherein the essential oil encapsulated by the minicell is capable of being delivered to a target in a controlled release manner.
9. The bacterial minicell as in any one of the preceding embodiments, wherein the essential oil comprises geraniol, eugenol, genistein, thymol, pyrethrum or carvacrol.

### Method of Preparing a Minicell Encapsulating a Bioactive Agent

1. A method of preparing an minicell encapsulating a bioactive agent, said method comprising the steps of:
   a) producing and purifying minicells;
   b) providing a bioactive agent;
   c) loading the minicells with the bioactive agent for encapsulation; and
   d) recovering the minicells encapsulating the bioactive agent.
2. The method as in any one of the preceding embodiments, wherein in step a) the minicells are produced from a bacterial cell.
3. The method as in any one of the preceding embodiments, wherein in step a) the purified minicells are provided as a suspension in water or other suitable liquid, or a concentrated paste.
4. The method as in any one of the preceding embodiments, wherein the suspension comprises about 1 to 500 mg minicells per ml.
5. The method as in any one of the preceding embodiments, wherein in step a) the purified minicells are provided as a dry powder.
6. The method as in any one of the preceding embodiments, wherein in step b) the bioactive agent provided as a suspension in an aqueous solvent.
7. The method as in any one of the preceding embodiments, wherein in step c) the loaded minicells are suspended in a suspension of the bioactive agent.
8. The method as in any one of the preceding embodiments, wherein in step c) the reaction is carried out at atmospheric pressure at a temperature of about 1° C. to about 40° C.
9. The method as in any one of the preceding embodiments, wherein in step c) the loading ratio between the minicells and the bioactive agent is about 1:5 to about 5:1.
10. The method as in any one of the preceding embodiments, further comprising the step of drying the minicells encapsulating the bioactive agent.
11. The method as in any one of the preceding embodiments, wherein the drying of the minicells encapsulating the bioactive agent is by evaporating a solvent.
12. The method as in any one of the preceding embodiments, wherein the bioactive agent is an essential oil.
13. The method as in any one of the preceding embodiments, wherein the essential oil comprises geraniol, eugenol, or thymol.

### Method of Delivering a Bioactive Agent to a Locus

1. A method of delivering a bioactive agent to a subject, the method comprising: applying to the locus with an insecticidal composition as in any one of the preceding embodiments.
2. The method as in any one of the preceding embodiments, wherein the locus is an insect, a plant, an animal, or a human.
3. The method as in any one of the preceding embodiments, wherein the bioactive agent is an essential oil.
4. The method as in any one of the preceding embodiments, wherein the bioactive agent has an insecticidal activity.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not, be taken as an acknowledgment or any form of suggestion that they constitute valid prior art or form part of the common general knowledge in any country in the world.

### REFERENCES

U.S. Pat. No. 3,467,604
U.S. Patent Application No. 2012/0016022
U.S. Patent Application No. 2012/0016022
U.S. Patent Application No. 2016/0174571
International Patent application No. WO 09/013361
International Patent application No. WO2018/201160
International Patent application No. WO2018/201161
International Patent application No. WO2019/060903
International Patent application No. WO2021/133846
Martin, G. B.; Ferasyi, T. R. Clean, Green, Ethical (CGE) Management: What Research Do We Really Need? Int. J. Trop. Vet. Biomed. Res., 2016, 1-8
Mengoni, Y.; Adrian, M.; Pereira, S.; Santos-Carballal, B.; Kaiser, M.; Goycoolea, F. M. A chitosan-based liposome formulation enhances the in vitro wound healing efficacy of substance P neuropeptide. Pharmaceutics, 2017, 56-61
Filipovic-Grcic, J.; Skalko-Basnet, N.; Jalsenjak I. Mucoadhesive chitosan-coated liposomes: Characteristics and stability. J. Microencap., 2007, 18, 3-12
Madrigal-Carballo, S.; Rodriguez, G.; Sibaja, M.; Vila, A. O.; Reed, J. D.; Molina, F. Chitosomes loaded with cranberry proanthocyanidins attenuate the bacterial lipopolysaccharide induced expression of iNOS and COX-2 in Raw 264.7 macrophages. J. Liposome Res., 2009, 19, 89-196
Madrigal-Carballo, S.; Vila, A. O.; Sibaja, M.; Reed, J. D.; Molina, M. In vitro uptake of lysozyme-loaded liposomes coated with chitosan biopolymer as model immunoadjuvants. J. Liposome Res., 2010, 20, 1-8
Turek, C.; Stintzin, F. C. Stability of Essential Oils: A Review. Com. Rev. Food Sci. Food Safety, 2013, 12, 40-53.
Glasl H. 1975. Uber die Haltbarkeit von Terpenoiden in Extrakten und Losungen mit unterschiedlichem Alkoholgehalt. Arch Pharm 308:88-93
Choe E, Min DB. 2006. Mechanisms and factors for edible oil oxidation. Compr Rev Food Sci Food Saf5:169-86.

What is claimed is:

1. An insecticidal composition for controlling one or more insects comprising:
(i) a minicell and (ii) a bioactive agent having insecticidal activity,
wherein the bioactive agent is selected from a botanical ingredient, an essential oil, a saponin, and combinations thereof,
wherein the one or more insects are controlled with application of said composition to a locus, and
wherein the minicell enhances stability and insecticidal activity of said bioactive agent.

2. The insecticidal composition of claim 1, wherein the minicell is an achromosomal bacterial cell.

3. The insecticidal composition of any one of claims 1-2, wherein the minicell is capable of encapsulating the bioactive agent and wherein the bioactive agent is present within the minicell.

4. The insecticidal composition of any one of claims 1-3, wherein said botanical ingredient is a plant extract having an insecticidal activity.

5. The insecticidal composition of any one of claims 1-4, wherein said botanical ingredient is selected from the group consisting of pyrethrum, pyrethrin, rotenone, sabadilla, cevadine, veratridine, ryania, nicotine, and neen.

6. The insecticidal composition of any one of claims 1-3, wherein said essential oil is a plant extract having an insecticidal activity.

7. The insecticidal composition of any one of claims 1-3 and 6, wherein said essential oil is selected from the group consisting of thyme oil, rosemary oil, cinnamon oil, tea tree oil, peppermint oil, clove oil, orange oil, oregano oil, and neem oil, citronella oil, lemon grass oil, eucalyptus oil, lavender oil, and cedar oil.

8. The insecticidal composition of any one of claims 1-3 and 6-7, wherein said essential oil comprises thymol, geraniol, eugenol, myrcene, α-terpinene, p-cymene, d-limonene, menthol, α-pinene, β-pinene, pulegone, anisole, eucalyptol, geraniol, geranyl acetate, linalyl acetate, methyl anthranilate, cinnamaldehyde, methyl benzoate, azadirachtin, citronellal, nerolidol, pulegone, anethole, ethyl benzoate, emamectin benzoate, or benzyl benzoate.

9. The insecticidal composition of any one of claims 1-8, wherein said insecticidal composition further comprises a soap made with potassium salts of fatty acids.

10. The insecticidal composition of any one of claims 1-9, wherein said insecticidal composition further comprises a surfactant.

11. The insecticidal composition of any one of claims 1-10, wherein the composition is applied in a liquid form or a soluble, dry powder form.

12. The insecticidal composition of any one of claims 1-11, wherein the minicell and the bioactive agent are present in a weight-to-weight ratio of about 5:1 to about 1:5 in the composition.

13. The insecticidal composition of claim 12, wherein the minicell and the bioactive agent are present in a weight-to-weight ratio of about 1:1.

14. The insecticidal composition of claim 1, wherein the locus is an insect, a plant, an animal, or a human.

15. The insecticidal composition of claim 1, wherein the bioactive agent in the presence of the minicell has at least 1% higher insecticidal activity than the bioactive agent alone at day 1 after treatment of said composition.

16. A method of controlling one or more insects, the method comprising: applying an insecticidal composition to a locus, wherein said insecticidal composition comprising:
(i) a minicell and (ii) a bioactive agent having insecticidal activity,
wherein the bioactive agent is selected from a botanical ingredient, an essential oil, a saponin, and combinations thereof,
wherein the one or more insects are controlled with application of said composition to said locus, and
wherein the minicell enhances stability and insecticidal activity of said bioactive agent.

17. The method of claim 16, wherein the minicell is an achromosomal bacterial cell.

18. The method of any one of claims 16-17, wherein the minicell is capable of encapsulating the bioactive agent and wherein the bioactive agent is present within the minicell.

19. The method of any one of claims 16-18, wherein said botanical ingredient is a plant extract having an insecticidal activity.

20. The method of any one of claims 16-19, wherein said botanical ingredient is selected from the group consisting of pyrethrum, pyrethrin, rotenone, sabadilla, cevadine, veratridine, ryania, nicotine, and neen.

21. The method of any one of claims 16-18, wherein said essential oil is a plant extract having an insecticidal activity.

22. The method of any one of claims 16-18 and 21, wherein said essential oil is selected from the group consisting of thyme oil, rosemary oil, cinnamon oil, tea tree oil, peppermint oil, clove oil, orange oil, oregano oil, and neem oil, citronella oil, lemon grass oil, eucalyptus oil, lavender oil, and cedar oil.

23. The method of any one of claims 16-18 and 21-22, wherein said essential oil comprises thymol, geraniol, eugenol, myrcene, α-terpinene, p-cymene, d-limonene, menthol, α-pinene, β-pinene, pulegone, anisole, eucalyptol, geraniol, geranyl acetate, linalyl acetate, methyl anthranilate, cinnamaldehyde, methyl benzoate, azadirachtin, citronellal, nerolidol, pulegone, anethole, ethyl benzoate, emamectin benzoate, or benzyl benzoate.

24. The method of any one of claims 16-23, wherein said insecticidal composition further comprises a soap made with potassium salts of fatty acids.

25. The method of any one of claims 16-24, wherein said insecticidal composition further comprises a surfactant.

26. The method of any one of claims 16-25, wherein the composition is applied in a liquid form or a soluble, dry powder form.

27. The method of any one of claims 16-26, wherein the minicell and the bioactive agent are present in a weight-to-weight ratio of about 5:1 to about 1:5 in the composition.

28. The method of claim 27, wherein the minicell and the bioactive agent are present in a weight-to-weight ratio of about 1:1.

29. The method of claim 16, wherein the locus is an insect, a plant, an animal, or a human.

30. The method of claim 16, wherein the bioactive agent in the presence of the minicell has at least 1% higher insecticidal activity than the bioactive agent alone at day 1 after treatment of said composition.
